(19) United States
(12) Patent Application Publication
(10) Pub. No.: US 2017/0223695 A1
(43) Pub. Date: Aug. 3, 2017

(54) METHOD AND APPARATUS FOR TRANSMITTING AN UPLINK CHANNEL IN A WIRELESS COMMUNICATION SYSTEM

(71) Applicant: LG ELECTRONICS INC., Seoul (KR)

(72) Inventors: Kyuhwan KWAK, Seoul (KR); Daesung HWANG, Seoul (KR); Yunjung YI, Seoul (KR); Hyunho LEE, Seoul (KR)

(73) Assignee: LG ELECTRONICS INC., Seoul (KR)

(21) Appl. No.: 15/424,745

(22) Filed: Feb. 3, 2017

Related U.S. Application Data
(60) Provisional application No. 62/290,470, filed on Feb. 3, 2016.
(60) Provisional application No. 62/335,694, filed on May 13, 2016.

(51) Int. Cl. H04W 72/04; H04W 52/02; H04W 72/12; H04W 56/00; H04W 48/08

(52) U.S. Cl. CPC H04W 72/0413; H04W 56/0075; H04W 48/08; H04W 72/1268; H04W 56/0005; H04W 52/0216

(57) ABSTRACT

Disclosed are a method and apparatus for transmitting an uplink channel in a wireless communication system. A method for transmitting an uplink channel in a wireless communication system supporting an sTTI is performed by a terminal incapable of the simultaneous transmission of a first uplink channel and a second uplink channel, and includes when a first uplink channel region at a first sTTI overlaps a specific symbol included in a second uplink channel region at a second sTTI, transmitting the first uplink channel to a base station using at least one of a plurality of symbols included in the first uplink channel region symbol other than the specific symbol at the first sTTI and transmitting the second uplink channel to the base station using at least one symbol included in the second uplink channel region at the second sTTI. The specific symbol includes a symbol to which a DMRS related to the second uplink channel is mapped.

### CROSS-REFERENCE TO RELATED APPLICATIONS

Pursuant to 35 U.S.C. §119(e), this application claims the benefit of U.S. Provisional Application Nos. 62/290,470 filed on Feb. 3, 2016, and 62/335,694 filed on May 13, 2016, the contents of which are all hereby incorporated by reference herein in their entirety.

### BACKGROUND OF THE INVENTION

Field of the Invention

The present invention relates to a wireless communication system and, more particularly, to a method for transmitting an uplink channel and an apparatus supporting the same.

Discussion of the Related Art

Mobile communication systems have been developed to provide voice services while ensuring the activity of a user. However, the mobile communication systems have been expanded to their regions up to data services as well as voice. Today, the shortage of resources is caused due to an explosive increase of traffic, and more advanced mobile communication systems are required due to user's need for higher speed services.

Requirements for a next-generation mobile communication system basically include the acceptance of explosive data traffic, a significant increase of a transfer rate per user, the acceptance of the number of significantly increased connection devices, very low end-to-end latency, and high energy efficiency. To this end, research is carried out on various technologies, such as dual connectivity, massive Multiple Input Multiple Output (MIMO), in-band full duplex, Non-Orthogonal Multiple Access (NOMA), the support of a super wideband, and device networking.

### SUMMARY OF THE INVENTION

In a wireless communication system supporting a short TTI, if a channel for transmitting uplink control information and a channel for transmitting uplink data overlap, there is a problem in that UE incapable of the simultaneous transmission of the two channels cannot transmit the two channels at the same time in an overlap region.

An object of the present invention is to propose a method for transmitting, by UE not supporting the simultaneous transmission of the two channels, uplink control information and/or data in a wireless communication system.

Furthermore, an object of the present invention is to propose a method for transmitting, by UE, an uplink control channel and/or an uplink shared channel in a wireless communication system supporting a short transmission time interval (sTTI).

Furthermore, an object of the present invention is to propose a method for emptying, by UE, an overlap region (or symbol) and transmitting an uplink control channel and/or an uplink shared channel.

Furthermore, an object of the present invention is to propose a method for non-emptying, by UE, an overlap region (or symbol) and transmitting an uplink control channel and/or an uplink shared channel.

Furthermore, an object of the present invention is to propose a method for transmitting, by UE, an uplink control channel and/or an uplink shared channel based on the priorities of uplink channels.

Technical objects to be achieved by the present invention are not limited to the aforementioned object, and those skilled in the art to which the present invention pertains may evidently understand other technological objects from the following description.

In an aspect, a method for transmitting an uplink channel in a wireless communication system supporting a short transmission time interval (sTTI) is performed by a terminal not supporting the simultaneous transmission of a first uplink channel and a second uplink channel, and includes when a first uplink channel region at a first sTTI is overlapped with a specific symbol included in a second uplink channel region at a second sTTI, transmitting the first uplink channel to a base station using at least one of a plurality of symbols included in the first uplink channel region symbol other than the specific symbol at the first sTTI and transmitting the second uplink channel to the base station using at least one symbol included in the second uplink channel region at the second sTTI. The specific symbol may include a symbol to which a demodulated reference signal (DMRS) related to the second uplink channel is mapped.

Furthermore, the symbol to which the DMRS is mapped may include a DMRS symbol shared by the second uplink channel at the first sTTI and the second uplink channel at the second sTTI.

Furthermore, the first uplink channel may include a channel in which the terminal transmits uplink control information to the base station. The second uplink channel may include a channel in which the terminal transmits uplink data to the base station.

Furthermore, the first uplink channel may include a short physical uplink control channel (sPUCCH). The second uplink channel may include a short physical uplink shared channel (sPUSCH).

Furthermore, wherein the first sTTI may include a sTTI adjacent to the second sTTI.

Furthermore, the at least one symbol included in the second uplink channel region may include at least one of a plurality of symbols included in the second uplink channel region at the second sTTI other than the specific symbol.

The method may further include transmitting a sounding reference signal to the base station using the specific symbol. The DMRS related to the second uplink channel may be mapped to a part of the at least one symbol other than the specific symbol.

Furthermore, the first uplink channel region may be subjected to frequency hopping based on a predetermined hopping pattern.

The method may further include receiving information related to a specific cyclic shift applied to a sequence and information related to orthogonal cover code from the base station. The transmitted first uplink channel may include at least one first symbol to which the sequence based on the specific cyclic shift has been applied and at least one second symbol to which the orthogonal cover code has been applied.

In another aspect, a terminal transmitting an uplink channel in a wireless communication system supporting a short transmission time interval (sTTI) does not support a simultaneous transmission of a first uplink channel and a second uplink channel, and includes a transmission/reception unit for transmitting and receiving a radio signal and a processor functionally coupled to the transmission/reception unit. The processor may perform control so that when a first uplink channel region at a first sTTI is overlapped with a specific symbol included in a second uplink channel region at a second sTTI, a first uplink channel is transmitted to a base station using at least one of a plurality of symbols included in the first uplink channel region symbol other than the specific symbol at the first sTTI and the second uplink channel is transmitted to the base station using at least one symbol included in the second uplink channel region at the second sTTI. The specific symbol may include a symbol to which a demodulated reference signal (DMRS) related to the second uplink channel is mapped.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 illustrates the structure of a radio frame in a wireless communication system to which an embodiment of the present invention may be applied.

FIG. 2 is a diagram illustrating a resource grid for one downlink slot in a wireless communication system to which an embodiment of the present invention may be applied.

FIG. 3 illustrates the structure of a downlink subframe in a wireless communication system to which an embodiment of the present invention may be applied.

FIG. 4 illustrates the structure of an uplink subframe in a wireless communication system to which an embodiment of the present invention may be applied.

FIG. 5 illustrates an example of a form in which the formats of a physical uplink control channel (PUCCH) are mapped to the PUCCH region of an uplink physical resource block in a wireless communication system to which an embodiment of the present invention may be applied.

FIG. 6 illustrates the structure of a channel quality indicator (CQI) channel in the case of a normal cyclic prefix (CP) in a wireless communication system to which an embodiment of the present invention may be applied.

FIG. 7 illustrates the structure of an ACK/NACK channel in the case of a normal CP in a wireless communication system to which an embodiment of the present invention may be applied.

FIG. 8 illustrates an example of the transport channel processing of an uplink shared channel (UL-SCH) in a wireless communication system to which an embodiment of the present invention may be applied.

FIG. 9 illustrates an example of the signal processing process of an uplink shared channel, that is, a transport channel, in a wireless communication system to which an embodiment of the present invention may be applied.

FIG. 10 illustrates examples of a cell-specific reference signal (CRS) pattern in 1 resource block (RB) to which an embodiment of the present invention may be applied.

FIG. 11 illustrates a reference signal pattern to which a downlink resource block pair has been mapped in a wireless communication system to which an embodiment of the present invention may be applied.

FIG. 12 illustrates an uplink subframe including a sounding reference signal symbol in a wireless communication system to which an embodiment of the present invention may be applied.

FIG. 13 illustrates an example of a component carrier and a carrier aggregation in a wireless communication system to which an embodiment of the present invention may be applied.

FIG. 14 illustrates an example of the structure of a subframe according to cross-carrier scheduling in a wireless communication system to which an embodiment of the present invention may be applied.

FIG. 15 illustrates an example in which 5 SC-FDMA symbols are generated and transmitted during one slot in a wireless communication system to which an embodiment of the present invention may be applied.

FIG. 16 illustrates an example of a time-frequency resource block in a time-frequency domain to which an embodiment of the present invention may be applied.

FIG. 17 illustrates an example of resource allocation and retransmission in a common asynchronous HARQ method to which an embodiment of the present invention may be applied.

FIG. 18 illustrates an example of a CoMP system using a carrier aggregation to which an embodiment of the present invention may be applied.

FIG. 19 illustrates an example in which a legacy PDCCH, PDSCH and E-PDCCH are multiplexed to which an embodiment of the present invention may be applied.

FIG. 20 illustrates an example of the mapping of modulation symbols to a PUCCH to which an embodiment of the present invention may be applied.

FIG. 21 illustrates a PUSCH transmission structure for 4-symbol TTIs according to various embodiments of the present invention.

FIG. 22 illustrates uplink resource grids according to various embodiments of the present invention.

FIG. 23 illustrates the PUSCH and PUCCH transmission regions of two pieces of UE according to various embodiments of the present invention.

FIG. 24 illustrates an example of a structure in which UE transmits an SRS in a region not used for PUCCH and PUSCH transmission according to various embodiments of the present invention.

FIG. 25 illustrates the structures of a PUCCH format in a legacy LTE system.

FIG. 26 illustrates PUCCH transmission formats according to embodiments of the present invention.

FIG. 27 illustrates examples of PUCCH multiplexing between pieces of UE according to various embodiments of the present invention.

FIG. 28 illustrates a PUCCH transmission structure having a different length for each TTI according to another embodiment of the present invention.

FIG. 29 illustrates a PUCCH transmission structure based on priority according to an embodiment of the present invention.

FIG. 30 illustrates structures in which the overlap of a PUCCH and a PUSCH has been taken into consideration if isolated symbols are present according to various embodiments of the present invention.

FIG. 31 illustrates a structure in which the TTI of a PUSCH has been changed based on priority according to another embodiment of the present invention.

FIG. 32 illustrates an operating flowchart of UE which transmits an uplink channel according to an embodiment of the present invention.

FIG. 33 illustrates a block diagram of a wireless communication device according to an embodiment of the present invention.

### DETAILED DESCRIPTION OF THE EMBODIMENTS

Hereafter, preferred embodiments of the present invention will be described in detail with reference to the accompanying drawings. A detailed description to be disclosed hereinbelow together with the accompanying drawing is to describe embodiments of the present invention and not to describe a unique embodiment for carrying out the present invention. The detailed description below includes details in order to provide a complete understanding. However, those skilled in the art know that the present invention can be carried out without the details.

In some cases, in order to prevent a concept of the present invention from being ambiguous, known structures and devices may be omitted or may be illustrated in a block diagram format based on core function of each structure and device.

In the specification, a base station means a terminal node of a network directly performing communication with a terminal. In the present document, specific operations described to be performed by the base station may be performed by an upper node of the base station in some cases. That is, it is apparent that in the network constituted by multiple network nodes including the base station, various operations performed for communication with the terminal may be performed by the base station or other network nodes other than the base station. A base station (BS) may be generally substituted with terms such as a fixed station, Node B, evolved-NodeB (eNB), a base transceiver system (BTS), an access point (AP), and the like. Further, a ‘terminal’ may be fixed or movable and be substituted with terms such as user equipment (UE), a mobile station (MS), a user terminal (UT), a mobile subscriber station (MSS), a subscriber station (SS), an advanced mobile station (AMS), a wireless terminal (WT), a Machine-Type Communication (MTC) device, a Machine-to-Machine (M2M) device, a Device-to-Device (D2D) device, and the like.

Hereinafter, a downlink means communication from the base station to the terminal and an uplink means communication from the terminal to the base station. In the downlink, a transmitter may be a part of the base station and a receiver may be a part of the terminal. In the uplink, the transmitter may be a part of the terminal and the receiver may be a part of the base station.

Specific terms used in the following description are provided to help appreciating the present invention and the use of the specific terms may be modified into other forms within the scope without departing from the technical spirit of the present invention.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology universal terrestrial radio access (UTRA) or CDMA2000. The TDMA may be implemented by radio technology such as Global System for Mobile communications (GSM)/General Packet Radio Service (GPRS)/Enhanced Data Rates for GSM Evolution (EDGE). The OFDMA may be implemented as radio technology such as IEEE 802.11 (Wi-Fi), IEEE 802.16 (WiMAX), IEEE 802-20, E-UTRA (Evolved UTRA), and the like. The UTRA is a part of a universal mobile telecommunication system (UMTS). 3^{rd} generation partnership project (3GPP) long term evolution (LTE) as a part of an evolved UMTS (E-UMTS) using evolved-UMTS terrestrial radio access (E-UTRA) adopts the OFDMA in a downlink and the SC-FDMA in an uplink. LTE-advanced (A) is an evolution of the 3GPP LTE.

The embodiments of the present invention may be based on standard documents disclosed in at least one of IEEE 802, 3GPP, and 3GPP2 which are the wireless access systems. That is, steps or parts which are not described to definitely show the technical spirit of the present invention among the embodiments of the present invention may be based on the documents. Further, all terms disclosed in the document may be described by the standard document.

3GPP LTE/LTE-A is primarily described for clear description, but technical features of the present invention are not limited thereto.

General System

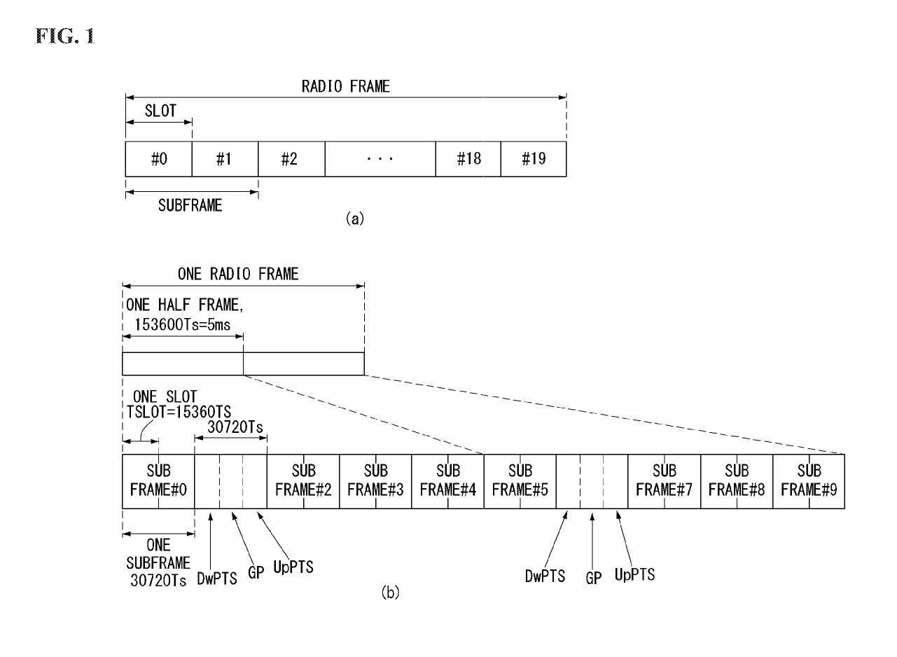

FIG. 1 illustrates a structure a radio frame in a wireless communication system to which the present invention can be applied.

In 3GPP LTE/LTE-A, radio frame structure type 1 may be applied to frequency division duplex (FDD) and radio frame structure type 2 may be applied to time division duplex (TDD) are supported.

In FIG. 1, the size of the radio frame in the time domain is represented by a multiple of a time unit of T_s=1/(15000*2048). The downlink and uplink transmissions are composed of radio frames having intervals of T_f=307200*T_s=10 ms.

FIG. 1(a) exemplifies radio frame structure type 1. Type 1 radio frames can be applied to both full duplex and half duplex FDD.

The radio frame is constituted by 10 subframes. One radio frame is composed of 20 slots having a length of T_slot=15360*T_s=0.5 ms, and each slot is given an index from 0 to 19. One subframe is constituted by two consecutive slots in the time domain, and the subframe i is constituted by slots 2i and 2i+1. A time required to transmit one subframe is referred to as a transmissions time interval (TTI). For example, the length of one subframe may be 1 ms and the length of one slot may be 0.5 ms.

In the FDD, the uplink transmission and the downlink transmission are classified in the frequency domain. There is no limitation on full-duplex FDD, whereas in half-duplex FDD operation, the UE can not transmit and receive at the same time.

One slot includes a plurality of orthogonal frequency division multiplexing (OFDM) symbols in the time domain and includes multiple resource blocks (RBs) in a frequency domain. In 3GPP LTE, since OFDMA is used in downlink, the OFDM symbol is used to express one symbol period. The OFDM symbol may be one SC-FDMA symbol or symbol period. The resource block is a resource allocation wise and includes a plurality of consecutive subcarriers in one slot.

FIG. 1(b) illustrates frame structure type 2.

The Type 2 radio frame consists of two half frames each having a length of 153600*T_s=5 ms. Each half frame consists of 5 subframes with a length of 30720*T_s=1 ms.

In frame structure type 2 of a TDD system, an uplink-downlink configuration is a rule indicating whether the uplink and the downlink are allocated (alternatively, reserved) with respect to all subframes.

Table 1 shows the uplink-downlink configuration.

TABLE 1

| Uplink- | Downlink- | | | | | | | | | | | |
|---|---|---|---|---|---|---|---|---|---|---|---|---|
| Downlink | to-Uplink | | | | | | | | | | | |
| configu- | Switch-point | | Subframe number | | | | | | | | | |
| ration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

Referring to Table 1, for each sub frame of the radio frame, ‘D’ represents a subframe for downlink transmission, ‘U’ represents a subframe for uplink transmission, and ‘S’ represents a special subframe constituted by three fields such as the DwPTS, the GP, and the UpPTS.

The DwPTS is used for initial cell search, synchronization, or channel estimation in the UE. The UpPTS is used to match the channel estimation at the base station and the uplink transmission synchronization of the UE. GP is a period for eliminating the interference caused in the uplink due to the multipath delay of the downlink signal between the uplink and the downlink.

Each subframe i is composed of a slot 2i and a slot 2i+1 each having a length of T_slot=15360*T_s=0.5 ms.

The uplink-downlink configuration may be divided into 7 configurations and the positions and/or the numbers of the downlink subframe, the special subframe, and the uplink subframe may vary for each configuration.

A time when the downlink is switched to the uplink or a time when the uplink is switched to the downlink is referred to as a switching point. Switch-point periodicity means a period in which an aspect of the uplink subframe and the downlink subframe are switched is similarly repeated and both 5 ms or 10 ms are supported. When the period of the downlink-uplink switching point is 5 ms, the special subframe S is present for each half-frame and when the period of the downlink-uplink switching point is 5 ms, the special subframe S is present only in a first half-frame.

In all configurations, subframes #0 and #5 and the DwPTS are intervals only the downlink transmission. The UpPTS and a subframe just subsequently to the subframe are continuously intervals for the uplink transmission.

The uplink-downlink configuration may be known by both the base station and the terminal as system information. The base station transmits only an index of configuration information whenever the uplink-downlink configuration information is changed to announce a change of an uplink-downlink allocation state of the radio frame to the terminal. Further, the configuration information as a kind of downlink control information may be transmitted through a physical downlink control channel (PDCCH) similarly to other scheduling information and may be commonly transmitted to all terminals in a cell through a broadcast channel as broadcasting information.

Table 2 illustrates the configuration of the special subframe (DwPTS/GP/UpPTS length).

TABLE 2

| | Normal cyclic prefix in downlink | | | Extended cyclic prefix in downlink | | |
|---|---|---|---|---|---|---|
| | | UpPTS | | | UpPTS | |
| Special subframe | | Normal cyclic | Extended cyclic | | Normal cyclic | Extended cyclic |
| configuration | DwPTS | prefix in uplink | prefix in uplink | DwPTS | prefix in uplink | prefix in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

The structure of the radio frame according to the example of FIG. 1 is just one example and the number subcarriers included in the radio frame or the number of slots included in the subframe and the number of OFDM symbols included in the slot may be variously changed.

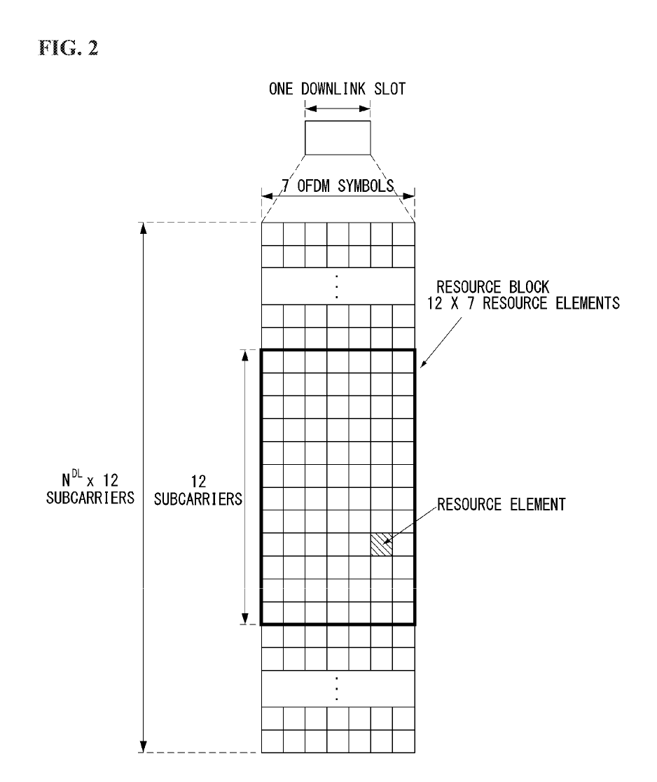

FIG. 2 is a diagram illustrating a resource grid for one downlink slot in the wireless communication system to which the present invention can be applied.

Referring to FIG. 2, one downlink slot includes the plurality of OFDM symbols in the time domain. Herein, it is exemplarily described that one downlink slot includes 7 OFDM symbols and one resource block includes 12 subcarriers in the frequency domain, but the present invention is not limited thereto.

Each element on the resource grid is referred to as a resource element and one resource block includes 12×7 resource elements. The number of resource blocks included in the downlink slot, N^{DL} is subordinated to a downlink transmission bandwidth.

A structure of the uplink slot may be the same as that of the downlink slot.

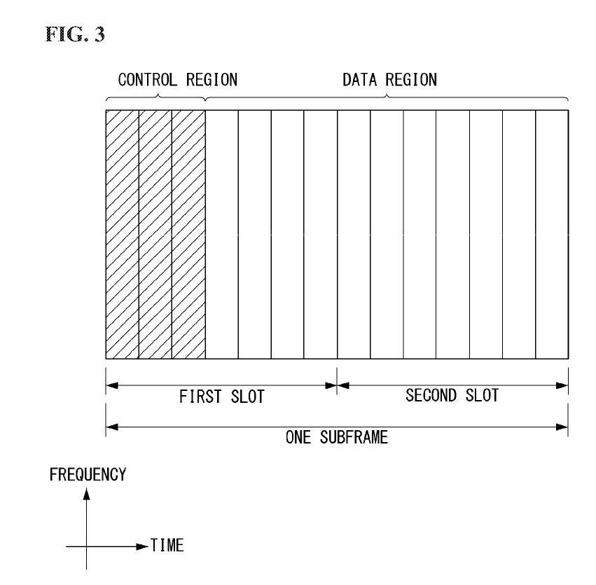

FIG. 3 illustrates a structure of a downlink subframe in the wireless communication system to which the present invention can be applied.

Referring to FIG. 3, a maximum of three fore OFDM symbols in the first slot of the sub frame is a control region to which control channels are allocated and residual OFDM symbols is a data region to which a physical downlink shared channel (PDSCH) is allocated. Examples of the downlink control channel used in the 3GPP LTE include a Physical Control Format Indicator Channel (PCFICH), a Physical Downlink Control Channel (PDCCH), a Physical Hybrid-ARQ Indicator Channel (PHICH), and the like.

The PFCICH is transmitted in the first OFDM symbol of the subframe and transports information on the number (that is, the size of the control region) of OFDM symbols used for transmitting the control channels in the subframe. The PHICH which is a response channel to the uplink transports an Acknowledgement (ACK)/Not-Acknowledgement (NACK) signal for a hybrid automatic repeat request (HARQ). Control information transmitted through a PDCCH is referred to as downlink control information (DCI). The downlink control information includes uplink resource allocation information, downlink resource allocation information, or an uplink transmission (Tx) power control command for a predetermined terminal group.

The PDCCH may transport A resource allocation and transmission format (also referred to as a downlink grant) of a downlink shared channel (DL-SCH), resource allocation information (also referred to as an uplink grant) of an uplink shared channel (UL-SCH), paging information in a paging channel (PCH), system information in the DL-SCH, resource allocation for an upper-layer control message such as a random access response transmitted in the PDSCH, an aggregate of transmission power control commands for individual terminals in the predetermined terminal group, a voice over IP (VoIP). A plurality of PDCCHs may be transmitted in the control region and the terminal may monitor the plurality of PDCCHs. The PDCCH is constituted by one or an aggregate of a plurality of continuous control channel elements (CCEs). The CCE is a logical allocation wise used to provide a coding rate depending on a state of a radio channel to the PDCCH. The CCEs correspond to a plurality of resource element groups. A format of the PDCCH and a bit number of usable PDCCH are determined according to an association between the number of CCEs and the coding rate provided by the CCEs.

The base station determines the PDCCH format according to the DCI to be transmitted and attaches the control information to a cyclic redundancy check (CRC) to the control information. The CRC is masked with a unique identifier (referred to as a radio network temporary identifier (RNTI)) according to an owner or a purpose of the PDCCH. In the case of a PDCCH for a specific terminal, the unique identifier of the terminal, for example, a cell-RNTI (C-RNTI) may be masked with the CRC. Alternatively, in the case of a PDCCH for the paging message, a paging indication identifier, for example, the CRC may be masked with a paging-RNTI (P-RNTI). In the case of a PDCCH for the system information, in more detail, a system information block (SIB), the CRC may be masked with a system information identifier, that is, a system information (SI)-RNTI. The CRC may be masked with a random access (RA)-RNTI in order to indicate the random access response which is a response to transmission of a random access preamble.

Enhanced PDCCH (EPDCCH) carries UE-specific signaling. The EPDCCH is located in a physical resource block (PRB) that is set to be terminal specific. In other words, as described above, the PDCCH can be transmitted in up to three OFDM symbols in the first slot in the subframe, but the EPDCCH can be transmitted in a resource region other than the PDCCH. The time (i.e., symbol) at which the EPDCCH in the subframe starts may be set in the UE through higher layer signaling (e.g., RRC signaling, etc.).

The EPDCCH is a transport format, a resource allocation and HARQ information associated with the DL-SCH and a transport format, a resource allocation and HARQ information associated with the UL-SCH, and resource allocation information associated with SL-SCH (Sidelink Shared Channel) and PSCCH Information, and so on. Multiple EPDCCHs may be supported and the terminal may monitor the set of EPCCHs.

The EPDCCH can be transmitted using one or more successive advanced CCEs (ECCEs), and the number of ECCEs per EPDCCH can be determined for each EPDCCH format.

Each ECCE may be composed of a plurality of enhanced resource element groups (EREGs). EREG is used to define the mapping of ECCE to RE. There are 16 EREGs per PRB pair. All REs are numbered from 0 to 15 in the order in which the frequency increases, except for the RE that carries the DMRS in each PRB pair.

The UE can monitor a plurality of EPDCCHs. For example, one or two EPDCCH sets may be set in one PRB pair in which the terminal monitors the EPDCCH transmission.

Different coding rates can be realized for the EPCCH by merging different numbers of ECCEs. The EPCCH may use localized transmission or distributed transmission, which may result in different mapping of the ECCE to the REs in the PRB.

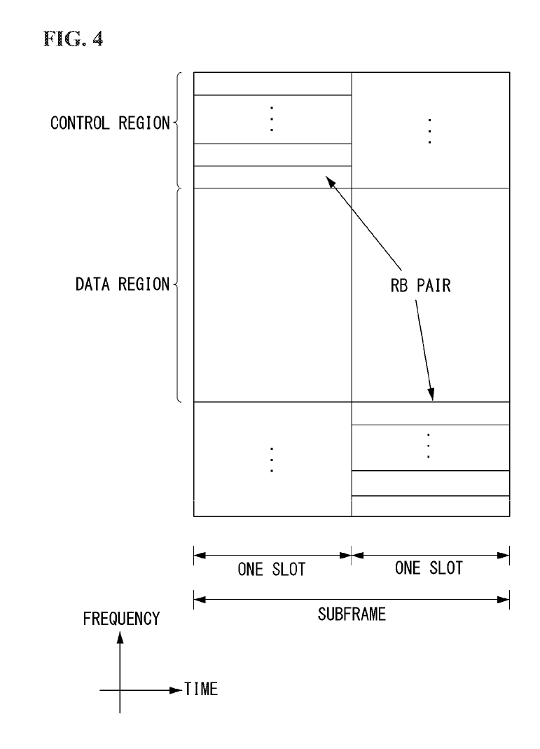

FIG. 4 illustrates a structure of an uplink subframe in the wireless communication system to which the present invention can be applied.

Referring to FIG. 4, the uplink subframe may be divided into the control region and the data region in a frequency domain. A physical uplink control channel (PUCCH) transporting uplink control information is allocated to the control region. A physical uplink shared channel (PUSCH) transporting user data is allocated to the data region. One terminal does not simultaneously transmit the PUCCH and the PUSCH in order to maintain a single carrier characteristic.

A resource block (RB) pair in the subframe are allocated to the PUCCH for one terminal. RBs included in the RB pair occupy different subcarriers in two slots, respectively. The RB pair allocated to the PUCCH frequency-hops in a slot boundary.

Physical Uplink Control Channel (PUCCH)

The uplink control information (UCI) transmitted through the PUCCH may include a scheduling request (SR), HARQ ACK/NACK information, and downlink channel measurement information.

The HARQ ACK/NACK information may be generated according to a downlink data packet on the PDSCH is successfully decoded. In the existing wireless communication system, 1 bit is transmitted as ACK/NACK information with respect to downlink single codeword transmission and 2 bits are transmitted as the ACK/NACK information with respect to downlink 2-codeword transmission.

The channel measurement information which designates feedback information associated with a multiple input multiple output (MIMO) technique may include a channel quality indicator (CQI), a precoding matrix index (PMI), and a rank indicator (RI). The channel measurement information may also be collectively expressed as the CQI.

20 bits may be used per subframe for transmitting the CQI.

The PUCCH may be modulated by using binary phase shift keying (BPSK) and quadrature phase shift keying (QPSK) techniques. Control information of a plurality of terminals may be transmitted through the PUCCH and when code division multiplexing (CDM) is performed to distinguish signals of the respective terminals, a constant amplitude zero autocorrelation (CAZAC) sequence having a length of 12 is primary used. Since the CAZAC sequence has a characteristic to maintain a predetermined amplitude in the time domain and the frequency domain, the CAZAC sequence has a property suitable for increasing coverage by decreasing a peak-to-average power ratio (PAPR) or cubic metric (CM) of the terminal. Further, the ACK/NACK information for downlink data transmission performed through the PUCCH is covered by using an orthogonal sequence or an orthogonal cover (OC).

Further, the control information transmitted on the PUCCH may be distinguished by using a cyclically shifted sequence having different cyclic shift (CS) values. The cyclically shifted sequence may be generated by cyclically shifting a base sequence by a specific cyclic shift (CS) amount. The specific CS amount is indicated by the cyclic shift (CS) index. The number of usable cyclic shifts may vary depending on delay spread of the channel. Various types of sequences may be used as the base sequence the CAZAC sequence is one example of the corresponding sequence.

Further, the amount of control information which the terminal may transmit in one subframe may be determined according to the number (that is, SC-FDMA symbols other an SC-FDMA symbol used for transmitting a reference signal (RS) for coherent detection of the PUCCH) of SC-FDMA symbols which are usable for transmitting the control information.

In the 3GPP LTE system, the PUCCH is defined as a total of 7 different formats according to the transmitted control information, a modulation technique, the amount of control information, and the like and an attribute of the uplink control information (UCI) transmitted according to each PUCCH format may be summarized as shown in Table 3 given below.

TABLE 3

| PUCCH | |
|---|---|
| Format | Uplink Control Information(UCI) |
| Format 1 | Scheduling Request (SR) (unmodulated waveform) |
| Format 1a | 1-bit HARQ ACK/NACK with/without SR |
| Format 1b | 2-bit HARQ ACK/NACK with/without SR |
| Format 2 | CQI (20 coded bits) |
| Format 2 | CQI and 1- or 2-bit HARQ ACK/NACK (20 bits) for |
| | extended CP only |
| Format 2a | CQI and 1-bit HARQ ACK/NACK (20 + 1 coded bits) |
| Format 2b | CQI and 2-bit HARQ ACK/NACK (20 + 2 coded bits) |

PUCCH format 1 is used for transmitting only the SR. A waveform which is not modulated is adopted in the case of transmitting only the SR and this will be described below in detail.

PUCCH format 1a or 1b is used for transmitting the HARQ ACK/NACK. PUCCH format 1a or 1b may be used when only the HARQ ACK/NACK is transmitted in a predetermined subframe. Alternatively, the HARQ ACK/NACK and the SR may be transmitted in the same subframe by using PUCCH format 1a or 1b.

PUCCH format 2 is used for transmitting the CQI and PUCCH format 2a or 2b is used for transmitting the CQI and the HARQ ACK/NACK.

In the case of an extended CP, PUCCH format 2 may be transmitted for transmitting the CQI and the HARQ ACK/NACK.

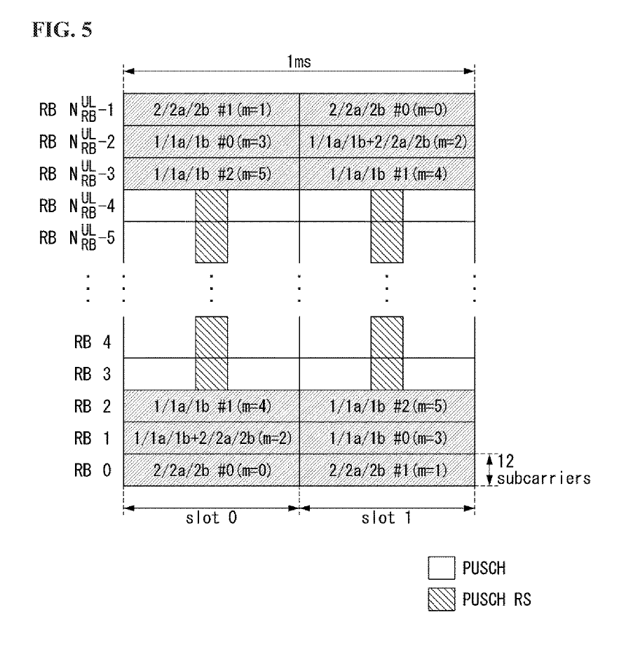

FIG. 5 illustrates one example of a type in which PUCCH formats are mapped to a PUCCH region of an uplink physical resource block in the wireless communication system to which the present invention can be applied.

In FIG. 5, N_{RB}^{UL} represents the number of resource blocks in the uplink and 0, 1, . . . , N_{RB}^{UL}−1 mean numbers of physical resource blocks. Basically, the PUCCH is mapped to both edges of an uplink frequency block. As illustrated in FIG. 5, PUCCH format 2/2a/2b is mapped to a PUCCH region expressed as m=0, 1 and this may be expressed in such a manner that PUCCH format 2/2a/2b is mapped to resource blocks positioned at a band edge. Further, both PUCCH format 2/2a/2b and PUCCH format 1/1a/1b may be mixedly mapped to a PUCCH region expressed as m=2. Next, PUCCH format 1/1a/1b may be mapped to a PUCCH region expressed as m=3, 4, and 5. The number (N_{RB}⁽²⁾) of PUCCH RBs which are usable by PUCCH format 2/2a/2b may be indicated to terminals in the cell by broadcasting signaling.

PUCCH format 2/2a/2b is described. PUCCH format 2/2a/2b is a control channel for transmitting channel measurement feedback (CQI, PMI, and RI).

A reporting period of the channel measurement feedbacks (hereinafter, collectively expressed as CQI information) and a frequency wise (alternatively, a frequency resolution) to be measured may be controlled by the base station. In the time domain, periodic and aperiodic CQI reporting may be supported. PUCCH format 2 may be used for only the periodic reporting and the PUSCH may be used for aperiodic reporting. In the case of the aperiodic reporting, the base station may instruct the terminal to transmit a scheduling resource loaded with individual CQI reporting for the uplink data transmission.

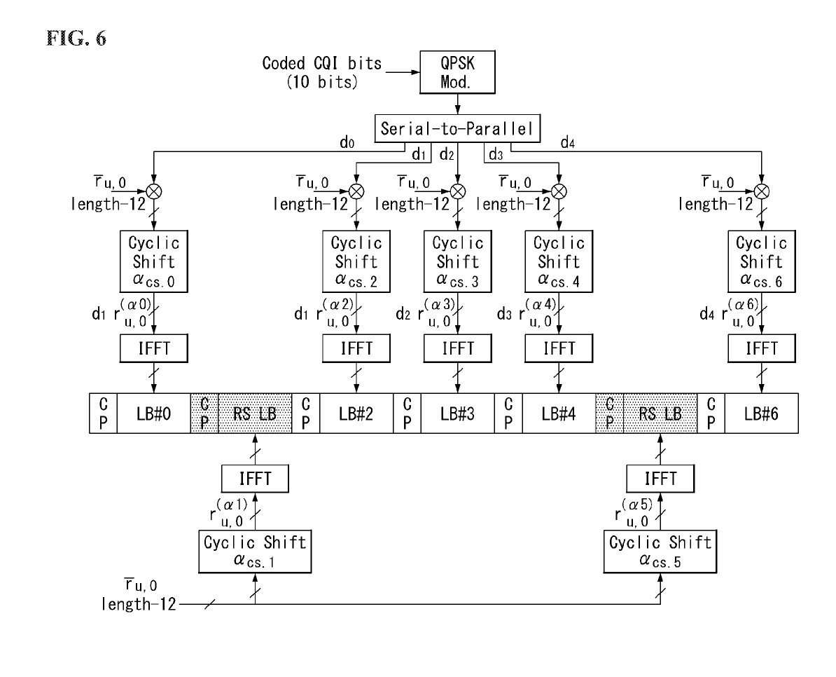

FIG. 6 illustrates a structure of a CQI channel in the case of a general CP in the wireless communication system to which the present invention can be applied.

In SC-FDMA symbols 0 to 6 of one slot, SC-FDMA symbols 1 and 5 (second and sixth symbols) may be used for transmitting a demodulation reference signal and the CQI information may be transmitted in the residual SC-FDMA symbols. Meanwhile, in the case of the extended CP, one SC-FDMA symbol (SC-FDMA symbol 3) is used for transmitting the DMRS.

In PUCCH format 2/2a/2b, modulation by the CAZAC sequence is supported and the CAZAC sequence having the length of 12 is multiplied by a QPSK-modulated symbol. The cyclic shift (CS) of the sequence is changed between the symbol and the slot. The orthogonal covering is used with respect to the DMRS.

The reference signal (DMRS) is loaded on two SC-FDMA symbols separated from each other by 3 SC-FDMA symbols among 7 SC-FDMA symbols included in one slot and the CQI information is loaded on 5 residual SC-FDMA symbols. Two RSs are used in one slot in order to support a high-speed terminal. Further, the respective terminals are distinguished by using the CS sequence. CQI information symbols are modulated and transferred to all SC-FDMA symbols and the SC-FDMA symbol is constituted by one sequence. That is, the terminal modulates and transmits the CQI to each sequence.

The number of symbols which may be transmitted to one TTI is 10 and modulation of the CQI information is determined up to QPSK. When QPSK mapping is used for the SC-FDMA symbol, since a CQI value of 2 bits may be loaded, a CQI value of 10 bits may be loaded on one slot. Therefore, a CQI value of a maximum of 20 bits may be loaded on one subframe. A frequency domain spread code is used for spreading the CQI information in the frequency domain.

The CAZAC sequence (for example, ZC sequence) having the length of 12 may be used as the frequency domain spread code. CAZAC sequences having different CS values may be applied to the respective control channels to be distinguished from each other. IFFT is performed with respect to the CQI information in which the frequency domain is spread.

12 different terminals may be orthogonally multiplexed on the same PUCCH RB by a cyclic shift having 12 equivalent intervals. In the case of a general CP, a DMRS sequence on SC-FDMA symbol 1 and 5 (on SC-FDMA symbol 3 in the case of the extended CP) is similar to a CQI signal sequence on the frequency domain, but the modulation of the CQI information is not adopted.

The terminal may be semi-statically configured by upper-layer signaling so as to periodically report different CQI, PMI, and RI types on PUCCH resources indicated as PUCCH resource indexes (n_{PUCCH}^{(1,\tilde{p})}, n_{PUCCH}^{(2,\tilde{p})}, and n_{PUCCH}^{(3,\tilde{p})}). Herein, the PUCCH resource) index (n_{PUCCH}^{(2,\tilde{p})}) is information indicating the PUCCH region used for PUCCH format 2/2a/2b and a CS value to be used.

PUCCH Channel Structure

PUCCH formats 1a and 1b are described.

In PUCCH format 1a and 1b, the CAZAC sequence having the length of 12 is multiplied by a symbol modulated by using a BPSK or QPSK modulation scheme. For example, a result acquired by multiplying a modulated symbol d(0) by a CAZAC sequence r(n) (n=0, 1, 2, . . . , N−1) having a length of N becomes y(0), y(1), y(2), . . . , y(N−1). y(0), . . . , y(N−1) symbols may be designated as a block of symbols. The modulated symbol is multiplied by the CAZAC sequence and thereafter, the block-wise spread using the orthogonal sequence is adopted.

A Hadamard sequence having a length of 4 is used with respect to general ACK/NACK information and a discrete Fourier transform (DFT) sequence having a length of 3 is used with respect to the ACK/NACK information and the reference signal.

The Hadamard sequence having the length of 2 is used with respect to the reference signal in the case of the extended CP.

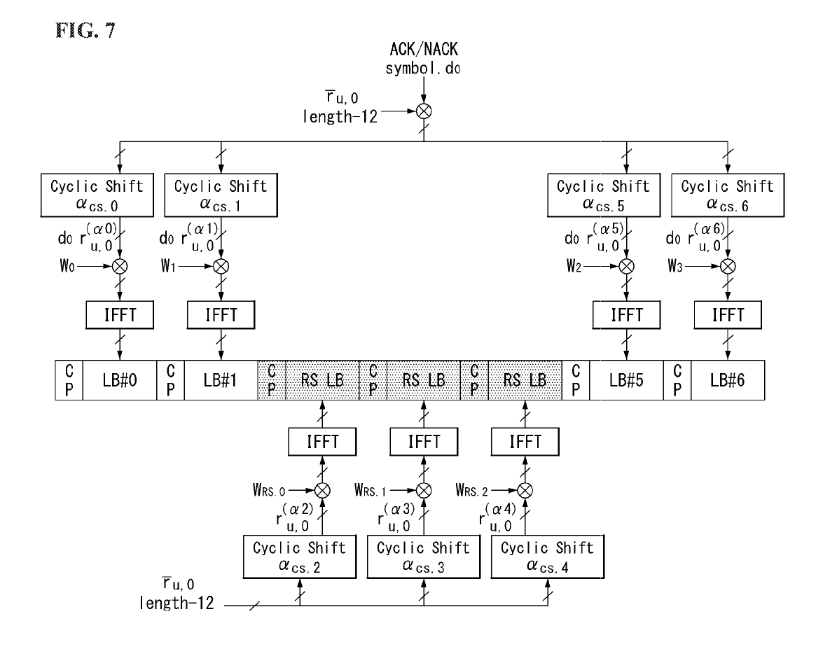

FIG. 7 illustrates a structure of an ACK/NACK channel in the case of a general CP in the wireless communication system to which the present invention can be applied.

In FIG. 7, a PUCCH channel structure for transmitting the HARQ ACK/NACK without the CQI is exemplarily illustrated.

The reference signal (DMRS) is loaded on three consecutive SC-FDMA symbols in a middle part among 7 SC-FDMA symbols and the ACK/NACK signal is loaded on 4 residual SC-FDMA symbols.

Meanwhile, in the case of the extended CP, the RS may be loaded on two consecutive symbols in the middle part. The number of and the positions of symbols used in the RS may vary depending on the control channel and the numbers and the positions of symbols used in the ACK/NACK signal associated with the positions of symbols used in the RS may also correspondingly vary depending on the control channel.

Acknowledgment response information (not scrambled status) of 1 bit and 2 bits may be expressed as one HARQ ACK/NACK modulated symbol by using the BPSK and QPSK modulation techniques, respectively. A positive acknowledgement response (ACK) may be encoded as ‘1’ and a negative acknowledgment response (NACK) may be encoded as ‘0’.

When a control signal is transmitted in an allocated band, 2-dimensional (D) spread is adopted in order to increase a multiplexing capacity. That is, frequency domain spread and time domain spread are simultaneously adopted in order to increase the number of terminals or control channels which may be multiplexed.

A frequency domain sequence is used as the base sequence in order to spread the ACK/NACK signal in the frequency domain. A Zadoff-Chu (ZC) sequence which is one of the CAZAC sequences may be used as the frequency domain sequence. For example, different CSs are applied to the ZC sequence which is the base sequence, and as a result, multiplexing different terminals or different control channels may be applied. The number of CS resources supported in an SC-FDMA symbol for PUCCH RBs for HARQ ACK/NACK transmission is set by a cell-specific upper-layer signaling parameter (Δ_{shift}^{PUCCH}).

The ACK/NACK signal which is frequency-domain spread is spread in the time domain by using an orthogonal spreading code. As the orthogonal spreading code, a Walsh-Hadamard sequence or DFT sequence may be used. For example, the ACK/NACK signal may be spread by using an orthogonal sequence (w0, w1, w2, and w3) having the length of 4 with respect to 4 symbols. Further, the RS is also spread through an orthogonal sequence having the length of 3 or 2. This is referred to as orthogonal covering (OC).

Multiple terminals may be multiplexed by a code division multiplexing (CDM) scheme by using the CS resources in the frequency domain and the OC resources in the time domain described above. That is, ACK/NACK information and RSs of a lot of terminals may be multiplexed on the same PUCCH RB.

In respect to the time-domain spread CDM, the number of spreading codes supported with respect to the ACK/NACK information is limited by the number of RS symbols. That is, since the number of RS transmitting SC-FDMA symbols is smaller than that of ACK/NACK information transmitting SC-FDMA symbols, the multiplexing capacity of the RS is smaller than that of the ACK/NACK information.

For example, in the case of the general CP, the ACK/NACK information may be transmitted in four symbols and not 4 but 3 orthogonal spreading codes are used for the ACK/NACK information and the reason is that the number of RS transmitting symbols is limited to 3 to use only 3 orthogonal spreading codes for the RS.

In the case of the subframe of the general CP, when 3 symbols are used for transmitting the RS and 4 symbols are used for transmitting the ACK/NACK information in one slot, for example, if 6 CSs in the frequency domain and 3 orthogonal cover (OC) resources may be used, HARQ acknowledgement responses from a total of 18 different terminals may be multiplexed in one PUCCH RB. In the case of the subframe of the extended CP, when 2 symbols are used for transmitting the RS and 4 symbols are used for transmitting the ACK/NACK information in one slot, for example, if 6 CSs in the frequency domain and 2 orthogonal cover (OC) resources may be used, the HARQ acknowledgement responses from a total of 12 different terminals may be multiplexed in one PUCCH RB.

Next, PUCCH format 1 is described. The scheduling request (SR) is transmitted by a scheme in which the terminal requests scheduling or does not request the scheduling. An SR channel reuses an ACK/NACK channel structure in PUCCH format 1a/1b and is configured by an on-off keying (OOK) scheme based on an ACK/NACK channel design. In the SR channel, the reference signal is not transmitted. Therefore, in the case of the general CP, a sequence having a length of 7 is used and in the case of the extended CP, a sequence having a length of 6 is used. Different cyclic shifts (CSs) or orthogonal covers (OCs) may be allocated to the SR and the ACK/NACK. That is, the terminal transmits the HARQ ACK/NACK through a resource allocated for the SR in order to transmit a positive SR. The terminal transmits the HARQ ACK/NACK through a resource allocated for the ACK/NACK in order to transmit a negative SR.

Next, an enhanced-PUCCH (e-PUCCH) format is described. An e-PUCCH may correspond to PUCCH format 3 of an LTE-A system. A block spreading technique may be applied to ACK/NACK transmission using PUCCH format 3.

PUCCH Piggybacking in Rel-8 LTE

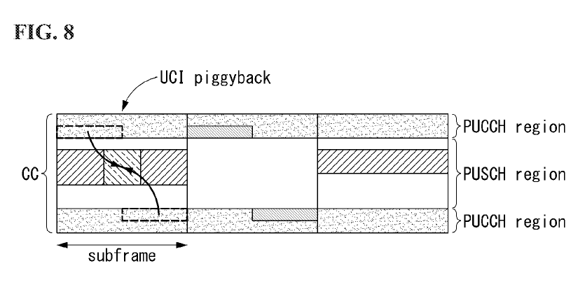

FIG. 8 illustrates one example of transport channel processing of a UL-SCH in the wireless communication system to which the present invention can be applied.

In a 3GPP LTE system (=E-UTRA, Rel. 8), in the case of the UL, single carrier transmission having an excellent peak-to-average power ratio (PAPR) or cubic metric (CM) characteristic which influences the performance of a power amplifier is maintained for efficient utilization of the power amplifier of the terminal. That is, in the case of transmitting the PUSCH of the existing LTE system, data to be transmitted may maintain the single carrier characteristic through DFT-precoding and in the case of transmitting the PUCCH, information is transmitted while being loaded on a sequence having the single carrier characteristic to maintain the single carrier characteristic. However, when the data to be DFT-precoded is non-contiguously allocated to a frequency axis or the PUSCH and the PUCCH are simultaneously transmitted, the single carrier characteristic deteriorates. Therefore, when the PUSCH is transmitted in the same subframe as the transmission of the PUCCH as illustrated in FIG. 11, uplink control information (UCI) to be transmitted to the PUCCH is transmitted (piggyback) together with data through the PUSCH.

Since the PUCCH and the PUSCH may not be simultaneously transmitted as described above, the existing LTE terminal uses a method that multiplexes uplink control information (UCI) (CQI/PMI, HARQ-ACK, RI, and the like) to the PUSCH region in a subframe in which the PUSCH is transmitted.

As one example, when the channel quality indicator (CQI) and/or precoding matrix indicator (PMI) needs to be transmitted in a subframe allocated to transmit the PUSCH, UL-SCH data and the CQI/PMI are multiplexed after DFT-spreading to transmit both control information and data. In this case, the UL-SCH data is rate-matched by considering a CQI/PMI resource. Further, a scheme is used, in which the control information such as the HARQ ACK, the RI, and the like punctures the UL-SCH data to be multiplexed to the PUSCH region.

FIG. 9 illustrates one example of a signal processing process of an uplink share channel of a transport channel in the wireless communication system to which the present invention can be applied.

Herein, the signal processing process of the uplink share channel (hereinafter, referred to as “UL-SCH”) may be applied to one or more transport channels or control information types.

Referring to FIG. 9, the UL-SCH transfers data to a coding unit in the form of a transport block (TB) once every a transmission time interval (TTI).

A CRC parity bit p₀, p₁, p₂, p₃, . . . , p_{L-1} is attached to a bit of the transport block received from the upper layer (S120). In this case, A represents the size of the transport block and L represents the number of parity bits. Input bits to which the CRC is attached are shown in b₀, b₁, b₂, b₃, . . . , b_{B-1}. In this case, B represents the number of bits of the transport block including the CRC.

b₀, b₁, b₂, b₃, . . . , b_{B-1} is segmented into multiple code blocks (CBs) according to the size of the TB and the CRC is attached to multiple segmented CBs (S121). Bits after the code block segmentation and the CRC attachment are shown in cᵣ₀, cᵣ₁, cᵣ₂, cᵣ₃, . . . , c_{r(K}_{ᵣ}₁₎. Herein, r represents No. (r=0, . . . , C−1) of the code block and Kr represents the bit number depending on the code block r. Further, C represents the total number of code blocks.

Subsequently, channel coding is performed (S122). Output bits after the channel coding are shown in dᵣ₀⁽ⁱ⁾, dᵣ₁⁽ⁱ⁾, dᵣ₃⁽ⁱ⁾, . . . , d_{r(D}_{ᵣ}₋₁₎⁽ⁱ⁾. In this case, i represents an encoded stream index and may have a value of 0, 1, or 2. Dr represents the number of bits of the i-th encoded stream for the code block r. r represents the code block number (r=0, . . . , C−1) and C represents the total number of code blocks. Each code block may be encoded by turbo coding.

Subsequently, rate matching is performed (S123). Bits after the rate matching are shown in eᵣ₀, eᵣ₁, eᵣ₂, eᵣ₃, . . . , e_{r(E}_{ᵣ}₋₁). In this case, r represents the code block number (r=0, . . . , C−1) and C represents the total number of code blocks. Er represents the number of rate-matched bits of the r-th code block.

Subsequently, concatenation among the code blocks is performed again (S124). Bits after the concatenation of the code blocks is performed are shown in f₀, f₁, f₂, f₃, . . . , f_{G-1}. In this case, G represents the total number of bits encoded for transmission and when the control information is multiplexed with the UL-SCH, the number of bits used for transmitting the control information is not included.

Meanwhile, when the control information is transmitted in the PUSCH, channel coding of the CQI/PMI, the RI, and the ACK/NACK which are the control information is independently performed (S126, S127, and S128). Since different encoded symbols are allocated for transmitting each control information, the respective control information has different coding rates.

In time division duplex (TDD), as an ACK/NACK feedback mode, two modes of ACK/NACK bundling and ACK/NACK multiplexing are supported by an upper-layer configuration. ACK/NACK information bits for the ACK/NACK bundling are constituted by 1 bit or 2 bits and ACK/NACK information bits for the ACK/NACK multiplexing are constituted by 1 to 4 bits.

After the concatenation among the code blocks in step S134, encoded bits f₀, f₁, f₂, f₃, . . . , f_{G-1} of the UL-SCH data and encoded bits q₀, q₁, q₂, q₃, . . . , q_{N}_{_{L}}_{·Q}_{_{CQI}}₋₁ of the CQI/PMI are multiplexed (S125). A multiplexed result of the data and the CQI/PMI is shown in g₀, g₁, g₂, g₃, . . . , g_{H′-1}. In this case, gᵢ (i=0, . . . , H′−1) represents a column vector having a length of (Qₘ·N_{L}). H=(G+N_{L}·Q_{CQI}) and H′=H/(N_{L}·Qₘ). N_{L} represents the number of layers mapped to a UL-SCH transport block and H represents the total number of encoded bits allocated to N_{L} transport layers mapped with the transport block for the UL-SCH data and the CQI/PMI information.

Subsequently, the multiplexed data and CQI/PMI, a channel encoded RI, and the ACK/NACK are channel-interleaved to generate an output signal (S129).

Reference Signal (RS)

In the wireless communication system, since the data is transmitted through the radio channel, the signal may be distorted during transmission. In order for the receiver side to accurately receive the distorted signal, the distortion of the received signal needs to be corrected by using channel information. In order to detect the channel information, a signal transmitting method know by both the transmitter side and the receiver side and a method for detecting the channel information by using an distortion degree when the signal is transmitted through the channel are primarily used. The aforementioned signal is referred to as a pilot signal or a reference signal (RS).

Furthermore, recently, a method capable of improving transmission/reception data efficiency by adopting a multi-Tx antenna and a multi-Rx antenna without using one Tx antenna and one Rx antenna as in a conventional technology when a packet is transmitted is used in most of mobile communication systems.

When the data is transmitted and received by using the MIMO antenna, a channel state between the transmitting antenna and the receiving antenna need to be detected in order to accurately receive the signal. Therefore, the respective transmitting antennas need to have individual reference signals.

The downlink reference signal includes a common RS (CRS) shared by all terminals in one cell and a dedicated RS (DRS) for a specific terminal. Information for demodulation and channel measurement may be provided by using the reference signals.

The receiver side (that is, terminal) measures the channel state from the CRS and feeds back the indicators associated with the channel quality, such as the channel quality indicator (CQI), the precoding matrix index (PMI), and/or the rank indicator (RI) to the transmitting side (that is, base station). The CRS is also referred to as a cell-specific RS. On the contrary, a reference signal associated with a feed-back of channel state information (CSI) may be defined as CSI-RS.

The DRS may be transmitted through resource elements when data demodulation on the PDSCH is required. The terminal may receive whether the DRS is present through the upper layer and is valid only when the corresponding PDSCH is mapped. The DRS may be referred to as the UE-specific RS or the demodulation RS (DMRS).

In a mobile communication system, a reference signal (RS) may be basically divided into two types depending on purposes. That is, the RS includes an RS for obtaining channel information and an RS for data demodulation. The former has its object that allows UE to obtain downlink channel information. Accordingly, the RS needs to be transmitted in a broadband. UE must be capable of receiving and measuring the RS although the UE does not receive downlink data in a specific subframe. Furthermore, the RS is also used for measurement, such as handover. In contrast, the latter is an RS transmitted in a corresponding resource when an eNB transmits downlink data. UE can perform channel measurement by receiving a corresponding RS and thus demodulate data. The RS needs to be transmitted in a region in which the data is transmitted.

In the Release 8 LTE system, two types of downlink RSs have been defined for unicast service. The two types of downlink RSs include a common RS (CRS) for obtaining information about a channel state and for measurement, such as handover, and a UE-specific RS also called a dedicated RS used for data demodulation. In the Release 8 LTE system, a UE-specific RS is used for only data demodulation, and a CRS is used for the two objects of the acquisition of channel information and data demodulation. The CRS is a cell-specific signal and transmitted for each subframe with respect to a broadband. In the cell-specific CRS, an RS for a maximum of 4 antenna ports is transmitted depending on the number of Tx antennas of an eNB. For example, if the number of Tx antennas of an eNB is two, CRSs for Nos. 0 and 1 antenna ports are transmitted. If the number of Tx antennas of an eNB is four, CRSs for respective Nos. 0-3 antenna ports are transmitted.

Furthermore, in the LTE system, if a CRS is mapped to a time-frequency resource, an RS for one antenna port in a frequency axis is mapped to one RE per 6 REs and transmitted.

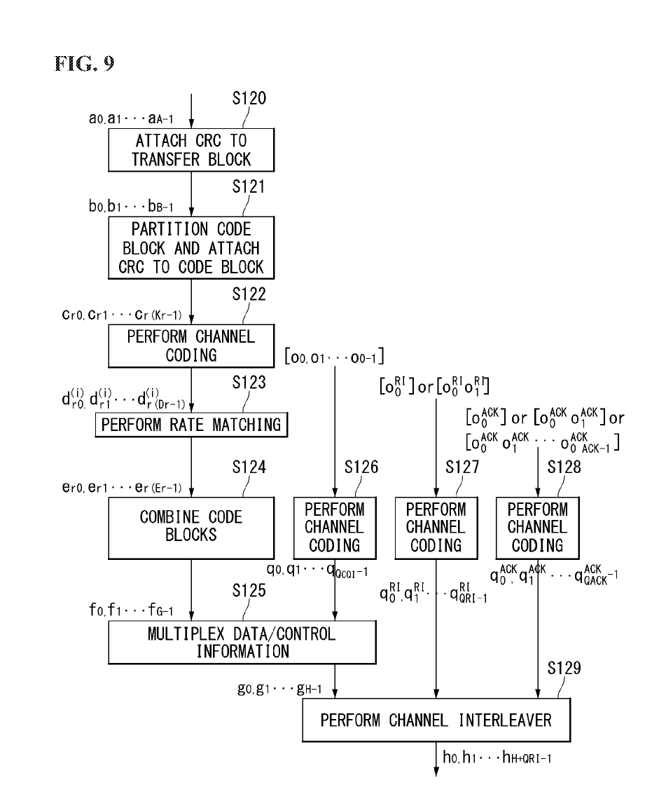

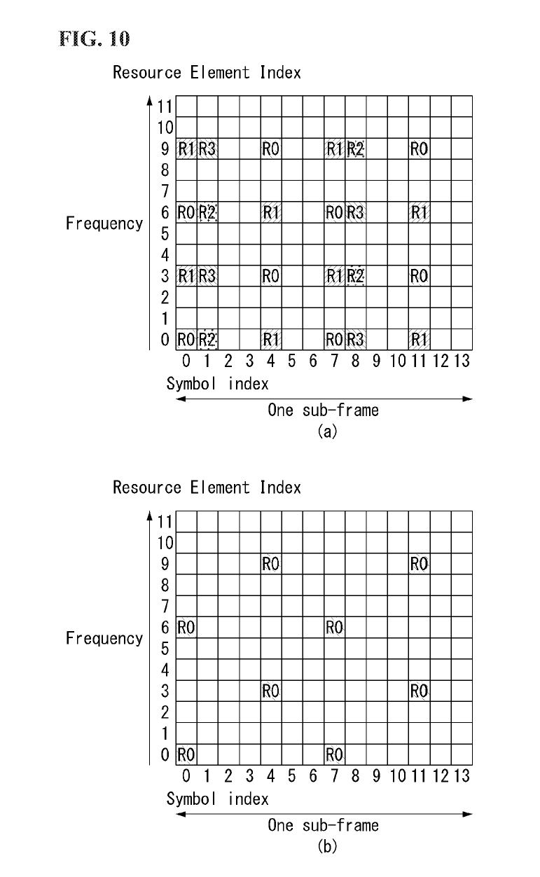

FIG. 10 illustrates examples of a cell-specific reference signal (CRS) pattern in 1 resource block (RB) to which an embodiment of the present invention may be applied.

FIG. 10(a) corresponds to a case where the number of Tx antennas of an eNB is 4. In this case, CRSs corresponding to Nos. 0 to 3 antenna ports, respectively, are transmitted. Furthermore, FIG. 10(b) corresponds to a case where the number of Tx antennas of an eNB is 1. A CRS corresponding to a No. 1 antenna port is transmitted.

Furthermore, in an LTE-A system advanced from an LTE system, a system needs to be designed to support a maximum of 8 Tx antennas for the downlink of an eNB. Accordingly, an RS for a maximum of 8 Tx antennas also needs to be supported. In an LTE system, a downlink RS has been defined for only an RS for a maximum of 4 antenna ports. If an eNB has 4 downlink Tx antennas to a maximum of 8 downlink Tx antennas in an LTE-A system, an RS for the antenna ports need to be additionally defined and designed. For an RS for a maximum of 8 Tx antenna ports, both the aforementioned RS for channel measurement and the aforementioned RS for data demodulation have to be designed.

One of important factors that need to be taken into consideration in designing an LTE-A system is backward compatibility, that is, that LTE UE must well operate even in the LTE-A system without any problem and the system must support such an UE operation. From a viewpoint of RS transmission, an RS for a maximum of 8 Tx antenna ports needs to be additionally defined in a time-frequency domain in which a CRS defined in LTE is transmitted in a full band every subframe. In the LTE-A system, if an RS pattern for a maximum of 8 Tx antennas is added to a full band every subframe as in a method, such as the CRS of existing LTE, RS overhead is excessively increased. Accordingly, an RS newly designed in the LTE-A system is basically divided into two types: an RS (i.e., a channel state information-RS or channel state indication-RS (CSI-RS) for a channel measurement object for selecting an MCS, a PMI, etc. and an RS (i.e., a data modulation-RS (DM-RS) for a data demodulation object which is transmitted in 8 Tx antennas. The CSI-RS for the channel measurement object is designed for an object focused on channel measurement unlike the existing CRS used for channel measurement and measurement, such as handover, and data demodulation. Furthermore, the CSI-RS for the channel measurement object may also be used for an object of measurement, such as handover. The CSI-RS does not need to be transmitted every subframe unlike a CRS because it is transmitted for an object of obtaining information about a channel state. In order to reduce overhead for the CSI-RS, the CSI-RS is intermittently transmitted in a time axis. For data demodulation, a DM RS is transmitted dedicatedly to UE that has been scheduled in a corresponding time-frequency domain. That is, the DM-RS of specific UE is transmitted only in a region in which the specific UE has been scheduled, that is, in a time-frequency domain in which data is received.

FIG. 11 illustrates a reference signal pattern mapped to a downlink resource block pair in the wireless communication system to which the present invention can be applied.

Referring to FIG. 15, as a wise in which the reference signal is mapped, the downlink resource block pair may be expressed by one subframe in the time domain×12 subcarriers in the frequency domain. That is, one resource block pair has a length of 14 OFDM symbols in the case of a normal cyclic prefix (CP) (FIG. 15a) and a length of 12 OFDM symbols in the case of an extended cyclic prefix (CP) (FIG. 15b). Resource elements (REs) represented as ‘0’, ‘1’, ‘2’, and ‘3’ in a resource block lattice mean the positions of the CRSs of antenna port indexes ‘0’, ‘1’, ‘2’, and ‘3’, respectively and resource elements represented as ‘D’ means the position of the DRS.

Hereinafter, when the CRS is described in more detail, the CRS is used to estimate a channel of a physical antenna and distributed in a whole frequency band as the reference signal which may be commonly received by all terminals positioned in the cell. Further, the CRS may be used to demodulate the channel quality information (CSI) and data.

The CRS is defined as various formats according to an antenna array at the transmitter side (base station). The 3GPP LTE system (for example, release-8) supports various antenna arrays and a downlink signal transmitting side has three types of antenna arrays of three single transmitting antennas, two transmitting antennas, and four transmitting antennas. When the base station uses the single transmitting antenna, a reference signal for a single antenna port is arrayed. When the base station uses two transmitting antennas, reference signals for two transmitting antenna ports are arrayed by using a time division multiplexing (TDM) scheme and/or a frequency division multiplexing (FDM) scheme. That is, different time resources and/or different frequency resources are allocated to the reference signals for two antenna ports which are distinguished from each other.

Moreover, when the base station uses four transmitting antennas, reference signals for four transmitting antenna ports are arrayed by using the TDM and/or FDM scheme. Channel information measured by a downlink signal receiving side (terminal) may be used to demodulate data transmitted by using a transmission scheme such as single transmitting antenna transmission, transmission diversity, closed-loop spatial multiplexing, open-loop spatial multiplexing, or multi-user MIMO.

In the case where the MIMO antenna is supported, when the reference signal is transmitted from a specific antenna port, the reference signal is transmitted to the positions of specific resource elements according to a pattern of the reference signal and not transmitted to the positions of the specific resource elements for another antenna port. That is, reference signals among different antennas are not duplicated with each other.

A rule of mapping the CRS to the resource block is defined as below.

$$k = 6 m + ( v + {v}_{shift} ) mod 6 \\ l = \{ \begin{matrix}0 , {N}_{symb}^{DL} - 3 & if p ∈ \{ 0 , 1 \} \\ 1 & if p ∈ \{ 2 , 3 \}\end{matrix} \\ m = 0 , 1 , … , 2 \cdot {N}_{RB}^{DL} - 1 \\ {m}^{′} = m + {N}_{RB}^{max , DL} - {N}_{RB}^{DL} \\ v = \{ \begin{matrix}0 & if p = 0 and l = 0 \\ 3 & if p = 0 and l \neq 0 \\ 3 & if p = 1 and l = 0 \\ 0 & if p = 1 and l \neq 0 \\ 3 ( {n}_{s} mod 2 ) & if p = 2 \\ 3 + 3 ( {n}_{s} mod 2 ) & if p = 3\end{matrix} \\ {v}_{shift} = {N}_{ID}^{cell} mod 6 \qquad [ Equation 1 ]$$

In Equation 1, k and l represent the subcarrier index and the symbol index, respectively and p represents the antenna port. N_{symb}^{DL} represents the number of OFDM symbols in one downlink slot and N_{RB}^{DL} represents the number of radio resources allocated to the downlink. nₛ represents a slot index and, N_{ID}^{cell} cell m represents a cell ID. mod represents an modulo operation. The position of the reference signal varies depending on the ν_{shift} value in the frequency domain. Since ν_{shift} is subordinated to the cell ID, the position of the reference signal has various frequency shift values according to the cell.

In more detail, the position of the CRS may be shifted in the frequency domain according to the cell in order to improve channel estimation performance through the CRS. For example, when the reference signal is positioned at an interval of three subcarriers, reference signals in one cell are allocated to a 3k-th subcarrier and a reference signal in another cell is allocated to a 3k+1-th subcarrier. In terms of one antenna port, the reference signals are arrayed at an interval of six resource elements in the frequency domain and separated from a reference signal allocated to another antenna port at an interval of three resource elements.

In the time domain, the reference signals are arrayed at a constant interval from symbol index 0 of each slot. The time interval is defined differently according to a cyclic shift length. In the case of the normal cyclic shift, the reference signal is positioned at symbol indexes 0 and 4 of the slot and in the case of the extended CP, the reference signal is positioned at symbol indexes 0 and 3 of the slot. A reference signal for an antenna port having a maximum value between two antenna ports is defined in one OFDM symbol. Therefore, in the case of transmission of four transmitting antennas, reference signals for reference signal antenna ports 0 and 1 are positioned at symbol indexes 0 and 4 (symbol indexes 0 and 3 in the case of the extended CP) and reference signals for antenna ports 2 and 3 are positioned at symbol index 1 of the slot. The positions of the reference signals for antenna ports 2 and 3 in the frequency domain are exchanged with each other in a second slot.

Hereinafter, when the DRS is described in more detail, the DRS is used for demodulating data. A precoding weight used for a specific terminal in the MIMO antenna transmission is used without a change in order to estimate a channel associated with and corresponding to a transmission channel transmitted in each transmitting antenna when the terminal receives the reference signal.

The 3GPP LTE system (for example, release-8) supports a maximum of four transmitting antennas and a DRS for rank 1 beamforming is defined. The DRS for the rank 1 beamforming also means a reference signal for antenna port index 5.

A rule of mapping the DRS to the resource block is defined as below. Equation 2 shows the case of the normal CP and Equation 3 shows the case of the extended CP.

$$\begin{matrix}k = ( {k}^{′} ) mod {N}_{sc}^{RB} + {N}_{sc}^{RB} \cdot {n}_{PRB} \\ {k}^{′} = \{ \begin{matrix}4 {m}^{′} + {v}_{shift} & if l ∈ \{ 2 , 3 \} \\ 4 {m}^{′} + ( 2 + {v}_{shift} ) mod 4 & if l ∈ \{ 5 , 6 \}\end{matrix} \\ l = \{ \begin{matrix}3 & {l}^{′} = 0 \\ 6 & {l}^{′} = 1 \\ 2 & {l}^{′} = 2 \\ 5 & {l}^{′} = 3\end{matrix} \\ {l}^{′} = \{ \begin{matrix}0 , 1 & if {n}_{s} mod 2 = 0 \\ 2 , 3 & if {n}_{s} mod 2 = 1\end{matrix} \\ {m}^{′} = 0 , 1 , … , 3 {N}_{RB}^{PDSCH} - 1 \\ {v}_{shift} = {N}_{ID}^{cell} mod 3 & [ Equation 2 ] \\ k = ( {k}^{′} ) mod {N}_{sc}^{RB} + {N}_{sc}^{RB} \cdot {n}_{PRB} \\ {k}^{′} = \{ \begin{matrix}3 {m}^{′} + {v}_{shift} & if l = 4 \\ 3 {m}^{′} + ( 2 + {v}_{shift} ) mod 3 & if l = 1\end{matrix} \\ l = \{ \begin{matrix}4 & {l}^{′} ∈ \{ 0 , 2 \} \\ 1 & {l}^{′} = 1\end{matrix} \\ {l}^{′} = \{ \begin{matrix}0 & if {n}_{s} mod 2 = 0 \\ 1 , 2 & if {n}_{s} mod 2 = 1\end{matrix} \\ {m}^{′} = 0 , 1 , … , 4 {N}_{RB}^{PDSCH} - 1 \\ {v}_{shift} = {N}_{ID}^{cell} mod 3 & [ Equation 3 ]\end{matrix}$$

In Equations 1 to 3 given above, k and p represent the subcarrier index and the antenna port, respectively. N_{RB}^{DL}, nₛ, and N_{ID}^{cell} represent the number of RBs, the number of slot indexes, and the number of cell IDs allocated to the downlink, respectively. The position of the RS varies depending on the ν_{shift} value in terms of the frequency domain.

In Equations 2 and 3, k and l represent the subcarrier index and the symbol index, respectively and p represents the antenna port. N_{sc}^{RB} represents the size of the resource block in the frequency domain and is expressed as the number of subcarriers. n_{PRB} represents the number of physical resource blocks. N_{RB}^{PDSCH} represents a frequency band of the resource block for the PDSCH transmission. nₛ represents the slot index and N_{ID}^{cell} represents the cell ID. mod represents the modulo operation. The position of the reference signal varies depending on the ν_{shift} value in the frequency domain. Since ν_{shift} is subordinated to the cell ID, the position of the reference signal has various frequency shift values according to the cell.

Sounding Reference Signal (SRS)

The SRS is primarily used for the channel quality measurement in order to perform frequency-selective scheduling and is not associated with transmission of the uplink data and/or control information. However, the SRS is not limited thereto and the SRS may be used for various other purposes for supporting improvement of power control and various start-up functions of terminals which have not been scheduled. One example of the start-up function may include an initial modulation and coding scheme (MCS), initial power control for data transmission, timing advance, and frequency semi-selective scheduling. In this case, the frequency semi-selective scheduling means scheduling that selectively allocates the frequency resource to the first slot of the subframe and allocates the frequency resource by pseudo-randomly hopping to another frequency in the second slot.

Further, the SRS may be used for measuring the downlink channel quality on the assumption that the radio channels between the uplink and the downlink are reciprocal. The assumption is valid particularly in the time division duplex in which the uplink and the downlink share the same frequency spectrum and are divided in the time domain.

Subframes of the SRS transmitted by any terminal in the cell may be expressed by a cell-specific broadcasting signal. A 4-bit cell-specific ‘srsSubframeConfiguration’ parameter represents 15 available subframe arrays in which the SRS may be transmitted through each radio frame. By the arrays, flexibility for adjustment of the SRS overhead is provided according to a deployment scenario.

A 16-th array among them completely turns off a switch of the SRS in the cell and is suitable primarily for a serving cell that serves high-speed terminals.

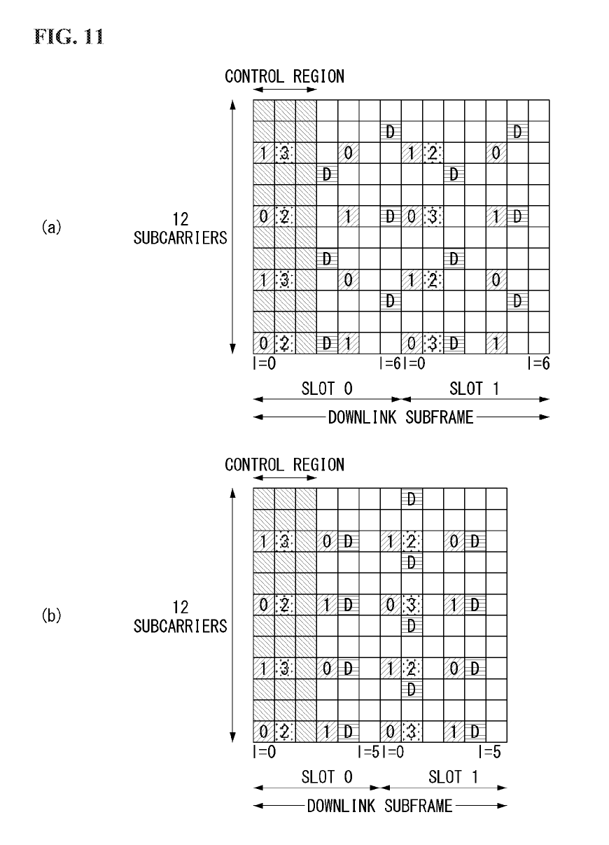

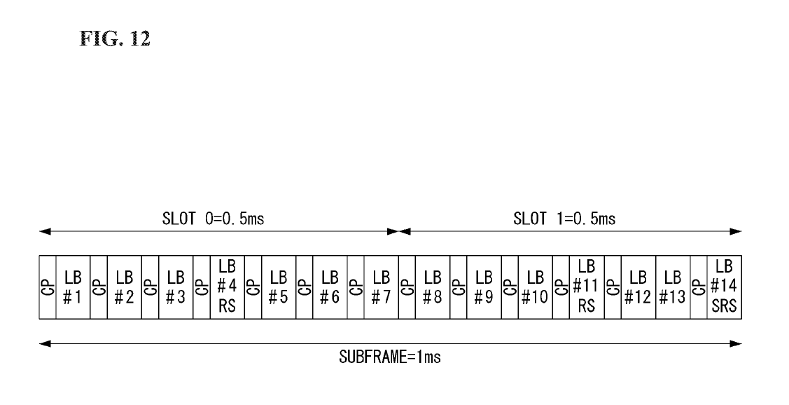

FIG. 12 illustrates an uplink subframe including a sounding reference signal symbol in the wireless communication system to which the present invention can be applied.

Referring to FIG. 12, the SRS is continuously transmitted through a last SC FDMA symbol on the arrayed subframes. Therefore, the SRS and the DMRS are positioned at different SC-FDMA symbols.

The PUSCH data transmission is not permitted in a specific SC-FDMA symbol for the SRS transmission and consequently, when sounding overhead is highest, that is, even when the SRS symbol is included in all subframes, the sounding overhead does not exceed approximately 7%.

Each SRS symbol is generated by a base sequence (random sequence or a sequence set based on Zadoff-Ch (ZC)) associated with a given time wise and a given frequency band and all terminals in the same cell use the same base sequence. In this case, SRS transmissions from a plurality of terminals in the same cell in the same frequency band and at the same time are orthogonal to each other by different cyclic shifts of the base sequence to be distinguished from each other.

SRS sequences from different cells may be distinguished from each other by allocating different base sequences to respective cells, but orthogonality among different base sequences is not assured.

General Carrier Aggregation

A communication environment considered in embodiments of the present invention includes multi-carrier supporting environments. That is, a multi-carrier system or a carrier aggregation system used in the present invention means a system that aggregates and uses one or more component carriers (CCs) having a smaller bandwidth smaller than a target band at the time of configuring a target wideband in order to support a wideband.

In the present invention, multi-carriers mean aggregation of (alternatively, carrier aggregation) of carriers and in this case, the aggregation of the carriers means both aggregation between continuous carriers and aggregation between non-contiguous carriers. Further, the number of component carriers aggregated between the downlink and the uplink may be differently set. A case in which the number of downlink component carriers (hereinafter, referred to as ‘DL CC’) and the number of uplink component carriers (hereinafter, referred to as ‘UL CC’) are the same as each other is referred to as symmetric aggregation and a case in which the number of downlink component carriers and the number of uplink component carriers are different from each other is referred to as asymmetric aggregation. The carrier aggregation may be used mixedly with a term such as the carrier aggregation, the bandwidth aggregation, spectrum aggregation, or the like.

The carrier aggregation configured by combining two or more component carriers aims at supporting up to a bandwidth of 100 MHz in the LTE-A system. When one or more carriers having the bandwidth than the target band are combined, the bandwidth of the carriers to be combined may be limited to a bandwidth used in the existing system in order to maintain backward compatibility with the existing IMT system. For example, the existing 3GPP LTE system supports bandwidths of 1.4, 3, 5, 10, 15, and 20 MHz and a 3GPP LTE-advanced system (that is, LTE-A) may be configured to support a bandwidth larger than 20 MHz by using on the bandwidth for compatibility with the existing system. Further, the carrier aggregation system used in the preset invention may be configured to support the carrier aggregation by defining a new bandwidth regardless of the bandwidth used in the existing system.

The LTE-A system uses a concept of the cell in order to manage a radio resource.

The carrier aggregation environment may be called a multi-cell environment. The cell is defined as a combination of a pair of a downlink resource (DL CC) and an uplink resource (UL CC), but the uplink resource is not required. Therefore, the cell may be constituted by only the downlink resource or both the downlink resource and the uplink resource. When a specific terminal has only one configured serving cell, the cell may have one DL CC and one UL CC, but when the specific terminal has two or more configured serving cells, the cell has DL CCs as many as the cells and the number of UL CCs may be equal to or smaller than the number of DL CCs.

Alternatively, contrary to this, the DL CC and the UL CC may be configured. That is, when the specific terminal has multiple configured serving cells, a carrier aggregation environment having UL CCs more than DL CCs may also be supported. That is, the carrier aggregation may be appreciated as aggregation of two or more cells having different carrier frequencies (center frequencies). Herein, the described ‘cell’ needs to be distinguished from a cell as an area covered by the base station which is generally used.

The cell used in the LTE-A system includes a primary cell (PCell) and a secondary cell (SCell. The P cell and the S cell may be used as the serving cell. In a terminal which is in an RRC_CONNECTED state, but does not have the configured carrier aggregation or does not support the carrier aggregation, only one serving constituted by only the P cell is present. On the contrary, in a terminal which is in the RRC_CONNECTED state and has the configured carrier aggregation, one or more serving cells may be present and the P cell and one or more S cells are included in all serving cells.

The serving cell (P cell and S cell) may be configured through an RRC parameter. PhysCellId as a physical layer identifier of the cell has integer values of 0 to 503. SCellIndex as a short identifier used to identify the S cell has integer values of 1 to 7. ServCellIndex as a short identifier used to identify the serving cell (P cell or S cell) has the integer values of 0 to 7. The value of 0 is applied to the P cell and SCellIndex is previously granted for application to the S cell. That is, a cell having a smallest cell ID (alternatively, cell index) in ServCellIndex becomes the P cell.

The P cell means a cell that operates on a primary frequency (alternatively, primary CC). The terminal may be used to perform an initial connection establishment process or a connection re-establishment process and may be designated as a cell indicated during a handover process. Further, the P cell means a cell which becomes the center of control associated communication among serving cells configured in the carrier aggregation environment. That is, the terminal may be allocated with and transmit the PUCCH only in the P cell thereof and use only the P cell to acquire the system information or change a monitoring procedure. An evolved universal terrestrial radio access (E-UTRAN) may change only the P cell for the handover procedure to the terminal supporting the carrier aggregation environment by using an RRC connection reconfiguration message (RRCConnectionReconfiguration) message of an upper layer including mobile control information (mobilityControlInfo).

The S cell means a cell that operates on a secondary frequency (alternatively, secondary CC). Only one P cell may be allocated to a specific terminal and one or more S cells may be allocated to the specific terminal. The S cell may be configured after RRC connection establishment is achieved and used for providing an additional radio resource. The PUCCH is not present in residual cells other than the P cell, that is, the S cells among the serving cells configured in the carrier aggregation environment. The E-UTRAN may provide all system information associated with a related cell which is in an RRC_CONNECTED state through a dedicated signal at the time of adding the S cells to the terminal that supports the carrier aggregation environment. A change of the system information may be controlled by releasing and adding the related S cell and in this case, the RRC connection reconfiguration (RRCConnectionReconfiguration) message of the upper layer may be used. The E-UTRAN may perform having different parameters for each terminal rather than broadcasting in the related S cell.

After an initial security activation process starts, the E-UTRAN adds the S cells to the P cell initially configured during the connection establishment process to configure a network including one or more S cells. In the carrier aggregation environment, the P cell and the S cell may operate as the respective component carriers. In an embodiment described below, the primary component carrier (PCC) may be used as the same meaning as the P cell and the secondary component carrier (SCC) may be used as the same meaning as the S cell.

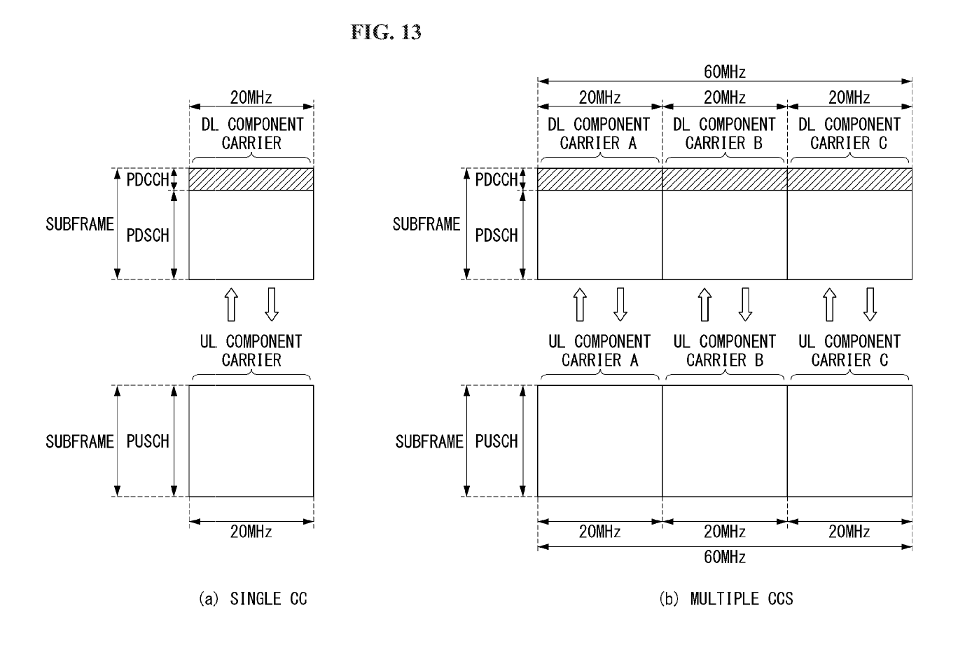

FIG. 13 illustrates examples of a component carrier and carrier aggregation in the wireless communication system to which the present invention can be applied.

FIG. 13a illustrates a single carrier structure used in an LTE system. The component carrier includes the DL CC and the UL CC. One component carrier may have a frequency range of 20 MHz.

FIG. 13b illustrates a carrier aggregation structure used in the LTE system. In the case of FIG. 9b, a case is illustrated, in which three component carriers having a frequency magnitude of 20 MHz are combined. Each of three DL CCs and three UL CCs is provided, but the number of DL CCs and the number of UL CCs are not limited. In the case of carrier aggregation, the terminal may simultaneously monitor three CCs, and receive downlink signal/data and transmit uplink signal/data.

When N DL CCs are managed in a specific cell, the network may allocate M (M≦N) DL CCs to the terminal. In this case, the terminal may monitor only M limited DL CCs and receive the DL signal. Further, the network gives L (L≦M≦N) DL CCs to allocate a primary DL CC to the terminal and in this case, UE needs to particularly monitor L DL CCs. Such a scheme may be similarly applied even to uplink transmission.

A linkage between a carrier frequency (alternatively, DL CC) of the downlink resource and a carrier frequency (alternatively, UL CC) of the uplink resource may be indicated by an upper-layer message such as the RRC message or the system information. For example, a combination of the DL resource and the UL resource may be configured by a linkage defined by system information block type 2 (SIB2). In detail, the linkage may mean a mapping relationship between the DL CC in which the PDCCH transporting a UL grant and a UL CC using the UL grant and mean a mapping relationship between the DL CC (alternatively, UL CC) in which data for the HARQ is transmitted and the UL CC (alternatively, DL CC) in which the HARQ ACK/NACK signal is transmitted.

Cross Carrier Scheduling

In the carrier aggregation system, in terms of scheduling for the carrier or the serving cell, two types of a self-scheduling method and a cross carrier scheduling method are provided. The cross carrier scheduling may be called cross component carrier scheduling or cross cell scheduling.

The cross carrier scheduling means transmitting the PDCCH (DL grant) and the PDSCH to different respective DL CCs or transmitting the PUSCH transmitted according to the PDCCH (UL grant) transmitted in the DL CC through other UL CC other than a UL CC linked with the DL CC receiving the UL grant.

Whether to perform the cross carrier scheduling may be UE-specifically activated or deactivated and semi-statically known for each terminal through the upper-layer signaling (for example, RRC signaling).

When the cross carrier scheduling is activated, a carrier indicator field (CIF) indicating through which DL/UL CC the PDSCH/PUSCH the PDSCH/PUSCH indicated by the corresponding PDCCH is transmitted is required. For example, the PDCCH may allocate the PDSCH resource or the PUSCH resource to one of multiple component carriers by using the CIF. That is, the CIF is set when the PDSCH or PUSCH resource is allocated to one of DL/UL CCs in which the PDCCH on the DL CC is multiply aggregated.

In this case, a DCI format of LTE-A Release-8 may extend according to the CIF. In this case, the set CIF may be fixed to a 3-bit field and the position of the set CIF may be fixed regardless of the size of the DCI format. Further, a PDCCH structure (the same coding and the same CCE based resource mapping) of the LTE-A Release-8 may be reused.

On the contrary, when the PDCCH on the DL CC allocates the PDSCH resource on the same DL CC or allocates the PUSCH resource on a UL CC which is singly linked, the CIF is not set. In this case, the same PDCCH structure (the same coding and the same CCE based resource mapping) and DCI format as the LTE-A Release-8 may be used.

When the cross carrier scheduling is possible, the terminal needs to monitor PDCCHs for a plurality of DCIs in a control region of a monitoring CC according to a transmission mode and/or a bandwidth for each CC. Therefore, a configuration and PDCCH monitoring of a search space which may support monitoring the PDCCHs for the plurality of DCIs are required.

In the carrier aggregation system, a terminal DL CC aggregate represents an aggregate of DL CCs in which the terminal is scheduled to receive the PDSCH and a terminal UL CC aggregate represents an aggregate of UL CCs in which the terminal is scheduled to transmit the PUSCH. Further, a PDCCH monitoring set represents a set of one or more DL CCs that perform the PDCCH monitoring. The PDCCH monitoring set may be the same as the terminal DL CC set or a subset of the terminal DL CC set. The PDCCH monitoring set may include at least any one of DL CCs in the terminal DL CC set. Alternatively, the PDCCH monitoring set may be defined separately regardless of the terminal DL CC set. The DL CCs included in the PDCCH monitoring set may be configured in such a manner that self-scheduling for the linked UL CC is continuously available. The terminal DL CC set, the terminal UL CC set, and the PDCCH monitoring set may be configured UE-specifically, UE group-specifically, or cell-specifically.

When the cross carrier scheduling is deactivated, the deactivation of the cross carrier scheduling means that the PDCCH monitoring set continuously means the terminal DL CC set and in this case, an indication such as separate signaling for the PDCCH monitoring set is not required. However, when the cross carrier scheduling is activated, the PDCCH monitoring set is preferably defined in the terminal DL CC set. That is, the base station transmits the PDCCH through only the PDCCH monitoring set in order to schedule the PDSCH or PUSCH for the terminal.

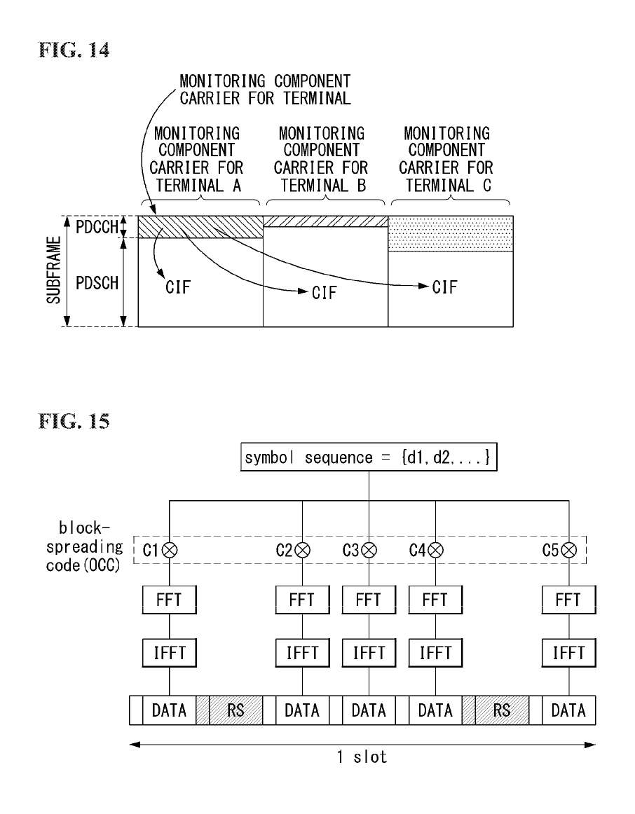

FIG. 14 illustrates one example of a subframe structure depending on cross carrier scheduling in the wireless communication system to which the present invention can be applied.

Referring to FIG. 14, a case is illustrated, in which three DL CCs are associated with a DL subframe for an LTE-A terminal and DL CC′A′ is configured as a PDCCH monitoring DL CC. When the CIF is not used, each DL CC may transmit the PDCCH scheduling the PDSCH thereof without the CIF. On the contrary, when the CIF is used through the upper-layer signaling, only one DL CC ‘A’ may transmit the PDCCH scheduling the PDSCH thereof or the PDSCH of another CC by using the CIF. In this case, DL CC ‘B’ and ‘C’ in which the PDCCH monitoring DL CC is not configured does not transmit the PDCCH.

PDCCH Assignment Procedure

A plurality of PDCCHs may be transmitted in a single subframe. That is, the control region of one subframe includes a plurality of CCEs having indices 0˜N_{CCE,k}−1. In this case, N_{CCE,k} means a total number of CCEs within the control region of a k-th subframe. UE monitors a plurality of PDCCHs every subframe. In this case, the term “monitoring” means that the UE attempts to decode each of PDCCHs according to the format of a monitored PDCCH. In a control region allocated within a subframe, an eNB does not provide UE with information about the position of a corresponding PDCCH. The UE is unaware that its own PDCCH is transmitted at which position in what CCE aggregation level or according to which DCI format in order to receive a control channel transmitted by the eNB. Accordingly, the UE searches for the PDCCH by monitoring a set of PDCCH candidates within a subframe. This is called blind decoding/detection (BD). Blind decoding refers to a method of demasking, by UE, its own UE ID to a CRC portion and then checking whether a corresponding PDCCH is its own control channel by reviewing a CRC error.

In active mode, UE monitors the PDCCH of each subframe in order to receive data transmitted to the UE. In DRX mode, UE wakes up in the monitoring period of each DRX cycle and monitors a PDCCH in a subframe corresponding to the monitoring period. A subframe in which the monitoring of the PDCCH is performed is called a non-DRX subframe.

In order to receive a PDCCH transmitted to UE, the UE has to perform blind decoding on all of CCEs which are present in the control region of a non-DRX subframe. The UE has to decode all of PDCCHs in a possible CCE aggregation level until blind decoding for the PDCCHs is successful within each non-DRX subframe because the UE is unaware that which PDCCH format will be transmitted. The UE has to attempt detection in all of possible CCE aggregation levels until blind decoding for the PDCCHs is successful because the UE is unaware that its own PDCCH uses how many CCEs. That is, the UE performs the blind decoding in each CCE aggregation level. That is, the UE first attempts decoding in a CCE aggregation level unit of 1. If decoding all fails, the UE attempts decoding in a CCE aggregation level unit of 2. Thereafter, the UE attempts decoding in a CCE aggregation level unit of 4 and a CCE aggregation level unit of 8. Furthermore, the UE attempts decoding on all of a C-RNTI, a P-RNTI, an SI-RNTI, and an RA-RNTI 4. Furthermore, the UE attempts decoding on all of DCI formats to be monitored.

As described above, if UE attempts blind decoding on all of DCI formats to be monitored in each of all of CCE aggregation levels with respect to all of RNTIs, the number of times of detection attempts is excessively increased. Accordingly, in the LTE system, a search space (SS) concept is defined for the blind decoding of UE. The search space means a set of PDCCH candidates to be monitored and may have a different size depending on the format of each PDCCH.

The search space may include a common search space (CSS) and a UE-specific/dedicated search space (USS). In the case of the CSS, all of pieces of UE may be aware of the size of the CSS, but the USS may be individually set for each piece of UE. Accordingly, UE has to decode both the USS and the CSS in order to decode a PDCCH. Accordingly, UE performs a maximum of pieces of 44 blind decoding (BD) in one subframe. In this case, blind decoding performed based on a different CRC value (e.g., a C-RNTI, P-RNTI, SI-RNTI or RA-RNTI) is not included in the maximum of pieces of 44 blind decoding (BD).

Due to a small search space, an eNB may not secure a CCE resource for transmitting a PDCCH to all of pieces of UE to which the PDCCH is to be transmitted within a given subframe. The reason for this is that the remaining resources left over after a CCE position is allocated may not be included in the search space of specific UE. In order to minimize such a barrier that may continue even in a next subframe, a UE-specific hopping sequence may be applied to the start point of a USS.

Table 4 illustrates the sizes of a CSS and a USS.

TABLE 4

| | | Number of | Number of |
|---|---|---|---|
| | | candidates | candidates |
| PDCCH | Number of | in common | in dedicated |
| format | CCEs (n) | search space | search space |
| 0 | 1 | — | 6 |
| 1 | 2 | — | 6 |
| 2 | 4 | 4 | 2 |
| 3 | 8 | 2 | 2 |

In order to reduce the computational load of UE according to the number of times of blind decoding attempts, the UE does not perform searches according to all of defined DCI formats at the same time. More specifically, the UE may always perform search for the DCI formats 0 and 1A in a USS. In this case, the DCI formats 0 and 1A have the same size, but the UE may distinguish the DCI formats using a flag for a DCI format 0/DCI format 1A differentiation included in a PDCCH. Furthermore, another DCI format in addition to the DCI formats 0 and 1A may be required for UE depending on PDSCH transmission mode set by an eNB. Examples of another DCI format include the DCI formats 1, 1B, and 2.

In a CSS, UE may search for the DCI formats 1A and 1C. Furthermore, the UE may be configured to search for the DCI format 3 or 3A. The DCI formats 3 and 3A have the same size as the DCI formats 0 and 1A, but the UE may differentiate the DCI formats using CRC scrambled by another ID not a UE-specific ID.

A search space Sₖ^{(L)} means a set of PDCCH candidates according to an aggregation level Lε{1, 2, 4, 8}. A CCE according to the PDCCH candidate set m of the search space may be determined by Equation 4 below.

L·{(Y+m)mod └N_{CCE,k}/L┘}+i [Equation 4]

In Equation 4, M^{(L)} denotes the number of PDCCH candidates according to a CCE aggregation level L to be monitored in a search space. m=0, . . . , M^{(L)}−1. i is an index that designates each CCE in each of PDCCH candidates, and i=0, . . . , L−1.

As described above, UE monitors both a USS and a CSS in order to decode a PDCCH. In this case, the CSS supports PDCCHs having an aggregation level of {4, 8}, and the USS supports PDCCHs having an aggregation level of {1, 2, 4, 8}.

Table 5 illustrates PDCCH candidates monitored by UE.

TABLE 5

| Search space Sₖ^{(L)} | | | |
|---|---|---|---|
| | Aggregation | Size | Number of PDCCH |
| Type | level L | [in CCEs] | candidates M^{(L)} |
| UE- | 1 | 6 | 6 |
| specific | 2 | 12 | 6 |
| | 4 | 8 | 2 |
| | 8 | 16 | 2 |
| Common | 4 | 16 | 4 |
| | 8 | 16 | 2 |

Referring to Equation 4, in the case of a CSS, Y^{k} is set to 0 with respect to two aggregation levels L=4 and L=8. In contrast, in the case of a USS, Yₖ is defined as in Equation 5 with respect to an aggregation level L.

Yₖ=(A·Yₖ₋₁)mod D [Equation 5]

In Equation 5, Y₋₁=n_{RNTI}≠0, the value of an RNTI used for n_{RNTI} may be defined as one of the identifications (IDs) of UE. Furthermore, A=39827, D=6637, and k=└nₛ/2┘. In this case, nₛ denotes a slot number (or index) in a radio frame.

General ACK/NACK Multiplexing Method

In a situation in which the terminal simultaneously needs to transmit multiple ACKs/NACKs corresponding to multiple data units received from an eNB, an ACK/NACK multiplexing method based on PUCCH resource selection may be considered in order to maintain a single-frequency characteristic of the ACK/NACK signal and reduce ACK/NACK transmission power.

Together with ACK/NACK multiplexing, contents of ACK/NACK responses for multiple data units may be identified by combining a PUCCH resource and a resource of QPSK modulation symbols used for actual ACK/NACK transmission.

For example, when one PUCCH resource may transmit 4 bits and four data units may be maximally transmitted, an ACK/NACK result may be identified in the eNB as shown in Table 3 given below.

TABLE 6

| HARQ-ACK(0), HARQ-ACK(1), | | |
|---|---|---|
| HARQ-ACK(2), HARQ-ACK(3) | n_{PUCCH}⁽¹⁾ | b(0), b(1) |
| ACK, ACK, ACK, ACK | n_{PUCCH, 1}⁽¹⁾ | 1, 1 |
| ACK, ACK, ACK, NACK/DTX | n_{PUCCH, 1}⁽¹⁾ | 1, 0 |
| NACK/DTX, NACK/DTX, NACK, DTX | n_{PUCCH, 2}⁽¹⁾ | 1, 1 |
| ACK, ACK, NACK/DTX, ACK | n_{PUCCH, 1}⁽¹⁾ | 1, 0 |
| NACK, DTX, DTX, DTX | n_{PUCCH, 0}⁽¹⁾ | 1, 0 |
| ACK, ACK, NACK/DTX, NACK/DTX | n_{PUCCH, 1}⁽¹⁾ | 1, 0 |
| ACK, NACK/DTX, ACK, ACK | n_{PUCCH, 3}⁽¹⁾ | 0, 1 |
| NACK/DTX, NACK/DTX, NACK/DTX, | n_{PUCCH, 3}⁽¹⁾ | 1, 1 |
| NACK | | |
| ACK, NACK/DTX, ACK, NACK/DTX | n_{PUCCH, 2}⁽¹⁾ | 0, 1 |
| ACK, NACK/DTX, NACK/DTX, ACK | n_{PUCCH, 0}⁽¹⁾ | 0, 1 |
| ACK, NACK/DTX, NACK/DTX, | n_{PUCCH, 0}⁽¹⁾ | 1, 1 |
| NACK/DTX | | |
| NACK/DTX, ACK, ACK, ACK | n_{PUCCH, 3}⁽¹⁾ | 0, 1 |
| NACK/DTX, NACK, DTX, DTX | n_{PUCCH, 1}⁽¹⁾ | 0, 0 |
| NACK/DTX, ACK, ACK, NACK/DTX | n_{PUCCH, 2}⁽¹⁾ | 1, 0 |
| NACK/DTX, ACK, NACK/DTX, ACK | n_{PUCCH, 3}⁽¹⁾ | 1, 0 |
| NACK/DTX, ACK, NACK/DTX, NACK/DTX | n_{PUCCH, 1}⁽¹⁾ | 0, 1 |
| NACK/DTX, NACK/DTX, ACK, ACK | n_{PUCCH, 3}⁽¹⁾ | 0, 1 |
| NACK/DTX, NACK/DTX, ACK, NACK/DTX | n_{PUCCH, 2}⁽¹⁾ | 0, 0 |
| NACK/DTX, NACK/DTX, NACK/DTX, ACK | n_{PUCCH, 3}⁽¹⁾ | 0, 0 |
| DTX, DTX, DTX, DTX | N/A | N/A |

In Table 6 given above, HARQ-ACK(i) represents an ACK/NACK result for an i-th data unit. In Table 6 given above, discontinuous transmission (DTX) means that there is no data unit to be transmitted for the corresponding HARQ-ACK(i) or that the terminal may not detect the data unit corresponding to the HARQ-ACK(i).

According to Table 6 given above, a maximum of four PUCCH resources (n_{PUCCH,0}⁽¹⁾, n_{PUCCH,1}⁽¹⁾, n_{PUCCH,2}⁽¹⁾, and n_{PUCCH,3}⁽¹⁾) are provided and b(0) and b(1) are two bits transmitted by using a selected PUCCH.

For example, when the terminal successfully receives all of four data units, the terminal transmits 2 bits (1,1) by using n_{PUCCH,1}⁽¹⁾.

When the terminal fails to decoding in first and third data units and succeeds in decoding in second and fourth data units, the terminal transmits bits (1,0) by using n_{PUCCH,3}⁽¹⁾.

In ACK/NACK channel selection, when there is at least one ACK, the NACK and the DTX are coupled with each other. The reason is that a combination of the PUCCH resource and the QPSK symbol may not all ACK/NACK states. However, when there is no ACK, the DTX is decoupled from the NACK.

In this case, the PUCCH resource linked to the data unit corresponding to one definite NACK may also be reserved to transmit signals of multiple ACKs/NACKs.

Common ACK/NACK Transmission

In an LTE-A system, to send a plurality of ACK/NACK information/signals for a plurality of PDSCHs transmitted through a plurality of DL CCs through a specific UL component carrier (UL CC) is taken into consideration. To this end, unlike in ACK/NACK transmission using the PUCCH formats 1a/1b in existing Rel-8 LTE, after channel coding (e.g., Reed-Muller code or Tail-biting convolutional code) is performed on a plurality of pieces of ACK/NACK information, to send a plurality of ACK/NACK information/signals using a new PUCCH format (i.e., an E-PUCCH format) of a modified form based on the PUCCH format 2 or the following block-spreading may be taken into consideration.

The block spreading technique is a scheme that modulates transmission of the control signal by using the SC-FDMA scheme unlike the existing PUCCH format 1 series or 2 series. As illustrated in FIG. 15, a symbol sequence may be spread and transmitted on the time domain by using an orthogonal cover code (OCC). The control signals of the plurality of terminals may be multiplexed on the same RB by using the OCC. In the case of PUCCH format 2 described above, one symbol sequence is transmitted throughout the time domain and the control signals of the plurality of terminals are multiplexed by using the cyclic shift (CS) of the CAZAC sequence, while in the case of a block spreading based on PUCCH format (for example, PUCCH format 3), one symbol sequence is transmitted throughout the frequency domain and the control signals of the plurality of terminals are multiplexed by using the time domain spreading using the OCC.

FIG. 15 illustrates one example of generating and transmitting 5 SC-FDMA symbols during one slot in the wireless communication system to which the present invention can be applied.

In FIG. 15, an example of generating and transmitting 5 SC-FDMA symbols (that is, data part) by using an OCC having the length of 5 (alternatively, SF=5) in one symbol sequence during one slot. In this case, two RS symbols may be used during one slot.

In the example of FIG. 15, the RS symbol may be generated from a CAZAC sequence to which a specific cyclic shift value is applied and transmitted in a type in which a predetermined OCC is applied (alternatively, multiplied) throughout a plurality of RS symbols. Further, in the example of FIG. 15, when it is assumed that 12 modulated symbols are used for each OFDM symbol (alternatively, SC-FDMA symbol) and the respective modulated symbols are generated by QPSK, the maximum bit number which may be transmitted in one slot becomes 24 bits (=12×2). Accordingly, the bit number which is transmittable by two slots becomes a total of 48 bits. When a PUCCH channel structure of the block spreading scheme is used, control information having an extended size may be transmitted as compared with the existing PUCCH format 1 series and 2 series.

For convenience of description, a plural ACK/NACK transmission method based on such channel coding using the PUCCH format 2 or E-PUCCH format is called a multi-bit ACK/NACK coding transmission method. The multi-bit ACK/NACK coding transmission method is a method for transmitting an ACK/NACK-coded block generated by performing channel coding on ACK/NACK or discontinuous transmission (DTX) information about the PDSCH of a plurality of DL CCs (i.e., means that a PDCCH has not been received and detected). For example, if UE operates in SU-MIMO mode in which DL CC and receives 2 codewords (CWs), the UE may transmit a total of 4 feedback states of ACK/ACK, ACK/NACK, NACK/ACK, NACK/NACK for each CW with respect to a corresponding CC or may have a maximum of 5 feedback states including DTX. Furthermore, if UE receives a single CW, it may have a maximum of 3 states of ACK, NACK, and DTX (if NACK is processed like DTX, the UE may have a total of 2 states of ACK and NACK/DTX). Accordingly, if the UE aggregates a maximum of 5 DL CCs and operates in SU-MIMO mode in all of CCs, it may have a maximum of 55 transmittable feedback states. An ACK/NACK payload size for expressing the maximum of 55 transmittable feedback states is a total of 12 bits (if DTX is processed like NACK, the number of feedback states is 45, and an ACK/NACK payload size for expressing the 45 feedback states is a total of 10 bits).

In the aforementioned ACK/NACK multiplexing (i.e., ACK/NACK selection) method applied to existing Rel-8 TDD systems, basically, in order to secure a PUCCH resource for each piece of UE, an implicit ACK/NACK selection method using an implicit PUCCH resource corresponding to a PDCCH (i.e., linked to the lowest CCE index) that schedules each PDSCH of corresponding UE is taken into consideration. Meanwhile, in the LTE-A FDD system, basically, the transmission of a plurality of ACK/NACKs for a plurality of PDSCHs transmitted through a plurality of DL CCs through a single specific UL CC configured in a UE-specific manner is taken into consideration. To this end, an ACK/NACK selection method using an implicit PUCCH resource linked to a PDCCH that schedules a specific DLCC or some or all of DL CCs (i.e., linked to the lowest CCE index n_CCE or linked to an n_CCE or an n_CCE+1) or a combination of a corresponding implicit PUCCH resource and an explicit PUCCH resource previously reserved for each piece of UE through RRC signaling is taken into consideration.

Meanwhile, even in LTE-A TDD systems, a situation in which a plurality of CCs has been aggregated (i.e., CA) may be taken into consideration. Accordingly, to send a plurality of ACK/NACK information/signals for a plurality of PDSCHs, transmitted through a plurality of DL subframes and a plurality of CCs, through a specific CC (i.e., A/N CC) in an UL subframe corresponding to a plurality of corresponding DL subframes is taken into consideration. In this case, unlike in the aforementioned LTE-A FDD, a method (i.e., full ACK/NACK) for transmitting a plurality of ACK/NACKs corresponding to a maximum of CWs which may be transmitted through all of CCs allocated to UE with respect to all of a plurality of DL subframes (i.e., SFs) may be taken into consideration, or a method (i.e., bundled ACK/NACK) for reducing a total number of transmitted ACK/NACKs by applying ACK/NACK bundling to a CW and/or a CC and/or an SF domain and transmitting the reduced number of ACK/NACKs may be taken into consideration. In this case, the CW bundling means that ACK/NACK bundling for a CW is applied to each DL SF for each CC. The CC bundling means that ACK/NACK bundling for all of CCs or some CCs is applied to each DL SF. The SF bundling means that ACK/NACK bundling for all of or some DL SFs is applied to each CC. Characteristically, an ACK-counter method for providing notification of a total number of ACKs (or the number of some ACKs) for each CC with respect to all of PDSCHs or DL grant PDCCHs received for each CC may be taken into consideration as the SF bundling method. In this case, an ACK/NACK transmission scheme based on multi-bit ACK/NACK coding or ACK/NACK selection may be configurably applied depending on the size of ACK/NACK payload for each piece of UE, that is, the size of ACK/NACK payload for full or bundled ACK/NACK transmission configured to each piece of UE.

HARQ Procedure

In a mobile communication system, one eNB transmits and receives data to and from a plurality of terminals and wireless channel environments in one cell/sector. In a system operating in multiple carriers and a system operating like the system operating in multiple carriers, an eNB receives packet traffic from a wired Internet and transmits the received packet traffic to each terminal using a predetermined communication method. In this case, what the eNB determines to transmit the data to which terminal using which frequency domain at which timing is downlink scheduling. Furthermore, the eNB receives data transmitted by a terminal using a predetermined communication method, demodulates the received data, and transmits the demodulated data through a wired Internet. What the eNB will transmit uplink data to which terminal using what frequency band at which timing is uplink scheduling. In general, UE having a better channel state transmits and receives data using a longer time and more frequency resources.

A resource in a system operating in multiple carriers and system operating like the system operating in multiple carriers may be basically divided into a time domain and a frequency domain. The resource may be defined as a resource block. The resource block includes specific N subcarriers and specific M subframes or a predetermined time unit. In this case, N and M may be 1.

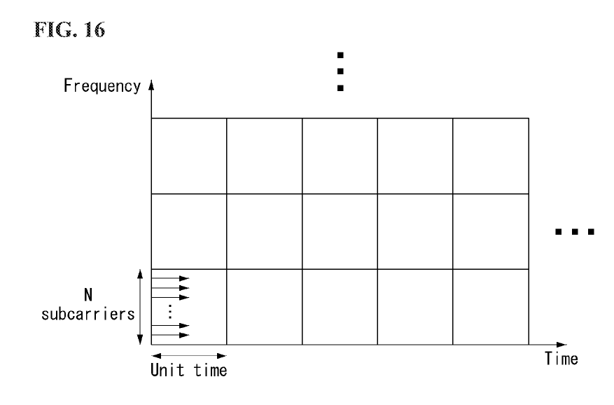

FIG. 16 illustrates an example of a time-frequency resource block in a time-frequency domain to which an embodiment of the present invention may be applied.

Referring to FIG. 16, one square means one resource block. One resource block uses several subcarriers as one axis and uses a predetermined time unit as the other axis.

In downlink, an eNB schedules one or more resource blocks for selected UE in accordance with a predetermined scheduling rule. The eNB transmits data to the UE using a resource block allocated to the UE. In uplink, an eNB schedules one or more resource blocks for selected UE in accordance with a predetermined scheduling rule, and pieces of UE transmit data using allocated resources in uplink. An error control method if a frame is lost or damaged after data is transmitted after scheduling includes an automatic repeat request (ARQ) method and a hybrid ARQ (HARQ) method of a more advanced form. Basically, in the ARQ method, after transmitting one frame, an eNB waits for the reception of an ACK message. The reception side transmits the ACK message only when it properly receives the frame. If an error is generated in the frame, the reception side transmits a negative-ACK (NAK) message and deletes information about the received frame having an error from a reception stage buffer. The transmission side transmits a subsequent frame when it receives an ACK signal, but retransmits the frame when it receives a NAK message. Unlike in the ARQ method, in the HARQ method, if a received frame cannot be demodulated, a reception stage transmits a NAK message to a transmission stage, but stores an already received frame in a buffer for a specific time and combines the already received frame with the frame when it is retransmitted, thereby increasing a reception success ratio.

Recently, the HARQ method more efficient than the basic ARQ method is widely used. The HARQ method includes several types. The HARQ method may be basically divided into a synchronous HARQ method and an asynchronous HARQ method depending on retransmission timing, and may be divided into a channel-adaptive method and a channel-non-adaptive method depending on whether the state of a channel is incorporated or not with respect to the amount of resources used upon retransmission.

The synchronous HARQ method is a method for performing subsequent retransmission according to timing predetermined by a system when initial transmission fails. That is, assuming that timing when retransmission is performed is an each fourth time unit after initial transmission failed, it is not necessary to additionally provide notification of the timing because the timing has already been agreed between an eNB and pieces of UE. However, if a data transmission side has received a NAK message, it retransmits a frame in each fourth time unit until it receives an ACK message. In contrast, the asynchronous HARQ method may be performed through additional signaling or when retransmission timing is newly scheduled. Timing when the retransmission of a frame that had failed is performed is changed due to several factors, such as the state of a channel.

The channel-non-adaptive HARQ method is a method in which the modulation of a frame, the number of resource blocks used, AMC, etc. upon retransmission are performed as scheduled upon initial transmission. In contrast, the channel-adaptive HARQ method is a method in which the modulation of a frame, the number of resource blocks used, AMC, etc. upon retransmission are varied depending on the state of a channel. For example, in the channel-non-adaptive HARQ method, the transmission side transmitted data using 6 resource blocks upon initial transmission and subsequently retransmits the data using 6 resource blocks in the same manner even upon retransmission. In contrast, in the channel-adaptive method, although data has been transmitted using 6 resource blocks upon initial transmission, the transmission side retransmits the data using resource blocks greater than or smaller than the 6 resources blocks depending on the state of a channel.

Four types of HARQ combinations may be present based on such classification, but HARQ methods that are chiefly used include a synchronous and channel-adaptive HARQ method and a synchronous and channel-non-adaptive HARQ method. The synchronous and channel-adaptive HARQ method can maximize retransmission efficiency by adaptively changing retransmission timing and the amount of resources used depending on the state of a channel, but is not taken into consideration for uplink because it has a disadvantage of high overhead. In contrast, the synchronous and channel-non-adaptive HARQ method has an advantage in that it has almost no overhead for retransmission timing and resource allocation because the retransmission timing and the resource allocation have been agreed within a system, but has a disadvantage in that retransmission efficiency is very low if the method is used in the state of a channel having a severe change. Today, in 3GPP LTE, the asynchronous HARQ method is used in downlink and the synchronous HARQ method is used in uplink.

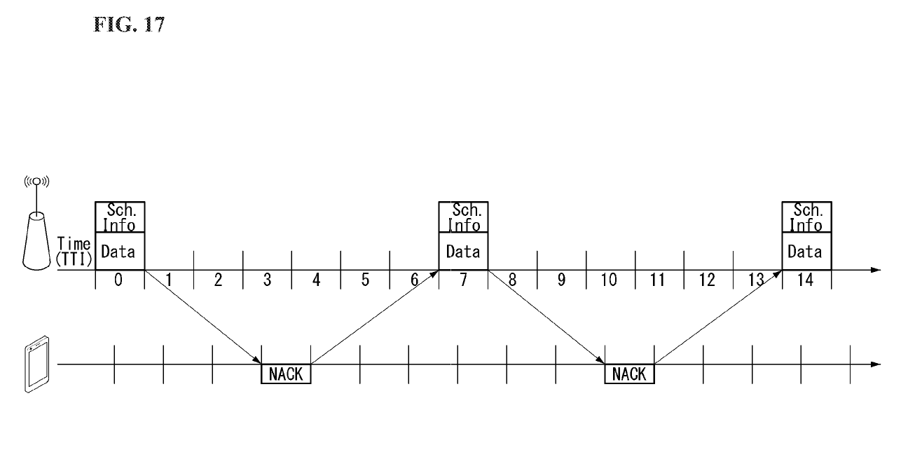

FIG. 17 illustrates an example of resource allocation and retransmission in a common asynchronous HARQ method to which an embodiment of the present invention may be applied.

Referring to FIG. 17, for example, in the case of downlink, after scheduling is performed and data is transmitted, ACK/NAK information is received from UE, and time delay may occur until next data is transmitted. The time delay may be generated due to channel propagation delay and the time taken for data decoding and data encoding.

For data transmission not including a blank during such a delay period, a method for transmitting data using an independent HARQ process is used. For example if the shortest cycle between next data transmission and next data transmission is 7 subframes, data may be transmitted without a blank if 7 independent processes are placed. In LTE, if a system does not operate according to MIMO, a maximum of 8 processes can be allocated.

Coordinated Multi-Point (CoMP) Operation Based on CA

In systems subsequent LTE, CoMP transmission may be implemented using a carrier aggregation (CA) function in LTE.

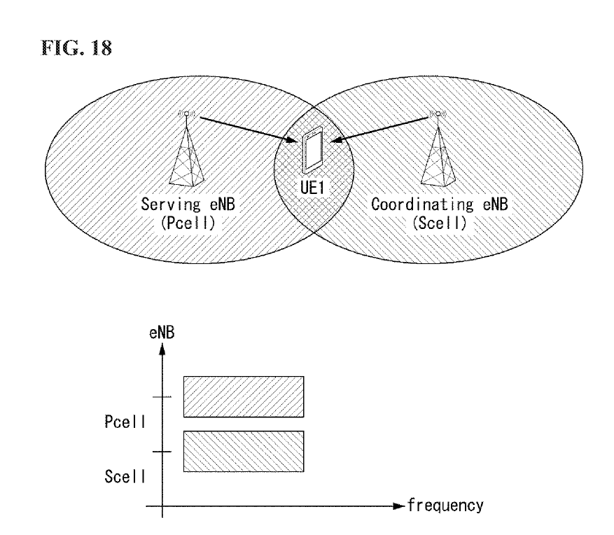

FIG. 18 illustrates an example of a CoMP system using a carrier aggregation to which an embodiment of the present invention may be applied.

Referring to FIG. 18, a primary cell (Pcell) carrier and a secondary cell (Scell) carrier use the same frequency band in a frequency axis and have been allocated to two eNBs, respectively, which are geographically spaced apart from each other. The serving eNB of UE1 may be allocated as a Pcell, an Scell may be allocated to a neighbor cell that gives more interference, and thus various DL/UL CoMP operations, such as joint transmission (JT), coordinated scheduling (CS)/coordinated beamforming (CB), and dynamic cell selection may be possible.

FIG. 18 illustrates an example in which UE aggregates the two eNBs into a Pcell and an Scell, respectively. In some embodiments, a piece of UE may aggregate three or more cells, some of the three or more cells perform a CoMP operation in the same frequency band, and other cells may perform a simple CA operation in other frequency bands. In this case, a Pcell does not need to necessarily participate in the CoMP operation.

UE Procedure for Receiving the PDSCH

Except the subframes indicated by the higher layer parameter mbsfn-SubframeConfigList, a UE shall upon detection of a PDCCH of a serving cell with DCI format 1, 1A, 1B, 1C, 1D, 2, 2A, 2B or 2C intended for the UE in a subframe, decode the corresponding PDSCH in the same subframe with the restriction of the number of transport blocks defined in the higher layers. A UE may assume that positioning reference signals are not present in resource blocks in which it shall decode PDSCH according to a detected PDCCH with CRC scrambled by the SI-RNTI or P-RNTI with DCI format 1A or 1C intended for the UE.

A UE configured with the carrier indicator field for a given serving cell shall assume that the carrier indicator field is not present in any PDCCH of the serving cell in the common search space that is described in [3]. Otherwise, the configured UE shall assume that for the given serving cell the carrier indicator field is present in PDCCH located in the UE specific search space described in [3] when the PDCCH CRC is scrambled by C-RNTI or SPS C-RNTI.

If a UE is configured by higher layers to decode PDCCH with CRC scrambled by the SI-RNTI, the UE shall decode the PDCCH and the corresponding PDSCH according to any of the combinations defined in Table 7. The scrambling initialization of PDSCH corresponding to these PDCCHs is by SI-RNTI.

TABLE 7

| DCI | | Transmission scheme of PDSCH |
|---|---|---|
| format | Search Space | corresponding to PDCCH |
| DCI | Common | If the number of PBCH antenna ports is |
| format 1C | | one, Single-antenna port, port 0 is |
| | | used, otherwise Transmit diversity. |
| DCI | Common | If the number of PBCH antenna ports is |
| format 1A | | one, Single-antenna port, port 0 is |
| | | used, otherwise Transmit diversity |

If a UE is configured by higher layers to decode PDCCH with CRC scrambled by the P-RNTI, the UE shall decode the PDCCH and the corresponding PDSCH according to any of the combinations defined in Table 8. The scrambling initialization of PDSCH corresponding to these PDCCHs is by P-RNTI.

TABLE 8

| DCI | | Transmission scheme of PDSCH |
|---|---|---|
| format | Search Space | corresponding to PDCCH |
| DCI | Common | If the number of PBCH antenna ports is |
| format 1C | | one, Single-antenna port, port 0 is |
| | | used, otherwise Transmit diversity |
| DCI | Common | If the number of PBCH antenna ports is |
| format 1A | | one, Single-antenna port, port 0 is |
| | | used, otherwise Transmit diversity |

If a UE is configured by higher layers to decode PDCCH with CRC scrambled by the RA-RNTI, the UE shall decode the PDCCH and the corresponding PDSCH according to any of the combinations defined in Table 9. The scrambling initialization of PDSCH corresponding to these PDCCHs is by RA-RNTI.

When RA-RNTI and either C-RNTI or SPS C-RNTI are assigned in the same subframe, UE is not required to decode a PDSCH indicated by a PDCCH with a CRC scrambled by C-RNTI or SPS C-RNTI.

TABLE 9

| DCI | | Transmission scheme of PDSCH |
|---|---|---|
| format | Search Space | corresponding to PDCCH |
| DCI | Common | If the number of PBCH antenna ports is |
| format 1C | | one, Single-antenna port, port 0 is |
| | | used, otherwise Transmit diversity |
| DCI | Common | If the number of PBCH antenna ports is |
| format 1A | | one, Single-antenna port, port 0 is |
| | | used, otherwise Transmit diversity |

The UE is semi-statically configured via higher layer signalling to receive PDSCH data transmissions signalled via PDCCH according to one of nine transmission modes, denoted mode 1 to mode 9.

For frame structure type 1, The operation of the UE associated with PDSCH reception may be as below.

The UE is not expected to receive PDSCH resource blocks transmitted on antenna port 5 in any subframe in which the number of OFDM symbols for PDCCH with normal CP is equal to four.

The UE is not expected to receive PDSCH resource blocks transmitted on antenna port 5, 7, 8, 9, 10, 11, 12, 13 or 14 in the two PRBs to which a pair of VRBs is mapped if either one of the two PRBs overlaps in frequency with a transmission of either PBCH or primary or secondary synchronisation signals in the same subframe.

The UE is not expected to receive PDSCH resource blocks transmitted on antenna port 7 for which distributed VRB resource allocation is assigned.

The UE may skip decoding the transport block(s) if it does not receive all assigned PDSCH resource blocks. If the UE skips decoding, the physical layer indicates to higher layer that the transport block(s) are not successfully decoded.

For frame structure type 2, The operation of the UE associated with PDSCH reception may be as below.

The UE is not expected to receive PDSCH resource blocks transmitted on antenna port 5 in any subframe in which the number of OFDM symbols for PDCCH with normal CP is equal to four.

The UE is not expected to receive PDSCH resource blocks transmitted on antenna port 5 in the two PRBs to which a pair of VRBs is mapped if either one of the two PRBs overlaps in frequency with a transmission of PBCH in the same subframe.

The UE is not expected to receive PDSCH resource blocks transmitted on antenna port 7, 8, 9, 10, 11, 12, 13 or 14 in the two PRBs to which a pair of VRBs is mapped if either one of the two PRBs overlaps in frequency with a transmission of primary or secondary synchronisation signals in the same subframe.

With normal CP configuration, the UE is not expected to receive PDSCH on antenna port 5 for which distributed VRB resource allocation is assigned in the special subframe with configuration #1 or #6.

The UE is not expected to receive PDSCH on antenna port 7 for which distributed VRB resource allocation is assigned.

The UE may skip decoding the transport block(s) if it does not receive all assigned PDSCH resource blocks. If the UE skips decoding, the physical layer indicates to higher layer that the transport block(s) are not successfully decoded.

If a UE is configured by higher layers to decode PDCCH with CRC scrambled by the C-RNTI, the UE shall decode the PDCCH and any corresponding PDSCH according to the respective combinations defined in Table 10. The scrambling initialization of PDSCH corresponding to these PDCCHs is by C-RNTI.

If the UE is configured with the carrier indicator field for a given serving cell and, if the UE is configured by higher layers to decode PDCCH with CRC scrambled by the C-RNTI, then the UE shall decode PDSCH of the serving cell indicated by the carrier indicator field value in the decoded PDCCH.

When a UE configured in transmission mode 3, 4, 8 or 9 receives a DCI Format 1A assignment, it shall assume that the PDSCH transmission is associated with transport block 1 and that transport block 2 is disabled.

When a UE is configured in transmission mode 7, scrambling initialization of UE-specific reference signals corresponding to these PDCCHs is by C-RNTI.

The UE does not support transmission mode 8 if extended cyclic prefix is used in the downlink.

When a UE is configured in transmission mode 9, in the subframes indicated by the higher layer parameter mbsfn-SubframeConfigList except in subframes for the serving cell, the UE shall upon detection of a PDCCH with CRC scrambled by the C-RNTI with DCI format 1A or 2C intended for the UE, decode the corresponding PDSCH in the same subframe.

TABLE 10

| | | | Transmission scheme of |
|---|---|---|---|
| Transmission | DCI | Search | PDSCH corresponding |
| mode | format | Space | to PDCCH |
| Mode 1 | DCI | Common and | Single-antenna port, |
| | format 1A | UE specific | port 0 |
| | | by C-RNTI | |
| | DCI | UE specific | Single-antenna port, |
| | format 1 | by C-RNTI | port 0 |
| Mode 2 | DCI | Common and | Transmit diversity |
| | format 1A | UE specific | |
| | | by C-RNTI | |
| | DCI | UE specific | Transmit diversity |
| | format 1 | by C-RNTI | |
| Mode 3 | DCI | Common and | Transmit diversity |
| | format 1A | UE specific | |
| | | by C-RNTI | |
| | DCI | UE specific | Large delay CDD or |
| | format 2A | by C-RNTI | Transmit diversity |
| Mode 4 | DCI | Common and | Transmit diversity |
| | format 1A | UE specific | |
| | | by C-RNTI | |
| | DCI | UE specific | Closed-loop spatial |
| | format 2 | by C-RNTI | multiplexing or |
| | | | Transmit diversity |
| Mode 5 | DCI | Common and | Transmit diversity |
| | format 1A | UE specific | |
| | | by C-RNTI | |
| | DCI | UE specific | Multi-user MIMO |
| | format 1D | by C-RNTI | |
| Mode 6 | DCI | Common and | Transmit diversity |
| | format 1A | UE specific | |
| | | by C-RNTI | |
| | DCI | UE specific | Closed-loop spatial |
| | format 1B | by C-RNTI | multiplexing using a |
| | | | single transmission |
| | | | layer |
| Mode 7 | DCI | Common and | If the number of |
| | format 1A | UE specific | PBCH antenna ports |
| | | by C-RNTI | is one, |
| | | | Single-antenna |
| | | | port, port 0 is |
| | | | used, otherwise |
| | | | Transmit diversity |
| | DCI | UE specific | Single-antenna port, |
| | format 1 | by C-RNTI | port 5 |
| Mode 8 | DCI | Common and | If the number of |
| | format 1A | UE specific | PBCH antenna ports |
| | | by C-RNTI | is one, |
| | | | Single-antenna |
| | | | port, port 0 is |
| | | | used, otherwise |
| | | | Transmit diversity |
| | DCI | UE specific | Dual layer |
| | format 2B | by C-RNTI | transmission, port 7 |
| | | | and 8 or |
| | | | single-antenna |
| | | | port, port 7 or 8 |
| Mode 9 | DCI | Common and | Non-MBSFN subframe: |
| | format 1A | UE specific | If the number of |
| | | by C-RNTI | PBCH antenna ports |
| | | | is one, |
| | | | Single-antenna |
| | | | port, port 0 is |
| | | | used, otherwise |
| | | | Transmit diversity |
| | | | MBSFN subframe: |
| | | | Single-antenna |
| | | | port, port 7 |
| | DCI | UE specific | Up to 8 layer |
| | format 2C | by C-RNTI | transmission, |
| | | | ports 7-14 |

If a UE is configured by higher layers to decode PDCCH with CRC scrambled by the SPS C-RNTI, the UE shall decode the PDCCH on the primary cell and any corresponding PDSCH on the primary cell according to the respective combinations defined in Table 11. The same PDSCH related configuration applies in the case that a PDSCH is transmitted without a corresponding PDCCH. The scrambling initialization of PDSCH corresponding to these PDCCHs and PDSCH without a corresponding PDCCH is by SPS C-RNTI. When a UE is configured in transmission mode 7, scrambling initialization of UE-specific reference signals corresponding to these PDCCHs is by SPS C-RNTI.

When a UE is configured in transmission mode 9, in the subframes indicated by the higher layer parameter mbsfn-SubframeConfigList except in subframes for the serving cell, the UE shall upon detection of a PDCCH with CRC scrambled by the SPS C-RNTI with DCI format 1A or 2C or for a configured PDSCH without PDCCH intended for the UE, decode the corresponding PDSCH in the same subframe.

TABLE 11

| | | | Transmission scheme of |
|---|---|---|---|
| Transmission | DCI | Search | PDSCH corresponding |
| mode | format | Space | to PDCCH |
| Mode 1 | DCI | Common and | Single-antenna port, |
| | format 1A | UE specific | port 0 |
| | | by C-RNTI | |
| | DCI | UE specific | Single-antenna port, |
| | format 1 | by C-RNTI | port 0 |
| Mode 2 | DCI | Common and | Transmit diversity |
| | format 1A | UE specific | |
| | | by C-RNTI | |
| | DCI | UE specific | Transmit diversity |
| | format 1 | by C-RNTI | |
| Mode 3 | DCI | Common and | Transmit diversity |
| | format 1A | UE specific | |
| | | by C-RNTI | |
| | DCI | UE specific | Transmit diversity |
| | format 2A | by C-RNTI | |
| Mode 4 | DCI | Common and | Transmit diversity |
| | format 1A | UE specific | |
| | | by C-RNTI | |
| | DCI | UE specific | Transmit diversity |
| | format 2 | by C-RNTI | |
| Mode 5 | DCI | Common and | Transmit diversity |
| | format 1A | UE specific | |
| | | by C-RNTI | |
| Mode 6 | DCI | Common and | Transmit diversity |
| | format 1A | UE specific | |
| | | by C-RNTI | |
| Mode 7 | DCI | Common and | Single-antenna port, |
| | format 1A | UE specific | port 5 |
| | | by C-RNTI | |
| | DCI | UE specific | Single-antenna port, |
| | format 1 | by C-RNTI | port 5 |
| Mode 8 | DCI | Common and | Single-antenna port, |
| | format 1A | UE specific | port 7 |
| | | by C-RNTI | |
| | DCI | UE specific | Single-antenna port, |
| | format 2B | by C-RNTI | port 7 or 8 |
| Mode 9 | DCI | Common and | Single-antenna port, |
| | format 1A | UE specific | port 7 |
| | | by C-RNTI | |
| | DCI | UE specific | Single-antenna port, |
| | format 2C | by C-RNTI | port 7 or 8 |

If a UE is configured by higher layers to decode PDCCH with CRC scrambled by the Temporary C-RNTI and is not configured to decode PDCCH with CRC scrambled by the C-RNTI, the UE shall decode the PDCCH and the corresponding PDSCH according to the combination defined in Table 12. The scrambling initialization of PDSCH corresponding to these PDCCHs is by Temporary C-RNTI.

TABLE 12

| DCI | | Transmission scheme of PDSCH |
|---|---|---|
| format | Search Space | corresponding to PDCCH |
| DCI | Common and | If the number of PBCH antenna port is |
| format 1A | UE specific | one, Single-antenna port, port 0 is |
| | by Temporary | used, otherwise |
| | C-RNTI | Transmit diversity |
| DCI | UE specific | If the number of PBCH antenna port is |
| format 1 | by Temporary | one, Single-antenna port, port 0 is |
| | C-RNTI | used, otherwise |
| | | Transmit diversity |

UE Procedure for Transmitting the PUSCH

A UE is semi-statically configured via higher layer signalling to transmit PUSCH transmissions signalled via PDCCH according to one of two uplink transmission modes, denoted mode 1-2 as defined in Table 13. If a UE is configured by higher layers to decode PDCCHs with the CRC scrambled by the C-RNTI, the UE shall decode the PDCCH according to the combination defined in Table 13 and transmit the corresponding PUSCH. The scrambling initialization of this PUSCH corresponding to these PDCCHs and the PUSCH retransmission for the same transport block is by C-RNTI. Transmission mode 1 is the default uplink transmission mode for a UE until the UE is assigned an uplink transmission mode by higher layer signalling.

When a UE configured in transmission mode 2 receives a DCI Format 0 uplink scheduling grant, it shall assume that the PUSCH transmission is associated with transport block 1 and that transport block 2 is disabled.

TABLE 13

| | | | Transmission scheme of |
|---|---|---|---|
| Transmission | DCI | | PUSCH corresponding |
| mode | format | Search Space | to PDCCH |
| Mode 1 | DCI | Common and | Single-antenna port, |
| | format 0 | UE specific | port 10 (see |
| | | by C-RNTI | subclause 8.0.1) |
| Mode 2 | DCI | Common and | Single-antenna port, |
| | format 0 | UE specific | port 10 (see |
| | | by C-RNTI | subclause 8.0.1) |
| | DCI | UE specific | Closed-loop spatial |
| | format 4 | by C-RNTI | multiplexing (see |
| | | | subclause 8.0.2) |

If a UE is configured by higher layers to decode PDCCHs with the CRC scrambled by the C-RNTI and is also configured to receive random access procedures initiated by PDCCH orders, the UE shall decode the PDCCH according to the combination defined in Table 14.

TABLE 14

| DCI format | Search Space |
|---|---|
| DCI format 1A | Common and |
| | UE specific by C-RNTI |

If a UE is configured by higher layers to decode PDCCHs with the CRC scrambled by the SPS C-RNTI, the UE shall decode the PDCCH according to the combination defined in Table 15 and transmit the corresponding PUSCH. The scrambling initialization of this PUSCH corresponding to these PDCCHs and PUSCH retransmission for the same transport block is by SPS C-RNTI. The scrambling initialization of initial transmission of this PUSCH without a corresponding PDCCH and the PUSCH retransmission for the same transport block is by SPS C-RNTI.

TABLE 15

| | | | Transmission scheme of |
|---|---|---|---|
| Transmission | DCI | | PUSCH corresponding |
| mode | format | Search Space | to PDCCH |
| Mode 1 | DCI | Common and | Single-antenna port, |
| | format 0 | UE specific | port 10 (see |
| | | by C-RNTI | subclause 8.0.1) |
| Mode 2 | DCI | Common and | Single-antenna port, |
| | format 0 | UE specific | port 10 (see |
| | | by C-RNTI | subclause 8.0.1) |

If a UE is configured by higher layers to decode PDCCHs with the CRC scrambled by the Temporary C-RNTI regardless of whether UE is configured or not configured to decode PDCCHs with the CRC scrambled by the C-RNTI, the UE shall decode the PDCCH according to the combination defined in Table 16 and transmit the corresponding PUSCH. The scrambling initialization of PUSCH corresponding to these PDCCH is by Temporary C-RNTI.

If a Temporary C-RNTI is set by higher layers, the scrambling of PUSCH corresponding to the Random Access Response Grant and the PUSCH retransmission for the same transport block is by Temporary C-RNTI. Else, the scrambling of PUSCH corresponding to the Random Access Response Grant and the PUSCH retransmission for the same transport block is by C-RNTI.

TABLE 16

| DCI format | Search Space |
|---|---|
| DCI format 0 | Common |

If a UE is configured by higher layers to decode PDCCHs with the CRC scrambled by the TPC-PUCCH-RNTI, the UE shall decode the PDCCH according to the combination defined in Table 17. The notation 3/3A implies that the UE shall receive either DCI format 3 or DCI format 3A depending on the configuration.

TABLE 17

| DCI format | Search Space |
|---|---|
| DCI format 3/3A | Common |

If a UE is configured by higher layers to decode PDCCHs with the CRC scrambled by the TPC-PUSCH-RNTI, the UE shall decode the PDCCH according to the combination defined in Table 18. The notation 3/3A implies that the UE shall receive either DCI format 3 or DCI format 3A depending on the configuration.

TABLE 18

| DCI format | Search Space |
|---|---|
| DCI format 3/3A | Common |

Cross-CC Scheduling and E-PDCCH Scheduling

In the existing 3GPP LTE Rel-10 system, if a cross-CC scheduling operation is defined in an aggregation situation for a plurality of CCs (component carrier=(serving) cell), one CC may be preset to be able to receive DL/UL scheduling from only one specific CC (i.e., scheduling CC) (namely, to be able to receive DL/UL grant PDCCH for the corresponding scheduled CC).

The corresponding scheduling CC may basically perform a DL/UL scheduling for the scheduling CC itself.

In other words, the SS for the PDCCH scheduling the scheduling/scheduled CC in the cross-CC scheduling relation may come to exist in the control channel area of the scheduling CC.

Meanwhile, in the LTE system, CFDD DL carrier or TDD DL subframes use first n OFDM symbols of the subframe for PDCCH, PHICH, PCFICH and the like which are physical channels for transmission of various control informations and use the rest of the OFDM symbols for PDSCH transmission.

At this time, the number of symbols used for control channel transmission in each subframe is dynamically transmitted to the UE through the physical channel such as PCFICH or is semi-statically transmitted to the UE through RRC signaling.

At this time, particularly, value n may be set by 1 to 4 symbols depending on the subframe characteristic and system characteristic (FDD/TDD, system bandwidth, etc.).

Meanwhile, in the existing LTE system, PDCCH, which is the physical channel for transmitting DL/UL scheduling and various control information, may be transmitted through limited OFDM symbols.

Hence, the enhanced PDCCH (i.e., E-PDCCH), which is more freely multiplexed in PDSCH and FDM/TDM scheme, may be introduced instead of the control channel which is transmitted through the OFDM which is separated from the PDSCH like PDCCH.

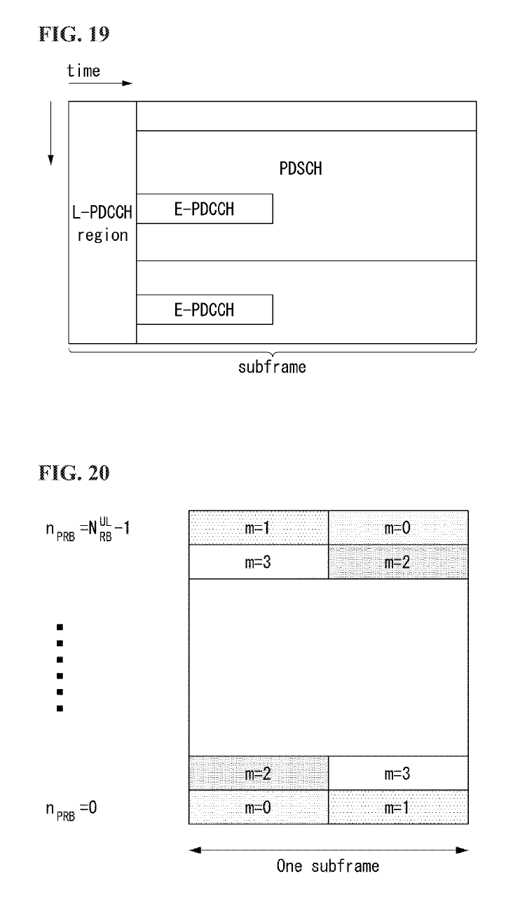

FIG. 19 illustrates an example of multiplexing legacy PDCCH, PDSCH and E-PDCCH.

Here, the legacy PDCCH may be expressed as L-PDCCH.

Quasi Co-Location

QC/QCL (quasi co-located or quasi co-location) can be defined as below.

If two antenna ports are in QC/QCL relationship (or QC/QCL), then a large-scale property of the signal transmitted through one antenna port is transmitted to the other antenna port. It can be assumed that the terminal can be inferred. Here, the wide-range characteristic includes at least one of a delay spread, a Doppler spread, a frequency shift, an average received power, and a received timing.

It may also be defined as follows. If two antenna ports are QC/QCL-related (or QC/QCL), then the large-scale properties of the channel through which one symbol is transmitted through one antenna port is transmitted through the other antenna port. It can be assumed that the terminal can be inferred from a radio channel through which a symbol is transmitted. Here, the large-scale properties includes at least one of a delay spread, a Doppler spread, a Doppler shift, an average gain, and an average delay.

That is, the two antenna ports are in the QC/QCL relationship (or QC/QCL), which means that the large-scale channel properties of the radio channel from one antenna port are the same as the large-scale channel properties of the radio channel from the other antenna port. Considering a plurality of antenna ports through which RSs are transmitted, if the antenna ports through which two different types of RSs are transmitted are in the QCL relationship, the large-scale properties of the radio channels from one type of antenna port can be replaced by the large-scale properties of the wireless channel.

In this specification, the above QC/QCL related definitions are not distinguished. That is, the QC/QCL concept can follow one of the above definitions. Or in a similar manner, it can be assumed that a QC/QCL hypothesis can be assumed to be transmitted at the co-location between the antenna ports established by the QC/QCL hypothesis (for example, UE may assume that there are antenna ports transmitted at the same transmission point), the QC/QCL concept definition may be modified by the terminal, and the spirit of the present invention includes such similar variations. In the present invention, QC/QCL related definitions are used in combination for convenience of explanation.

According to the QC/QCL concept, the UE may not assume the same large-scale channel properties between corresponding antenna ports for non-QC/QCL (Non-QC/QCL) antenna ports. That is, in this case, a typical UE receiver should perform independent processing on each non-quasi-co-located (NQC) AP which has been configured for timing acquisition and tracking, frequency offset estimation and compensation, delay estimation, and Doppler estimation.

There is an advantage in that UE can perform the following operation between APs capable of assuming QC:

With respect to Delay spread & Doppler spread, UE may identically apply a power-delay-profile, a delay spread and Doppler spectrum, and a Doppler spread estimation result for one port to a Wiener filter used upon channel estimation for the other port.

With respect to Frequency shift & Received Timing, UE may perform time and frequency synchronization on any one port and then apply the same synchronization to the demodulation of the other port.

With respect to Average received power, UE may average RSRP measurements for over two or more antenna ports.

Physical Uplink Control Channel (PUCCH)

The physical uplink control channel, PUCCH, carries uplink control information. Simultaneous transmission of PUCCH and PUSCH from the same UE is supported if enabled by higher layers. For frame structure type 2, the PUCCH is not transmitted in the UpPTS field.

The physical uplink control channel supports multiple formats as shown in Table 19.

Formats 2a and 2b are supported for normal cyclic prefix only.

TABLE 19

| PUCCH | Modulation | Number of bits per |
|---|---|---|
| format | scheme | subframe, M_{bit} |
| 1 | N/A | N/A |
| 1a | BPSK | 1 |
| 1b | QPSK | 2 |
| 2 | QPSK | 20 |
| 2a | QPSK + BPSK | 21 |
| 2b | QPSK + QPSK | 22 |
| 3 | QPSK | 48 |

All PUCCH formats use a cyclic shift, n_{cs}^{cell}(nₛ, l), which varies with the symbol number l and the slot number nₛ according to Equation 6.

n_{cs}^{cell}(nₛ,l)=Σᵢ₌₀⁷c(8N_{symb}^{UL}·nₛ+8l+i)·2ⁱ [Equation 6]

In Equation 6, the pseudo-random sequence c(i) is defined by clause 7.2. The pseudo-random sequence generator shall be initialized with cᵢₙᵢₜ=n_{ID}^{RS}. n_{ID}^{RS} is given by clause 5.5.1.5 with N_{ID}^{cell} corresponding to the primary cell, at the beginning of each radio frame. The physical resources used for PUCCH depends on two parameters, N_{RB}⁽²⁾ and N_{cs}⁽¹⁾, given by higher layers.

The variable N_{RB}⁽²⁾≧0 denotes the bandwidth in terms of resource blocks that are available for use by PUCCH formats 2/2a/2b transmission in each slot. The variable N_{cs}⁽¹⁾ denotes the number of cyclic shift used for PUCCH formats 1/1a/1b in a resource block used for a mix of formats 1/1a/1b and 2/2a/2b. The value of N_{cs}⁽¹⁾ is an integer multiple of Δ_{shift}^{PUCCH} within the range of {0, 1, . . . , 7}, where Δ_{shift}^{PUCCH} is provided by higher layers. No mixed resource block is present if N_{cs}⁽¹⁾=0. At most one resource block in each slot supports a mix of formats 1/1a/1b and 2/2a/2b.

Resources used for transmission of PUCCH formats 1/1a/1b, 2/2a/2b and 3 are represented by the non-negative indices n_{PUCCH}^{(1,\tilde{p})},

$${n}_{PUCCH}^{( 2 , \tilde{p} )} < {N}_{RB}^{( 2 )} {N}_{sc}^{RB} + ⌈ \frac{{N}_{cs}^{( 1 )}}{8} ⌉ \cdot ( {N}_{sc}^{RB} - {N}_{cs}^{( 1 )} - 2 ) ,$$

and n_{PUCCH}^{(3,\tilde{p})}, respectively.

PUCCH Formats 1, 1a and 1b

For PUCCH format 1, information is carried by the presence/absence of transmission of PUCCH from the UE. In the remainder of this clause, d(0)=1 shall be assumed for PUCCH format 1. For PUCCH formats 1a and 1b, one or two explicit bits are transmitted, respectively. The block of bits b(0), . . . , b(M_{bit}−1) shall be modulated as described in Table 20, resulting in a complex-valued symbol d(0).

TABLE 20

| PUCCH format | b(0), . . . , b(M_{bit} − 1) | d(0) |
|---|---|---|
| 1a | 0 | 1 |
| | 1 | −1 |
| 1b | 00 | 1 |
| | 01 | −j |
| | 10 | j |
| | 11 | −1 |

The modulation schemes for the different PUCCH formats are given by Table 19. The complex-valued symbol d(0) shall be multiplied with a cyclically shifted length N_{seq}^{PUCCH}=12 sequence r_{u,v}^{(α}^{_{\tilde{p}}}⁾(n) for each of the P antenna ports used for PUCCH transmission according to Equation 7.

$${y}^{( \tilde{p} )} ( n ) = \frac{1}{\sqrt{p}} d ( 0 ) \cdot {r}_{u , v}^{( {α}_{\tilde{p}} )} ( n ) , n = 0 , 1 , … , {N}_{seq}^{PUCCH} - 1 \qquad [ Equation 7 ]$$

In Equation 7, r_{u,v}^{(α}^{_{\tilde{p}}}⁾(n) is defined by clause 5.5.1 with M_{sc}^{RS}=N_{seq}^{PUCCH}. The antenna-port specific cyclic shift α_{\tilde{p}} varies between symbols and slots as defined below.

The block of complex-valued symbols y^{(\tilde{p})}(0), . . . , y^{(\tilde{p})}(N_{seq}^{PUCCH}−1) shall be scrambled by S(nₛ) and block-wise spread with the antenna-port specific orthogonal sequence wₙ_{_{oc}}_{^{(\tilde{p})}}(i) according to Equation 8.

z^{(\tilde{p})}(m′·N_{SF}^{PUCCH}·N_{seq}^{PUCCH}+m·N_{seq}^{PUCCH}+n)=S(nₛ)·wₙ_{_{oc}}_{^{(\tilde{p})}}(m)·y^{(\tilde{p})(n)} [Equation 8]

In Equation 8, m, n, m′, and S(nₛ) are defined by Equation 9 and Equation 10.

$$\begin{matrix}m = 0 , … , {N}_{SF}^{PUCCH} - 1 \\ n = 0 , … , {N}_{seq}^{PUCCH} - 1 \\ {m}^{′} = 0 , 1 & \{ Equation 9 ] \\ S ( {n}_{s} ) = \{ \begin{matrix}1 & if {n}_{\tilde{p}}^{′} ( {n}_{s} ) mod 2 = 0 \\ {e}^{j π / 2} & otherwise\end{matrix} & [ Equation 10 ]\end{matrix}$$

In this case, N_{SF}^{PUCCH}=4 for both slots of normal PUCCH formats 1/1a/1b, and N_{SF}^{PUCCH}=4 for the first slot and N_{SF}^{PUCH}=3 for the second slot of shortened PUCCH formats 1/1a/1b. The sequence wₙ_{_{nc}}_{^{(\tilde{p})}}(i) is given by Table 21 and Table 22.

TABLE 21

| Sequence index | Orthogonal sequences |
|---|---|
| n_{oc}^{(\tilde{p})}(nₛ) | [w(0) . . . w(N_{SF}^{PUCCH} − 1)] |
| 0 | [+1 +1 +1 +1] |
| 1 | [+1 −1 +1 −1] |
| 2 | [+1 −1 −1 +1] |

TABLE 22

| Sequence index | Orthogonal sequences |
|---|---|
| n_{oc}^{(\tilde{p})}(nₛ) | [w(0) . . . w(N_{SF}^{PUCCH} − 1)] |
| 0 | [1 1 1] |
| 1 | [1 e^{j2π/3} e^{j4π/3}] |
| 2 | [1 e^{j4π/3} e^{j2π/3}] |

Resources used for transmission of PUCCH format 1, 1a and 1b are identified by a resource index n_{PUCCH}^{(1,\tilde{p})} from which the orthogonal sequence index n_{oc}^{(\tilde{p})}(nₛ) and the cyclic shift α_{\tilde{p}}(nₛ,l) are determined according to Equation 11.

$${n}_{oc}^{( \tilde{p} )} ( {n}_{s} ) = \{ \begin{matrix}⌊ {n}_{\tilde{p}}^{′} ( {n}_{s} ) \cdot {Δ}_{shift}^{PUCCH} / {N}^{′} ⌋ & for normal cyclic prefix \\ 2 \cdot ⌊ {n}_{\tilde{p}}^{′} ( {n}_{s} ) \cdot {Δ}_{shift}^{PUCCH} / {N}^{′} ⌋ & for extended cyclic prefix\end{matrix} \\ {α}_{\tilde{p}} ( {n}_{s} , l ) = 2 π \cdot {n}_{cs}^{( \tilde{p} )} ( {n}_{s} , l ) / {N}_{sc}^{RB} \\ {n}_{cs}^{( \tilde{p} )} ( {n}_{s} , l ) = \{ \begin{matrix}[ {n}_{cs}^{cell} ( {n}_{s} , l ) + ( {n}_{\tilde{p}}^{′} ( {n}_{s} ) \cdot {Δ}_{shift}^{PUCCH} + ( {n}_{oc}^{( \tilde{p} )} ( {n}_{s} ) {modΔ}_{shift}^{PUCCH} ) ) mod {N}^{′} ] {mod N}_{sc}^{RB} & for normal cyclic prefix \\ {n}_{cs}^{cell} ( {n}_{s} , l ) + ( {n}_{\tilde{p}}^{′} ( {n}_{s} ) \cdot {Δ}_{shift}^{PUCCH} + {n}_{oc}^{( \tilde{p} )} ( {n}_{s} ) / 2 ) mod {N}^{′} ] mod {N}_{sc}^{RB} & for extended cyclic prefix\end{matrix} \qquad [ Equation 12 ]$$

In Equation 11, N′ and c are defined according to Equation 12.

$${N}^{′} = \{ \begin{matrix}{N}_{cs}^{( 1 )} & if {n}_{PUCCH}^{( 1 , \tilde{p} )} < c \cdot {N}_{cs}^{( 1 )} / {Δ}_{shift}^{PUCCH} \\ {N}_{sc}^{RB} & otherwise\end{matrix} \\ c = \{ \begin{matrix}3 & normal cyclic prefix \\ 2 & extended cyclic prefix\end{matrix} \qquad [ Equation 12 ]$$

PUCCH Formats 2, 2a and 2b

The block of bits b(0), . . . , b(19) shall be scrambled with a UE-specific scrambling sequence, resulting in a block of scrambled bits \tilde{b}(0), . . . , \tilde{b}(19) according to Equation 13.

\tilde{b}(i)=(b(i)+c(i))mod 2 [Equation 13]

In Equation 13, the scrambling sequence c(i) is given by clause 7.2. The scrambling sequence generator shall be initialised with cᵢₙᵢₜ=(└ₛ/2┘+1)·(2N_{ID}^{cell}+1)·2¹⁶+n_{RNTI} at the start of each subframe where n_{RNTI} is C-RNTI. The block of scrambled bits \tilde{b}(0), . . . , \tilde{b}(19) shall be QPSK modulated as described in clause 7.1, resulting in a block of complex-valued modulation symbols d(0), . . . , d(9).

Each complex-valued symbol d(0), . . . , d(9) shall be multiplied with a cyclically shifted length N_{seq}^{PUCCH}=12 sequence r_{u,v}^{(α}^{_{\tilde{p}}}⁾(n) for each of the P antenna ports used for PUCCH transmission according to Equation 14.

$${z}^{( \tilde{p} )} ( {N}_{seq}^{PUCCH} \cdot n + i ) = \frac{1}{\sqrt{P}} d ( n ) \cdot {r}_{u , v}^{( {α}_{\overline{p}} )} ( i ) \\ n = 0 , 1 , … , 9 \\ i = 0 , 1 , … , {N}_{sc}^{RB} - 1 \qquad [ Equation 14 ]$$

In Equation 14, r_{u,v}^{(α}^{_{\tilde{p})}}(i) is defined by clause 5.5.1 with M_{sc}^{RS}=N_{seq}^{PUCCH}.

Resources used for transmission of PUCCH formats 2/2a/2b are identified by a resource index n_{PUCCH}^{(2,\tilde{p})} from which the cyclic shift α_{\tilde{p}}(nₛ,l) is determined according to Equation 15.

α_{\tilde{p}}(nₛ,l)=2π·n_{cs}^{(\tilde{p})(n}ₛ,l)/N_{sc}^{RB} [Equation 15]

For PUCCH formats 2a and 2b, supported for normal cyclic prefix only, the bit(s) b(20), . . . , b(M_{bit}−1) shall be modulated as described in Table 23 resulting in a single modulation symbol d(10) used in the generation of the reference-signal for PUCCH format 2a and 2b.

TABLE 23

| PUCCH format | b(20), . . . , b(M_{bit} − 1) | d(10) |
|---|---|---|
| 2a | 0 | 1 |
| | 1 | −1 |
| 2b | 00 | 1 |
| | 01 | −j |
| | 10 | j |
| | 11 | −1 |

PUCCH Format 3

The block of bits b(0), . . . , b(M_{bit}−1) shall be scrambled with a UE-specific scrambling sequence, resulting in a block of scrambled bits \tilde{b}(0), . . . , \tilde{b}(M_{bit}−1) according to Equation 16.

\tilde{b}(i)=(b(i)+c(i))mod 2 [Equation 16]

In Equation 16, the scrambling sequence c(i) is given by clause 7.2. The scrambling sequence generator shall be initialised with cᵢₙᵢₜ=(└nₛ/2┘+1)·(2N_{ID}^{cell}+1)·2¹⁶+n_{RNTI} at the start of each subframe where n_{RNTI} is the C-RNTI. The block of scrambled bits \tilde{b}(0), . . . , \tilde{b}(M_{bit}−1) shall be QPSK modulated as described in Subclause 7.1, resulting in a block of complex-valued modulation symbols d(0), . . . , d(M_{symb}−1)

The complex-valued symbols d(0), . . . , d(M_{symb}−1) shall be block-wise spread with the orthogonal sequences wₙ_{_{oc,0}}_{^{(\tilde{p})}}(i) and wₙ_{_{oc,1}}_{^{(\tilde{p})}}(i) resulting in N_{SF,0}^{PUCCH}+N_{SF,1}^{PUCCH} sets of N_{sc}^{RB} values each according to Equation 17.

$${y}_{n}^{( \tilde{p} )} ( i ) = \{ \begin{matrix}{w}_{{n}_{oc , 0}^{( \tilde{p} )}} ( \overline{n} ) \cdot {e}^{j π ⌊ {n}_{cs}^{cell} ( {n}_{s} , l ) / 64 ⌋ / 2} \cdot d ( i ) & n < {N}_{SF , 0}^{PUCCH} \\ {w}_{{n}_{oc , 1}^{( \tilde{p} )}} ( \overline{n} ) \cdot {e}^{j π ⌊ {n}_{cs}^{cell} ( {n}_{s} , l ) / 64 ⌋ / 2} \cdot d ( {N}_{sc}^{RB} + i ) & otherwise\end{matrix} \\ \overline{n} = n {mod N}_{SF , 0}^{PUCCH} \\ n = 0 , … , {N}_{SF , 0}^{PUCCH} + {N}_{SF , 1}^{PUCCH} - 1 \\ i = 0 , 1 , … , {N}_{sc}^{RB} - 1 \qquad [ Equation 17 ]$$

In Equation 17, N_{SF,0}^{PUCCH}=N_{SF,1}^{PUCCH}=5 for both slots in a subframe using normal PUCCH format 3 and N_{SF,0}^{PUCCH}=5, N_{SF,1}^{PUCCH}=4 holds for the first and second slot, respectively, in a subframe using shortened PUCCH format 3. The orthogonal sequences wₙ_{_{oc,0}}_{^{(\tilde{p})}}(i) and wₙ_{_{oc,1}}_{^{(\tilde{p})}}(i) are given by Table 24.

TABLE 24

| Sequence | Orthogonal sequence [wₙ_{_{oc}} (0) . . . wₙ_{_{oc}} (N_{SF}^{PUCCH} − 1)] | |
|---|---|---|
| index n_{oc} | N_{SF}^{PUCCH} = 5 | N_{SF}^{PUCCH} = 4 |
| 0 | [1 1 1 1 1] | [+1 +1 +1 +1] |
| 1 | [1 e^{j2π/5} e^{j4π/5} e^{j6π/5} e^{j8π/5}] | [+1 −1 +1 −1] |
| 2 | [1 e^{j4π/5} e^{j8π/5} e^{j2π/5} e^{j6π/5}] | [+1 +1 −1 −1] |
| 3 | [1 e^{j6π/5} e^{j2π/5} e^{j8π/5} e^{j4π/5}] | [+1 −1 −1 +1] |
| 4 | [1 e^{j8π/5} e^{j6π/5} e^{j4π/5} e^{j2π/5}] | — |

Resources used for transmission of PUCCH formats 3 are identified by a resource index n_{PUCCH}^{(3,\tilde{p})} from which the quantities n_{oc,0}^{\tilde{p})} and n_{oc,1}^{(\tilde{p})} are derived according to Equation 18.

$${n}_{oc , 0}^{( \tilde{p} )} = {n}_{PUCCH}^{( 3 , \tilde{p} )} {mod N}_{SF , 1}^{PUCCH} \\ {n}_{oc , 1}^{( \tilde{p} )} = \{ \begin{matrix}( 3 {n}_{oc , 0}^{( \tilde{p} )} ) {mod N}_{SF , 1}^{PUCCH} & if {N}_{SF , 1}^{PUCCH} = 5 \\ {n}_{oc , 0}^{( \tilde{p} )} mod {N}_{SF , 1}^{PUCCH} & otherwise\end{matrix} \qquad [ Equation 18 ]$$

Mapping to Physical Resources

The block of complex-valued symbols z^{(\tilde{p})}(i) shall be multiplied with the amplitude scaling factor β_{PUCCH} in order to conform to the transmit power P_{PUCCH} specified in Subclause 5.1.2.1 in 3GPP TS 36.213 [4], and mapped in sequence starting with z^{(\tilde{p})}(0) to resource elements. PUCCH uses one resource block in each of the two slots in a subframe. Within the physical resource block used for transmission, the mapping of z^{(\tilde{p})}(i) to resource elements (k,l) on antenna port p and not used for transmission of reference signals shall be in increasing order of first k, then l and finally the slot number, starting with the first slot in the subframe.

The physical resource blocks to be used for transmission of PUCCH in slot nₛ are given by Equation 19.

$${n}_{PRB} = \{ \begin{matrix}⌊ \frac{m}{2} ⌋ & if ( m + {n}_{s} mod 2 ) mod 2 = 0 \\ {N}_{RB}^{UL} - 1 - ⌊ \frac{m}{2} ⌋ & if ( m + {n}_{s} mod 2 ) mod 2 = 1\end{matrix} \qquad [ Equation 18 ]$$

In Equation 19, variable m depends on the PUCCH format.

For formats 1, 1a and 1b, m is defined by Equation 20.

$$m = \{ \begin{matrix}{N}_{RB}^{( 2 )} & if {n}_{PUCCH}^{( 1 , \tilde{p} )} < c \cdot {N}_{cs}^{( 1 )} / {Δ}_{shift}^{PUCCH} \\ ⌊ \frac{{n}_{PUCCH}^{( 1 , \tilde{p} )} - c \cdot {N}_{cs}^{( 1 )} / {Δ}_{shift}^{PUCCH}}{c \cdot {N}_{sc}^{RB} / {Δ}_{shift}^{PUCCH}} ⌋ + {N}_{RB}^{( 2 )} + ⌈ \frac{{N}_{cs}^{( 1 )}}{8} ⌉ & otherwise\end{matrix} \\ c = \{ \begin{matrix}3 & normal cyclic prefix \\ 2 & extended cyclic prefix\end{matrix} \qquad [ Equation 20 ]$$

For formats 2, 2a and 2b, m is defined by Equation 21.

m=└n_{PUCCH}^{(2,\tilde{p})}/N_{sc}^{RB}┘ [Equation 21]

For format 3, m is defined by Equation 22.

m=└n_{PUCCH}^{(3,\tilde{p})}/N_{SF,0}^{PUCCH}┘ [Equation 22]

Mapping of modulation symbols for the physical uplink control channel is illustrated in FIG. 5.4.3-1.

In case of simultaneous transmission of sounding reference signal and PUCCH format 1, 1a, 1b or 3 when there is one serving cell configured, a shortened PUCCH format shall be used where the last SC-FDMA symbol in the second slot of a subframe shall be left empty.

FIG. 20 illustrates an example of the mapping of modulation symbols to a PUCCH to which an embodiment of the present invention may be applied. FIG. 20 is only illustrative for convenience of description, but is not intended to limit the scope of the present invention.

In FIG. 20, RB represents the number of resource blocks in the uplink, 0, 1, . . . , N_{RB}^{UL}−1 represents physical resource block number.

A 5G wireless communication system has an object of providing data latency reduced about 10 times compared to the existing wireless communication systems. In order to solve such a problem, it is expected that in 5G, a wireless communication system using a new frame structure having a shorter TTI (e.g., 0.2 ms) will be proposed.

Furthermore, it is expected that in the 5G system, an application having various requirements, such as a high capacity, low energy consumption, a low cost, and a high user data rate in addition to low latency, will coexist. As described above, it is expected that the 5G system will evolve into a system having a structure different from an existing structure in order to support various types of applications from an application that requires ultra-low latency to an application that requires a high data transfer rate.

Hereinafter, in this specification, a short TTI may be understood to have the same meaning as a single short TTI subframe (or short subframe). That is, if both a control region and a data region are defined within a single short subframe, a short TTI has a size including both the control region and the data region. If only a data region is defined within a short subframe, a short TTI has a size including only a data region.

Hereinafter, embodiments of the present invention are described in a radio frame structure to which a normal CP of an FDD type has been applied, for convenience of description. However, the present invention is not limited to the embodiments, but may be identically applied to a radio frame structure of a TDD type or a radio frame structure to which an extended CP has been applied.

In a next-generation communication system, such as 5G, a scheme for achieving very short latency when pieces of information are exchanged is taken into consideration. In other words, in a next-generation communication system, schemes supporting low latency service, that is, differentiation, compared to the previous-generation mobile communications (e.g., 3G and 4G) may be taken into consideration.

To this end, in a next-generation communication system, a structure having a short TTI is taken into consideration. Accordingly, an embodiment of the present invention proposes a method for transmitting data and/or control information through a new uplink channel in a wireless communication system supporting a short TTI.

Hereinafter, a next-generation communication system supporting a short TTI is collectively called a “latency reduced (LR) communication system”, for convenience of description.

Furthermore, in the following description, a channel in which uplink data is transmitted is called a physical uplink shared channel (PUSCH), and a channel in which uplink control information is transmitted is called a physical downlink control channel (PDCCH).

This is based on the terms used in a legacy LTE system, for convenience of description. The PUSCH described in this specification may mean a short PUSCH (sPUSCH) in an LR communication system and the PUCCH may mean a short PUCCH (sPUCCH) in an LR communication system.

PUSCH and PUCCH Transmission Method in a System Supporting a TTI of a 4-Symbol Unit

An example in which TTIs of a 4-symbol unit (or a 4-symbol TTI) in an LR communication system is set according to a TTI having a length of 1 ms (msec), including 14 symbols of a legacy LTE system, may be taken into consideration. In this case, each 4-symbol TTI may share a DMRS symbol with another 4-symbol TTI.

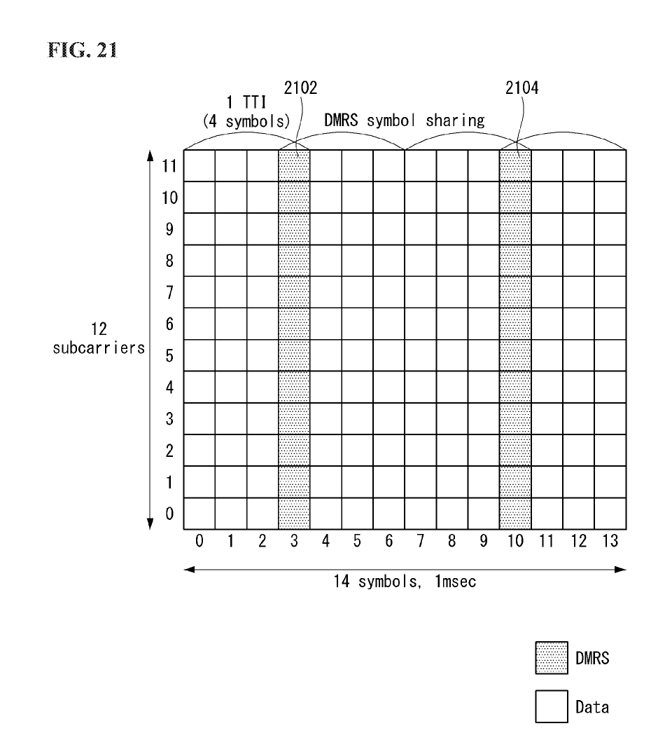

FIG. 21 illustrates a PUSCH transmission structure for 4-symbol TTIs according to various embodiments of the present invention. FIG. 21 is only illustrative for convenience of description, but is not intended to limit the scope of the present invention.

Referring to FIG. 21, a PUSCH of a 4-symbol TTI may share a symbol 2102 or a symbol 2104 with another PUSCH of a 4-symbol TTI.

In this case, the symbol 2102 and the symbol 2104 refer to symbols which are used for UE to transmit the DMRS of a PUSCH to an eNB. Furthermore, symbols other than the symbol 2102 and the symbol 2104 refer to symbols which are used to transmit data (e.g., ACK/NACK).

In FIG. 21, only a 4-symbol TTI has been taken into consideration, but a structure in which a DMRS symbol is shared as in FIG. 21 may be applied to a TTI having a different length (or different symbol unit).

Furthermore, TTIs that share a DMRS symbol may have different lengths. For example, a 4-symbol TTI and a 3-symbol TTI may share a DMRS symbol.

Furthermore, in FIG. 21, the number of shared DMRS symbols has been illustrated as being 1. In various embodiments of the present invention, the number of DMRS symbols shared between TTIs may be expanded in several symbol units.

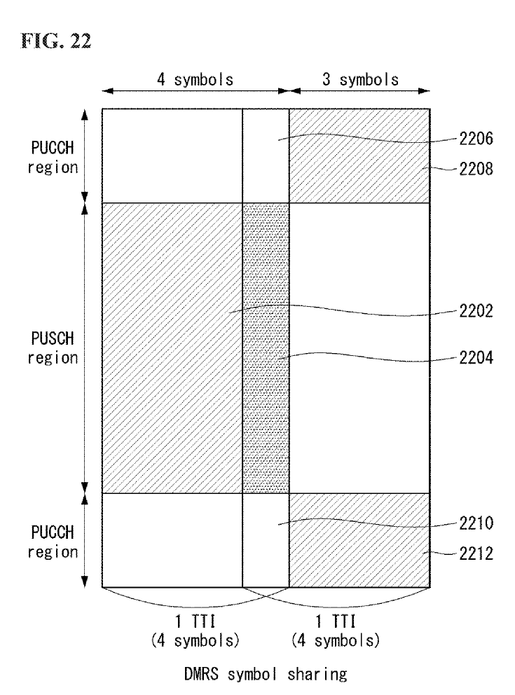

If a PUSCH structure, such as FIG. 21, is taken into consideration, the transmission region of a PUCCH may be located in regions at the ends on both sides of the transmission region of a PUSCH in the direction of the frequency axis as in legacy LTE. Such a structure may be expressed as in FIG. 22.

FIG. 22 illustrates uplink resource grids according to various embodiments of the present invention. FIG. 22 is only illustrative for convenience of description, but is not intended to limit the scope of the present invention.

Referring to FIG. 22, a region 2202 means a region in which UE transmits a PUSCH in a first TTI. A region 2204 is a region included in the region 2202 and may mean a region in which the DMRS of the PUSCH is transmitted.

In this case, in FIG. 22, 1 TTI unit (i.e., a 4-symbol unit) may correspond to a 4-symbol TTI shown in FIG. 21. Accordingly, in FIG. 21, if 12 subcarriers corresponding to (in the frequency axis) the 4-symbol TTI are classified as resource blocks (RBs), the region 2202 may include one or more (or several) RBs.

Furthermore, regions 2206 to 2212 may mean regions in which UE transmit a PUCCH in a second TTI.

In various embodiments of the present invention, if UE transmits a PUSCH in a first 4-symbol TTI (or a first TTI) and transmits a PUCCH in a second 4-symbol TTI (or a second TTI), a method of transmitting the PUSCH and/or the PUCCH may be different depending on the capability of the UE.

After the UE transmits the UCCH in the first TTI, it may transmit the PUSCH in the second TTI. In the following contents, however, an example in which UE transmits a PUSCH in a first TTI and transmits a PUCCH in a second TTI is described below, for convenience of description.

For example, if UE simultaneously transmits a PUSCH and a PUCCH (the UE has the capability to transmit the PUSCH and the PUCCH at the same time), the UE may transmit the PUSCH in the region 2202 and may transmit the PUCCH in the region 2206 and the region 2208 (and/or the region 2210 and the region 2212).

In other words, the UE may transmit the PUCCH in the second TTI by not taking into consideration the section in which PUSCH transmission and PUCCH transmission overlap.

In contrast, if the UE is unable to transmit the PUSCH and the PUCCH at the same time, the UE needs to transmit the PUSCH and/or the PUCCH by taking into consideration the section in which PUSCH transmission and PUCCH transmission overlap.

Hereinafter, methods for transmitting, by UE incapable of simultaneously transmitting a PUSCH and a PUCCH, the PUSCH and/or the PUCCH in an LR communication system, are described below.

Method for Emptying at Least One Shared Symbol

In various embodiments of the present invention, in an LR communication system, UE not supporting the simultaneous transmission of a PUSCH and a PUCCH may transmit the PUSCH or the PUCCH other than a region that is overlapped between the region in which the PUSCH is transmitted and the region in which the PUCCH is transmitted.

For example, if UE transmits a PUSCH in a first TTI as in the example of FIG. 22, the UE may empty (or not use) the region 2206 and the region 2210 (or a shared DMRS symbol region) of FIG. 22 and may transmit a PUCCH in a 3-symbol TTI unit in the region 2208 and/or the region 2212.

In this case, the region 2206 and the region 2210 may mean regions which are counted in response to the resource mapping of the PUCCH, but are not used for PUCCH transmission.

If a PUSCH transmission region and a PUCCH transmission region are configured as in the above example, UE may (continuously) transmit a PUSCH and a PUCCH in the same region (or the same uplink resource grid) regardless of whether the UE can transmit the PUSCH and the PUCCH at the same time (or regardless of the simultaneous transmission capability of the UE for the PUSCH and the PUCCH).

In this case, if the UE performs frequency hopping on the PUCCH, a frequency hopping pattern may be defined using the region 2208 and/or the region 2212.

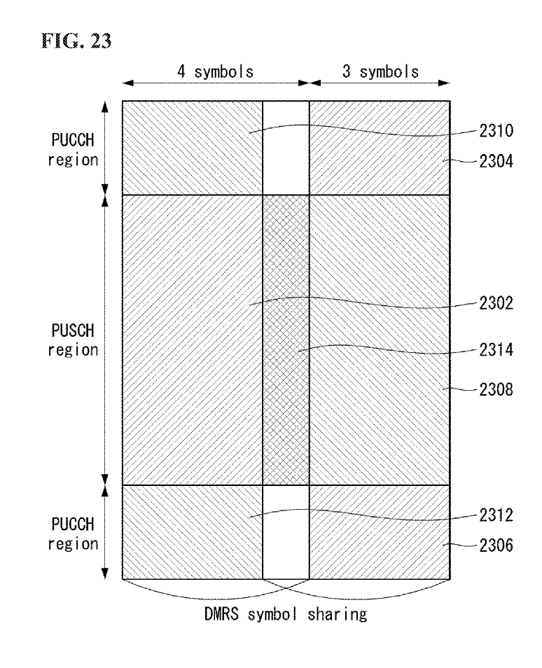

Furthermore, as shown in FIG. 23, a plurality of pieces of UE may transmit a PUCCH and a PUSCH in the same region.

FIG. 23 illustrates the PUSCH and PUCCH transmission regions of two pieces of UE according to various embodiments of the present invention. FIG. 23 is only illustrative for convenience of description, but is not intended to limit the scope of the present invention.

Referring to FIG. 23, it is assumed that two pieces of UE (e.g., first UE and second UE) transmit a PUSCH and a PUCCH, respectively, in a consecutive TTI.

In this case, a region 2302 means a region in which the first UE transmits the PUSCH, and a region 2304 and a region 2306 mean regions in which the first UE transmits the PUCCH.

Furthermore, a region 2308 means a region in which the second UE transmits the PUSCH, and a region 2310 and a region 2312 mean regions in which the second UE transmits the PUCCH.

Furthermore, a region 2314 is included in the region 2302 and the region 2308, and means a region in which the DMRS of the PUSCH is transmitted.

Since the PUSCH and the PUCCH are transmitted in the respective regions, the first UE and the second UE can perform PUSCH transmission and PUCCH transmission without a collision.

Furthermore, the PUCCH regions at both ends (i.e., the region 2304, the region 2306, the region 2310, and the region 2312) may be used for slot hopping depending on the transmission format of the PUCCH.

Furthermore, the PUCCHs may be multiplexed between pieces of UE (or uses) in the PUCCH regions.

Furthermore, in various embodiments of the present invention, pieces of UE having different capabilities may transmit a PUSCH and a PUCCH in the same uplink resource grid.

For example, UE incapable of the simultaneous transmission of a PUSCH and a PUCCH may transmit the PUCCH other than a PUCCH region corresponding to a shared DMRS symbol portion as in FIG. 23 (i.e., the PUCCH is transmitted in the region 2304, the region 2306, the region 2310 or the region 2312). UE capable of the simultaneous transmission may transmit the PUCCH even in the PUCCH region corresponding to the shared DMRS symbol region.

In this case, an eNB may transmit scheduling information about whether the UE capable of the simultaneous transmission of the PUSCH and the PUCCH will use the shared DMRS symbol region for PUCCH transmission to the UE through higher layer signaling.

In other words, the eNB may additionally allocate a PUCCH resource for the shared DMRS symbol region to the UE capable of the simultaneous transmission of the PUSCH and the PUCCH.

Furthermore, in various embodiments of the present invention, UE may not use a shared DMRS region for PUSCH transmission in addition to only PUCCH transmission. In other words, UE may transmit a PUCCH or a PUSCH without using a region in which PUCCH transmission and PUSCH transmission overlap.

In this case, the UE may transmit a sounding reference signal (SRS) for uplink channel measurement in an empty region (or a region not used for PUSCH and PUCCH transmission).

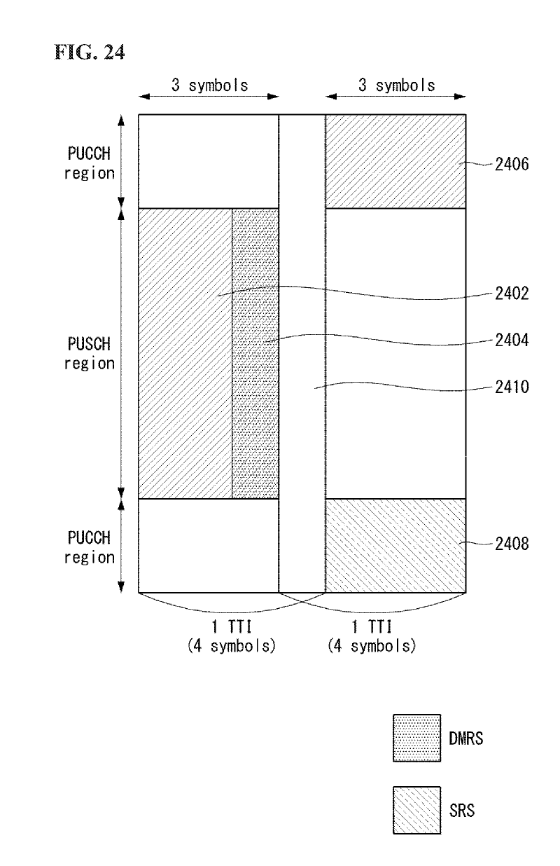

FIG. 24 illustrates an example of a structure in which UE transmits an SRS in a region not used for PUCCH and PUSCH transmission according to various embodiments of the present invention. FIG. 24 is only illustrative for convenience of description, but is not intended to limit the scope of the present invention.

Referring to FIG. 24, it is assumed that UE does not support the simultaneous transmission of a PUSCH and a PUCCH. The assumption is only illustrative for convenience of description. It is evident to those skilled in the art that UE supporting the simultaneous transmission of a PUSCH and a PUCCH may use a specific region in order to transmit an SRS.

In this case, a region 2402 may mean a region in which the UE transmits a PUSCH, and a region 2406 and a region 2408 may mean regions in which the UE transmits a PUCCH. In this case, unlike in a DMRS transmission region in a 4-symbol TTI, the UE transmits the DMRS of the PUSCH in a region 2404 (i.e., 1 symbol earlier compared to a common 4-symbol TTI).

Furthermore, the UE does not perform PUSCH and PUCCH transmission in a region 2410. Accordingly, the UE may transmit an SRS for the measurement of an uplink channel in a region 2410.

In this case, the region 2410 may mean a region which is counted in response to the resource mapping of the PUCCH and the PUSCH, but is not used for PUCCH and PUSCH transmission.

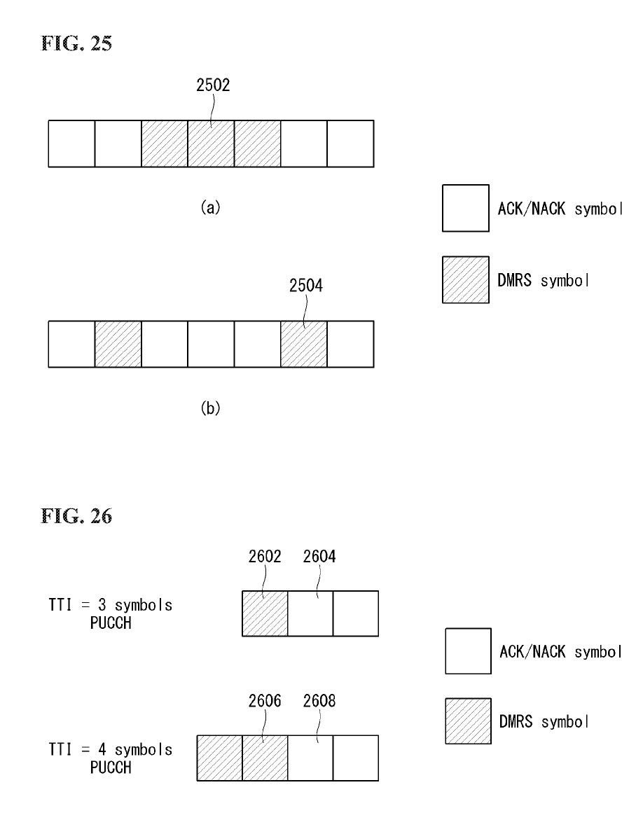

Furthermore, whether the transmitted SRS collides against the DMRS of a PUCCH in legacy LTE, such as that shown in FIG. 25, may be taken into consideration.

FIG. 25 illustrates the structures of a PUCCH format in a legacy LTE system.

Referring to FIG. 25, FIGS. 25(a) and 25(b) show the structures of a PUCCH format in one slot of legacy LTE.

In this case, FIG. 25(a) illustrates the structure of the PUCCH format 1 (or the PUCCH formats 1, 1a, and 1b) of legacy LTE. In this case, a region 2502 means a region in which the DMRS of the PUCCH format 1 is transmitted.

Furthermore, FIG. 25(b) illustrates the structure of the PUCCH format 2 (or the PUCCH formats 2, 2a, and 2b) of legacy LTE. In this case, a region 2504 means a region in which the DMRS of the PUCCH format 2 is transmitted.

If FIG. 25(a) and the region 2410 of FIG. 24 are taken into consideration, the region 2410 and the fourth symbol region of FIG. 25(a) may overlap. In this case, the SRS and the DMRS may be distinguished by respective sequences applied thereto. For example, a comb structure used for the transmission of an SRS may be different from a comb structure used for the transmission of a DMRS. In this case, an eNB may schedule the comb structures of the DMRS and the SRS for UE so that the comb structures do not overlap. If the comb structure is not utilized for the transmission of the DMRS, the sequences of SRS and DMRS can be distinguished from each other by assigning different cyclic shift (CS) values of the corresponding sequences.

Furthermore, if FIG. 25(b) and the region 2410 of FIG. 24 are taken into consideration, the region 2410 and the DMRS symbol of FIG. 25(b) do not overlap. Accordingly, in this case, the SRS and the DMRS do not collide against each other. However, in this case, since the PUCCH ACK/NACK symbol of the legacy LTE overlaps with the PUCCH ACK/NACK symbol of the legacy LTE, the SRS can be configured to be transmitted only to an area to which the PUCCH of the legacy LTE user is not allocated. In addition, the base station may notify the terminal (or user) of this configuration through higher layer signaling and/or physical layer signaling.

Method Using at Least One Shared Symbol

In the case of the aforementioned method, UE cannot use a shared symbol (or a symbol in which the transmission region of a PUSCH and the transmission region of a PUCCH overlap) for PUSCH and/or PUCCH transmission.

In this case, efficiency of uplink data and/or control information transmission may be low because the UE cannot transmit the uplink data and/or the control information in the shared symbol.

Accordingly, methods for using, by UE, a shared symbol for PUSCH or PUCCH transmission are described below.

In an embodiment of the present invention, if a PUCCH transmission format is properly used, a shared symbol (or a shared DMRS symbol) may be used for PUCCH transmission.

FIG. 26 illustrates PUCCH transmission formats according to embodiments of the present invention. FIG. 26 is only illustrative for convenience of description, but is not intended to limit the scope of the present invention.

Referring to FIG. 26, a region 2602 may mean a DMRS region (or a DMRS symbol) in a PUCCH of a 3-symbol TTI, and a region 2604 may mean an ACK/NACK region (or a symbol in which ACK/NACK is transmitted) in a PUCCH of a 3-symbol TTI.

Furthermore, a region 2606 may mean a DMRS region in a PUCCH of a 4-symbol TTI, and a region 2608 may mean an ACK/NACK region in a PUCCH of a 4-symbol TTI.

If the PUCCH transmission formats of FIG. 26 are used, a shared symbol (e.g., the region 2206 or region 2210 of FIG. 22) may be used using the cyclic shift (CS) of a sequence applied to the region 2602 and the region 2606 and orthogonal cover code (OCC) applied to the region 2604 and the region 2608.

Furthermore, in this case, multiplexing between pieces of UE having different capabilities may be possible (or may be performed).

For example, if the region 2602 and/or the region 2606 includes 12 subcarriers, a base sequence of a length 12 may be applied to the region 2602 and/or the region 2606.

More specifically, a sequence corresponding to the CS index 0 of the base sequence and {1, 1} OCC may be applied to UE capable of the simultaneous transmission of a PUSCH and a PUCCH. A sequence corresponding to the CS index 6 of the base sequence and {1, −1} OCC may be applied to UE incapable of the simultaneous transmission of a PUSCH and a PUCCH.

Since a CS and OCC are differently applied depending on the capability of UE, UE having a high capability (or capable of the simultaneous transmission of a PUSCH and a PUCCH) may transmit a PUCCH using a shared symbol region.

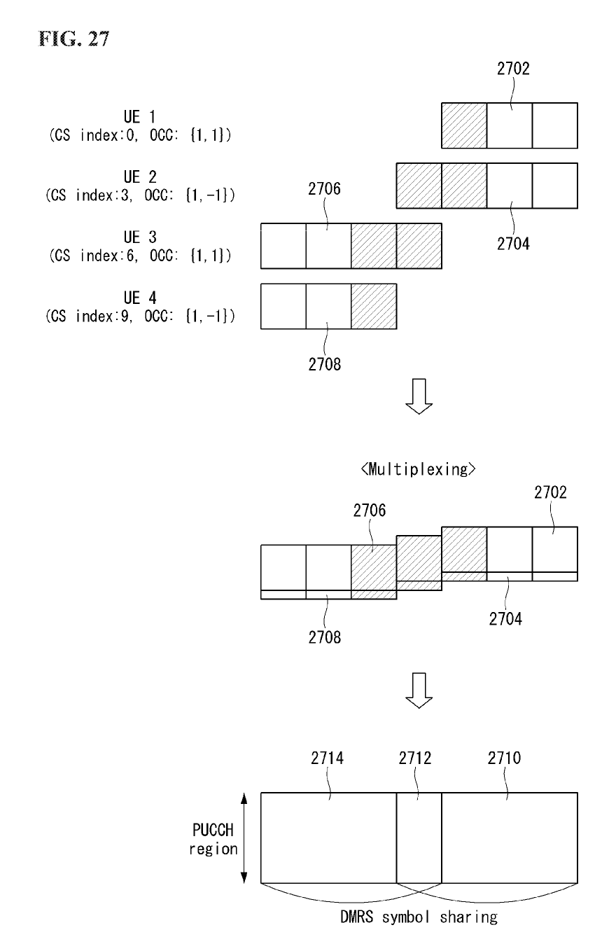

An example of a PUCCH transmitted by pieces of UE having different capabilities for 2 TTIs (or over 2 TTIs) using the aforementioned method is shown in FIG. 27.

FIG. 27 illustrates examples of PUCCH multiplexing between pieces of UE according to various embodiments of the present invention. FIG. 27 is only illustrative for convenience of description, but is not intended to limit the scope of the present invention.

Referring to FIG. 27, UE 1 and UE 4 mean UE incapable of the simultaneous transmission of a PUSCH and a PUCCH, and UE 2 and UE 3 mean UE capable of the simultaneous transmission of a PUSCH and a PUCCH.

In FIG. 27, a PUCCH 2702 may mean a PUCCH transmitted by the UE 1, a PUCCH 2704 may mean a PUCCH transmitted by the UE 2, a PUCCH 2706 may mean a PUCCH transmitted by the UE 3, and a PUCCH 2708 may mean a PUCCH transmitted by the UE 4. In this case, the UE 1 and the UE 2 may transmit the PUSCH in the first TTI, and the UE 3 and the UE 4 may transmit the PUSCH in the second TTI.

Furthermore, the UE 2 and the UE 3 may transmit the PUCCHs in a structure in which a DMRS symbol is shared.

In this case, the pieces of UE may transmit DMRS sequences using respective CS indices 0, 3, 6, and 9 regardless of a TTI in which the PUCCH is transmitted. Furthermore, pieces of UE (i.e., the UE 1 and the UE 2 or the UE 3 and the UE 4) that transmit the DMRS sequences in the same (or same) TTI may apply {1, 1} and {1, −1} OCC to ACK/NACK symbols, respectively.

Accordingly, while shared symbols are used for PUCCH transmission, multiplexing can be performed between pieces of UE having different capabilities.

More specifically, the PUCCH 2702 may be transmitted in a region 2710, the PUCCH 2704 may be transmitted the region 2710 and a region 2712, the PUCCH 2706 may be transmitted in the region 2712 and a region 2714, and the PUCCH 2708 may be transmitted in a region 2714. In this case, the region 2712 may correspond to the region 2210 of FIG. 22, and the region 2710 may correspond to the region 2212 of FIG. 22.

In this case, an eNB may transmit (or notify) information about a CS index and OCC, used for each of pieces of UE, to each of the pieces of UE through higher layer signaling.

Furthermore, in another embodiment of the present invention, in order to use a shared symbol, UE may transmit a PUCCH having a different length for each TTI. In this case, a PUCCH region may be divided into a region including a DMRS symbol shared between TTIs in a PUSCH and a region not including a DMRS symbol.

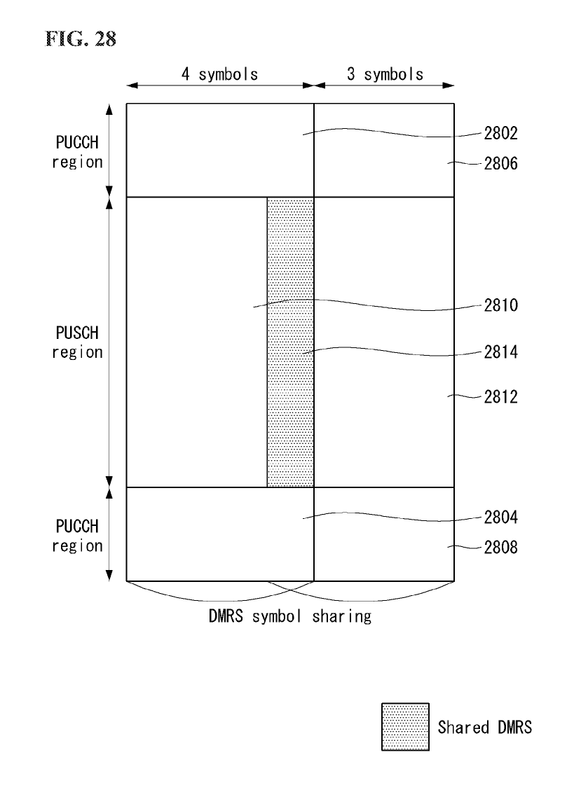

FIG. 28 illustrates a PUCCH transmission structure having a different length for each TTI according to another embodiment of the present invention. FIG. 28 is only illustrative for convenience of description, but is not intended to limit the scope of the present invention.

In this case, each of a region 2802 and a region 2804 means a 4-symbol length PUCCH region in a first TTI, and each of a region 2806 and a region 2808 means a 3-symbol length PUCCH region in a second TTI. Furthermore, a region 2810 and a region 2812 mean 4-symbol length PUSCH regions in the first TTI and the second TTI, respectively.

Referring to FIG. 28, the region 2810 and the region 2812 (or 4-symbol PUSCHs transmitted in a consecutive TTI) may share a region 2814. In this case, the region 2814 may mean a region in which the DMRS of the PUSCH is transmitted.

In this case, UE may transmit PUCCHs of different lengths in the 4-symbol length region and the 3-symbol length region. In other words, the UE may transmit PUCCHs of different lengths in the region 2802 and the region 2806, respectively.

In this case, if UE incapable of the simultaneous transmission of a PUSCH and a PUCCH transmits a PUCCH in the region 2802 (or 2804) and transmits a PUSCH in the region 2812, the PUCCH and the PUSCH may overlap (or collide against each other). In this case, the UE may forgive the PUSCH transmission and may transmit only the PUCCH in the region 2802 (or the region 2804). In addition, when the UE transmits the PUSCH in the second TTI by applying the same principle as in FIG. 24, the UE allocates a separate symbol for DMRS transmission in the region 2812 without using (or utilizing) the region 2814, It is obvious that transmission can be performed.

Method for Taking into Consideration Priority Between a PUCCH and a PUSCH

Furthermore, in various embodiments of the present invention, UE may transmit a PUSCH and/or a PUCCH by taking into consideration priority between the PUSCH and the PUCCH. For example, if the UE transmits periodic channel state information (CSI) using the PUCCH or receives data in downlink and transmits ACK/NACK information in response to the received data, in general, the priority of the PUCCH may be determined to be higher than that of the PUSCH.

Accordingly, methods for transmitting, by UE not supporting the simultaneous transmission of a PUSCH and a PUCCH (or incapable of the simultaneous transmission), the PUSCH or PUCCH based on priority are described below.

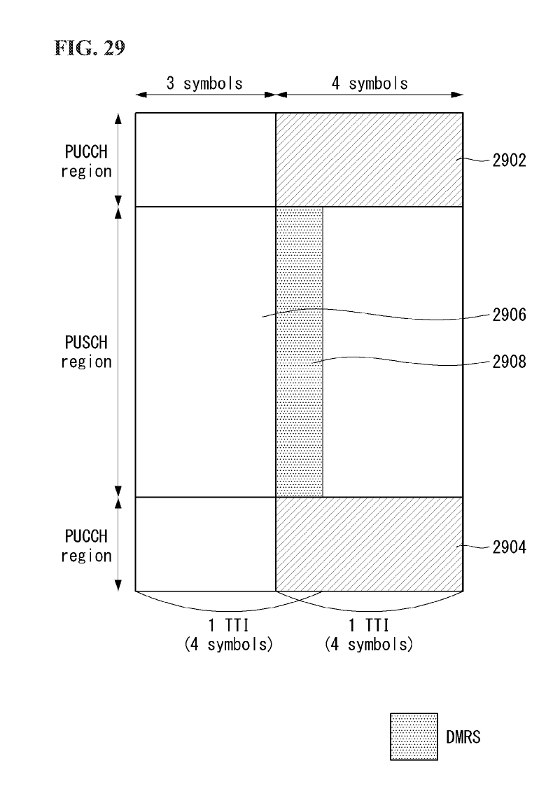

FIG. 29 illustrates a PUCCH transmission structure based on priority according to an embodiment of the present invention. FIG. 29 is only illustrative for convenience of description, but is not intended to limit the scope of the present invention.

In this case, each of a region 2902 and a region 2904 is a 4-symbol PUCCH region in a second TTI. Furthermore, a region 2906 means a 4-symbol PUSCH region in a first TTI, and a region 2908 means a DMRS region for a PUSCH in a region 2906.

Referring to FIG. 29, UE incapable of the simultaneous transmission of a PUSCH and a PUCCH may drop a PUSCH based on priority, and may transmit a PUCCH using the region 2902 or the region 2904. In this case, it is assumed that the priority of the PUCCH is higher than that of the PUSCH. Furthermore, a method for dropping a PUSCH may also be applied to a case where the transmission order of a PUCCH and a PUSCH is reversed.

In general, if a PUCCH corresponds to periodic CSI and thus what UE will transmit a PUCCH in an (n+1)-th TTI (or a situation in which PUCCH transmission has been scheduled in the (n+1)-th TTI) can be predicted at a point of time at which a PUSCH is transmitted (i.e., an n-th TTI), the UE may drop the PUSCH. In this case, if the UE can predict the contents in an (n−k)-th TTI, a k TTI may mean the time necessary to drop the PUSCH.

In contrast, UE may be unable to check a situation in which PUCCH transmission has been scheduled when it transmits a PUSCH in an n-th TTI or to stop PUSCH transmission in the n-th TTI. In this case, the UE may give priority to on-going transmission and may drop scheduled PUCCH transmission or may puncture a shared symbol in a PUCCH region.

In this case, whether the UE can check the PUCCH scheduling may be different depending on the capability of UE. Alternatively, as in a periodic PUCCH, such as CSI, and a PUCCH according to ACK/NACK transmission, whether a PUCCH has been scheduled may be different based on a semi-statically scheduled PUCCH and a dynamically scheduled PUCCH.

Alternatively, assuming that the TTI length (or size) of a PUCCH is 4 symbols, 3 symbols, 4 symbols, and 3 symbols within 1 ms, an overlap case may always be generated in the sequence of PUCCH-PUSCH. In this case, UE may give priority to a PUCCH. If a PUCCH and a PUSCH overlap, UE may drop a scheduled PUSCH after PUCCH transmission or may postpone DMRS transmission for a PUSCH by one symbol after puncturing an overlapped symbol based on priority.

In this case, if an eNB has recognized the transmission of the PUCCH, but has allocated the PUSCH for a reason, such as an emergency service, the UE may determine the priority of the PUSCH to be higher than that of the PUCCH. In this case, the UE may transmit the PUSCH and drop the PUCCH.

Furthermore, although the UE has not predicted PUCCH timing and has transmitted the PUSCH, the UE may not transmit the PUCCH in a next TTI.

Furthermore, in various embodiments of the present invention, the method for dropping one of a PUSCH and a PUCCH based on the priorities of the PUSCH and PUCCH may be applied to various symbol sharing structures.

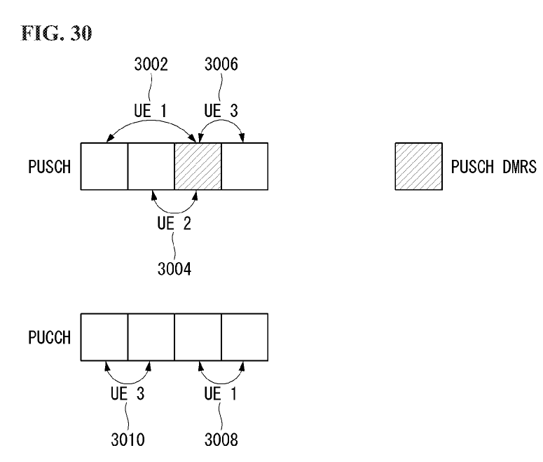

FIG. 30 illustrates structures in which the overlap of a PUCCH and a PUSCH has been taken into consideration if isolated symbols are present according to various embodiments of the present invention. FIG. 30 is only illustrative for convenience of description, but is not intended to limit the scope of the present invention.

In this case, a PUSCH 3002 means a PUSCH transmitted by UE 1, a PUSCH 3004 means a PUSCH transmitted by UE 2, a PUSCH 3006 means a PUSCH transmitted by UE 3. Furthermore, a PUCCH 3008 means a PUCCH transmitted by the UE 1, and a PUCCH 3010 means a PUCCH transmitted by the UE 3.

Referring to FIG. 30, a structure in which a PUSCH is shared between isolated symbols may be taken into consideration. In other words, the DMRS of a PUSCH region may be shared between isolated symbols.

For example, if the third symbol of the PUSCH 3002 and the first symbol of the PUCCH 3008 overlap as in the case of the UE 1, the UE may drop the PUSCH and/or the PUCCH according to the aforementioned method.

Furthermore, in accordance with a method, such as that described above, if the shared DMRS symbol of a PUSCH and a PUCCH region overlap, UE may transmit a PUCCH using the remaining regions (or symbol(s)) other than a symbol that overlaps the DMRS symbol of the PUSCH.

Furthermore, if a PUCCH region overlaps a symbol corresponding to data (e.g., ACK/NACK) not the shared DMRS of a PUSCH, UE may transmit data (to an eNB) through a PUSCH using the remaining symbol(s) other than the overlap symbol.

Accordingly, the UE may perform (or use) a method for dropping one of two channels (i.e., a PUSCH and a PUCCH) or may perform a method for transmitting information (e.g., a DMRS or data) other than a symbol overlapped in one of the two channels depending on whether the symbol of a PUSCH overlapping a PUCCH is for transmitting which one of the DMRS and the data.

Furthermore, the method may be extended and applied to PUSCH and/or PUCCH structures of various length units and may also be applied to a case where a PUCCH is shared between isolated symbols.

In this case, if a specific symbol (e.g., a DMRS symbol) is shared between isolated symbols, a transient period (or cycle) may be disposed by taking into consideration a transient time. For example, if a DMRS symbol is shared, the transient period may be located ahead of a symbol boundary so that a PUSCH can be transmitted with normal power from the start point of the symbol.

Furthermore, in another embodiment of the present invention, if a PUCCH and a PUSCH overlap, UE may change the TTI of a channel having low priority by the number of shared DMRS symbols and may transmit a PUSCH or PUCCH.

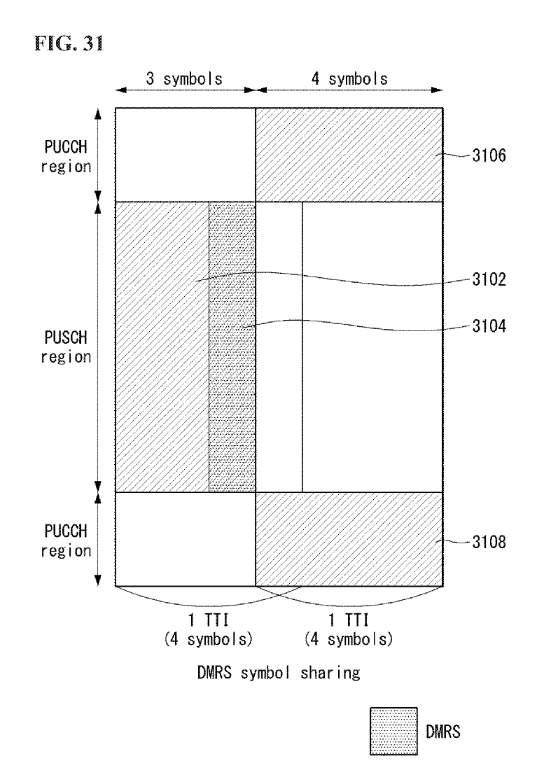

FIG. 31 illustrates a structure in which the TTI of a PUSCH has been changed based on priority according to another embodiment of the present invention. FIG. 31 is only illustrative for convenience of description, but is not intended to limit the scope of the present invention.

In this case, a region 3106 and a region 3108 mean PUCCH regions, and a region 3102 means a PUSCH region. Furthermore, a region 3104 means a region in which the DMRS of a PUSCH is transmitted.

Referring to FIG. 31, it is assumed that a basic (original) TTI for a PUSCH and a PUCCH are 4 symbols and the priority of the PUCCH is higher than that of the PUSCH.

In this case, UE may change the TTI of the PUSCH having low priority from 4 TTIs to 3 TTIs reduced by 1 symbol corresponding to the DMRS region, and may transmit a 3-symbol PUSCH (i.e., a PUSCH corresponding to the region 3102). In this case, the DMRS region corresponding to the 4 TTI PUSCH is punctured, and the DMRS transmission region is advanced by 1 symbol.

In this case, an eNB may transmit (or provide notification of) information about whether the PUSCH and the PUCCH overlap and/or about that a symbol(s) has to be reduced to what extent through scheduling.

Furthermore, in various embodiments of the present invention, if the priority of the PUSCH is higher than that of the PUCCH, UE may piggyback PUCCH information on the PUSCH.

For example, if it is expected that timing when periodically transmitted PUCCH information, such as periodic CSI, is expected will collide against timing when a PUSCH having high priority is allocated, an eNB may allocate a PUSCH resource to UE so that the PUCCH information can be previously included. Accordingly, the UE may piggyback the PUCCH on the PUSCH and transmit them to the eNB.

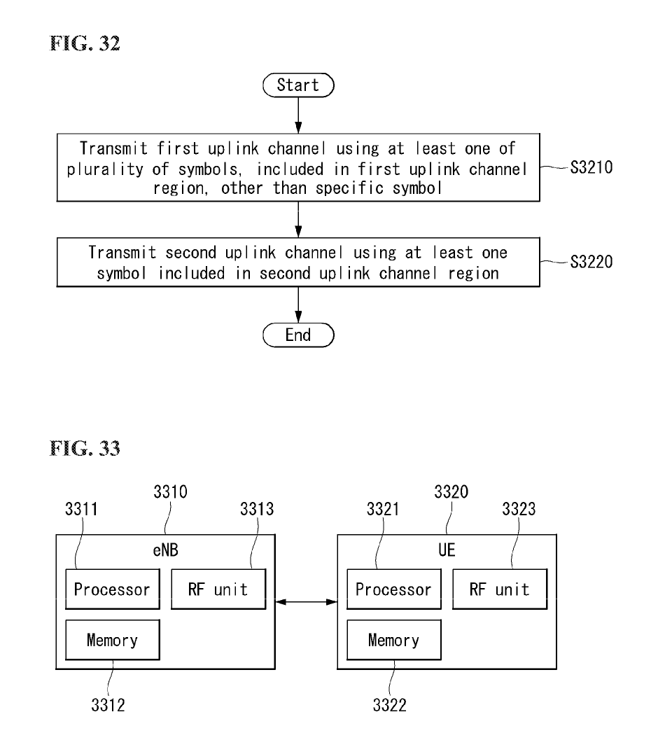

FIG. 32 illustrates an operating flowchart of UE which transmits an uplink channel according to an embodiment of the present invention. FIG. 32 is only illustrative for convenience of description, but is not intended to limit the scope of the present invention.

Referring to FIG. 32, it is assumed that UE transmits uplink channels to an eNB in a wireless communication system supporting a sTTI. Furthermore, is assumed that the UE does not support the simultaneous transmission of a first uplink channel and a second uplink channel.

In this case, the first uplink channel may mean the aforementioned PUCCH (or sPUCCH) and the second uplink channel may mean the aforementioned PUSCH (or sPUSCH). In other words, the first uplink channel may mean a channel which is used to transmit uplink control information, and the second uplink channel may mean a channel which is used to transmit uplink data.

At step S3210, if a first uplink channel region in (or at) a first sTTI overlaps a specific symbol included in a second uplink channel region in (or at) a second TTI, the UE may transmit the first uplink channel to the eNB using at least one of a plurality of symbols, included in the first uplink channel region, other than the specific symbol in the first sTTI.

In this case, the specific symbol may include a symbol to which a DMRS related to the second uplink channel is mapped. Furthermore, the symbol to which the DMRS is mapped may mean a DMRS symbol shared by the second uplink channel in the first sTTI and the second uplink channel in the second TTI. The specific symbol is similar to the aforementioned shared symbol (or shared DMRS symbol).

Furthermore, the first sTTI and the second sTTI may be consecutive.

In other words, if the PUSCH transmission and the PUCCH transmission overlap in the consecutive sTTIs, the UE may transmit a PUCCH using the region 2208 and/or region 2212 of FIG. 22.

Furthermore, the first uplink channel region may be subjected to frequency hopping based on a predetermined hopping pattern.

Furthermore, in various embodiments of the present invention, the UE may receive information related to a cyclic shift (CS), applied to a sequence (e.g., a sequence applied to a DMRS, that is, a base sequence) and/or information related to orthogonal cover code (OCC) from the eNB. In this case, the UE may transmit the first uplink channel, including symbols to which the CS and the OCC have been applied, to the eNB. Accordingly, the multiplexing of the transmission of the first uplink channel between pieces of UE can be performed.

After the UE transmits the first uplink channel, at step S3220, the UE may transmit the second uplink channel to the eNB using at least one symbol included in the second uplink channel region.

In this case, the UE may transmit the second uplink channel using the second uplink channel region including a region corresponding to the specific symbol. For example, the UE may transmit a PUSCH (or sPUSCH) to the eNB using the region 2202 including the region 2204 of FIG. 22.

Furthermore, in various embodiments of the present invention, the UE may transmit the second uplink channel using the second uplink channel region not including a region corresponding to the specific symbol (or an empty region corresponding to the specific symbol).

For example, the UE may transmit a PUSCH (or sPUSCH) to the eNB using the region 2402 of FIG. 24.

In this case, the region in which the DMRS related to the second uplink channel is transmitted may also be moved like the region 2404 of FIG. 24.

Furthermore, as described with reference to FIG. 24, the UE may transmit an SRS for uplink channel measurement (or estimation) to the eNB using the empty region.

Internal Block Diagrams of UE and eNB

FIG. 33 illustrates a block diagram of a communication device according to one embodiment of the present invention.

With reference to FIG. 33, a wireless communication system comprises a network node 3310 and a plurality of UEs 3320.

A network node 3310 comprises a processor 3311, memory 3312, and communication module 3313. The processor 3311 implements proposed functions, processes and/or methods proposed through FIG. 1 to FIG. 32. The processor 3311 can implement layers of wired/wireless interface protocol. The memory 3312, being connected to the processor 3311, stores various types of information for driving the processor 3311. The communication module 3313, being connected to the processor 3311, transmits and/or receives wired/wireless signals. Examples of the network node 3310 include an eNB, MME, HSS, SGW, PGW, application server and so on. In particular, in case the network node 3310 is an eNB, the communication module 3313 can include an Radio Frequency (RF) unit for transmitting/receiving a radio signal.

The UE 3320 comprises a processor 3321, memory 3322, and communication module (or RF unit) 3323. The processor 3321 implements proposed functions, processes and/or methods proposed through FIG. 1 to FIG. 32. The processor 3321 can implement layers of wired/wireless interface protocol. The memory 3322, being connected to the processor 3321, stores various types of information for driving the processor 3321. The communication module 3323, being connected to the processor 3321, transmits and/or receives wired/wireless signals.

The memory 3312, 3322 can be installed inside or outside the processor 3311, 3321 and can be connected to the processor 3311, 3321 through various well-known means. Also, the network node 3310 (in the case of an eNB) and/or the UE 3320 can have a single antenna or multiple antennas.

The aforementioned embodiments are achieved by combination of structural elements and features of the present invention in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

Embodiments according to the present invention may be implemented by various means, for example, hardware, firmware, software, or a combination thereof. In the case of hardware implementation, an embodiment of the present invention may be implemented by one or more application specific integrated circuits (ASICs), digital signal processors (DSPs), digital signal processing devices (DSPDs), programmable logic devices (PLDs) Field programmable gate arrays (FPGAs), a processor, a controller, a microcontroller, a microprocessor, or the like.

In the case of an implementation by firmware or software, an embodiment of the present invention may be implemented in the form of a module, a procedure, a function, or the like for performing the functions or operations described above. The software code can be stored in memory and driven by the processor. The memory is located inside or outside the processor and can exchange data with the processor by various means already known.

In accordance with an embodiment of the present invention, in a wireless communication system supporting a short transmission time Interval (sTTI), UE not supporting the simultaneous transmission of uplink channels can transmit uplink data and/or control information to an eNB without a collision between the uplink channels.

Advantages which may be obtained in the present invention are not limited to the aforementioned advantages, and various other advantages may be evidently understood by those skilled in the art to which the present invention pertains from the following description.

The method for transmitting an uplink channel in a wireless communication system according to an embodiment of the present invention has been illustrated as being applied to the 3GPP LTE/LTE-A systems, but may also be applied to various wireless communication systems in addition to the 3GPP LTE/LTE-A systems.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for transmitting an uplink channel in a wireless communication system supporting a short transmission time interval (sTTI), the method being performed by a terminal incapable of a simultaneous transmission of a first uplink channel and a second uplink channel and comprising:
when a first uplink channel region at a first sTTI is overlapped with a specific symbol included in a second uplink channel region at a second sTTI, transmitting the first uplink channel to a base station using at least one of a plurality of symbols included in the first uplink channel region symbol other than the specific symbol at the first sTTI; and
transmitting the second uplink channel to the base station using at least one symbol included in the second uplink channel region at the second sTTI,
wherein the specific symbol comprises a symbol to which a demodulated reference signal (DMRS) related to the second uplink channel is mapped.

2. The method of claim 1, wherein the symbol to which the DMRS is mapped comprises a DMRS symbol shared by the second uplink channel at the first sTTI and the second uplink channel at the second sTTI.

3. The method of claim 1, wherein:
the first uplink channel comprises a channel in which the terminal transmits uplink control information to the base station, and
the second uplink channel comprises a channel in which the terminal transmits uplink data to the base station.

4. The method of claim 1, wherein:
the first uplink channel comprises a short physical uplink control channel (sPUCCH), and
the second uplink channel comprises a short physical uplink shared channel (sPUCCH).

5. The method of claim 1, wherein the first sTTI comprises a sTTI adjacent to the second sTTI.

6. The method of claim 1, wherein the at least one symbol included in the second uplink channel region comprises at least one of a plurality of symbols included in the second uplink channel region at the second sTTI other than the specific symbol.

7. The method of claim 6, further comprising transmitting a sounding reference signal to the base station using the specific symbol,
wherein the DMRS related to the second uplink channel is mapped to a part of the at least one symbol other than the specific symbol.

8. The method of claim 1, wherein the first uplink channel region is subjected to frequency hopping based on a predetermined hopping pattern.

9. The method of claim 1, further comprising receiving information related to a specific cyclic shift applied to a sequence and information related to orthogonal cover code from the base station,
wherein the transmitted first uplink channel comprises at least one first symbol to which the sequence based on the specific cyclic shift has been applied and at least one second symbol to which the orthogonal cover code has been applied.

10. A terminal transmitting an uplink channel in a wireless communication system supporting a short transmission time Interval (sTTI), the terminal incapable of a simultaneous transmission of a first uplink channel and a second uplink channel and comprising:
a transmission/reception unit for transmitting and receiving a radio signal, and
a processor functionally coupled to the transmission/reception unit,
wherein the processor performs control so that when a first uplink channel region at a first sTTI is overlapped with a specific symbol included in a second uplink channel region at a second sTTI, a first uplink channel is transmitted to a base station using at least one of a plurality of symbols included in the first uplink channel region symbol other than the specific symbol at the first sTTI and the second uplink channel is transmitted to the base station using at least one symbol included in the second uplink channel region at the second sTTI, and
the specific symbol comprises a symbol to which a demodulated reference signal (DMRS) related to the second uplink channel is mapped.
